(19) United States
(12) Patent Application Publication
(10) Pub. No.: US 2008/0227007 A1
(43) Pub. Date: Sep. 18, 2008

(54) Image forming apparatus and process cartridge

(75) Inventors: Nozomu Tamoto, Numazu-shi (JP); Hiromi Tada, Numazu-shi (JP); Yoshinori Inaba, Numazu-shi (JP); Katsuichi Ohta, Mishima-shi (JP)

Correspondence Address: COOPER & DUNHAM, LLP, 1185 AVENUE OF THE AMERICAS, NEW YORK, NY, 10036, US

(73) Assignee: Ricoh Company, Ltd.

(21) Appl. No.: 12/075,092

(22) Filed: Mar. 7, 2008

(30) Foreign Application Priority Data
Mar. 16, 2007 (JP) 2007-069136

(51) Int. Cl. G03C 1/73; G03G 15/00

(52) U.S. Cl. 430/58.75; 430/58.65; 399/159

(57) ABSTRACT

An image forming apparatus including an image bearing member, a charger, an irradiator, and a developing device, wherein the relationships T1≦T2 and T2=W/V are satisfied, wherein T1 (msec) represents a real transit time, defined as a value on X-axis of a first flection point, at which a surface potential (Y) of the image bearing member firstly rises up when a time (X) between irradiating the image bearing member and measuring the surface potential of the irradiated portion thereof is shortened, in a graph showing a relationship between X and Y; T2 (msec) represents a charging time; W (mm) represents a charging width of the charger; and V (mm/msec) represents a linear velocity of the image bearing member.

### BACKGROUND OF THE INVENTION

1. Field of the Invention

The present invention relates to an image forming apparatus and a process cartridge for use in electrophotography.

2. Discussion of the Related Art

Image forming apparatuses using electrophotography, such as laser printers and digital copiers, have improved to stably produce high quality images and have been widely used recently. The image forming apparatus typically includes an image bearing member having a function of bearing an electrostatic latent image, which is formed by charging and irradiating the surface thereof, to be developed to form a visible image. The image bearing member includes an electrophotographic photoreceptor (hereinafter referred to as “photoreceptor”).

Organic photoreceptors mainly including an organic material are widely used from the viewpoint of cost, manufacturability, flexibility in choosing material, and influence on global environment. The organic photoreceptor includes a photosensitive layer including a photoconductive material. The organic photoreceptors are broadly classified into single-layer photoreceptors including a single layer having a function of both generating and transporting charge, and functionally-separated multilayer photoreceptors including a charge generation layer having a function of generating charge and a charge transport layer having a function of transporting charge.

An electrostatic latent image is formed as follows in the functionally-separated multilayer photoreceptor:
(1) a uniformly charged surface of a photoreceptor is irradiated with a light beam;
(2) a light beam passes through a charge transport layer and absorbed by a charge generation material included in a charge generation layer, so that a pair of counter charges is produced;
(3) one of the counter charges is injected into the charge transport layer from the interface between the charge generation layer and the charge transport layer;
(4) the injected charge transfers to the surface of the photoreceptor through the charge transport layer due to a force of an electric field; and
(5) the charged surface of the photoreceptor is neutralized by the transferred charge so that an electrostatic latent image is formed.

Such a multilayer organic photoreceptor is mainly used as the photoreceptor in electrophotography because of having good electrostatic stability and durability.

Not only photoreceptors but also developers and image forming apparatuses have improved recently. Therefore, recent image forming apparatuses using an organic photoreceptor are capable of producing extremely high quality images, and are used for various purposes. In addition to the demand for high quality image, demands for full-color printing and high-speed printing have also increased. Moreover, image forming apparatuses are required to be smaller in size and to shorten a time during which a printing is performed (hereinafter referred to as “printing time”).

In order to increase the print speed, a photoreceptor needs to have a higher sensitivity and a higher linear velocity. In order to downsize an image forming apparatus, a photoreceptor needs to have a smaller diameter. In order to produce a full-color image, an image forming apparatus needs to have both a higher print speed and a smaller size, because at least four toner images are superimposed with each other. Specifically, a tandem full-color image forming apparatus containing four developing units and corresponding four photoreceptors, which has realized high-speed printing of full-color images, is required to be much smaller in size. In order to shorten the printing time, currently having a low level of user satisfaction, a warm-up time needs to be shortened and a photoreceptor needs to produce high quality image even in the first rotation thereof so that a print image is immediately discharged without idling the photoreceptor for a while after a printing operation is completed.

However, no technique is proposed at present for simultaneously realizing the above matters. For example, if the linear velocity of a photoreceptor increases or the diameter thereof decreases, chargeability and transferability thereof decrease. For another example, if the diameter of a photoreceptor decreases, the layout around the photoreceptor is largely limited. In this case, it is difficult to provide a preliminary charging and/or transfer mechanism around the photoreceptor, and to keep a satisfactory time for performing charging, irradiating, and developing processes. Therefore, the photoreceptor is required to have a higher responsiveness when charged or irradiated.

Further, electrostatic properties of a photoreceptor deteriorate by repeated use. When a photoreceptor is repeatedly used, residual potential increases and sensitivity and chargeability decrease, resulting in deterioration of responsiveness of the photoreceptor when charged or irradiated. In addition, ozone and a NOx gas generated from a charger also deteriorate electrostatic properties of a photoreceptor, resulting in deterioration of the resultant image qualities such as resolution. In particular, when a repeatedly-used and electrostatically-fatigued photoreceptor is charged, the charge level of the photoreceptor in the first rotation is smaller than that in the second rotation. (This phenomenon is hereinafter referred to as “the first rotation charge decline”.) The first rotation charge decline is taken very seriously these years.

As electrophotographic image forming apparatuses come into wider use in various fields, a demand for full-color printing is extremely increased. Therefore, image forming apparatuses will be much more required not only to stably produce high quality images, but also to have a higher print speed and a smaller size. In order to lengthen the life of a photoreceptor and an image forming apparatus using the photoreceptor, the photoreceptor is required to improve abrasion resistance and to have stable electrostatic properties. A technique for improving electrostatic properties and stability of a photoreceptor even when the photoreceptor is repeatedly used, and a technique for preventing the occurrence of the first rotation charge decline, being an obstacle for realizing high-speed printing and downsizing of the image forming apparatus, are eagerly desired.

The first rotation charge decline occurs when a photoreceptor having a high printing speed and a small diameter is electrostatically fatigued by repeated use. The difference in charge amount between the first rotation and the second rotation tends to increase as a time in which the photoreceptor is repeatedly used increases, i.e., as the level of electrostatic fatigue increases. Although the charge amount of the photoreceptor recovers in the second rotation, the first rotation charge decline reoccurs when the photoreceptor is left for a certain time. The first rotation charge decline is not a temporal phenomenon and repeatedly occurs. As the leaving time increases, the difference in the charge amount between the first rotation and the second rotation tends to increase. Further, as the linear velocity of the photoreceptor increases, the difference in charge amount between the first rotation and the second rotation tends to increase, because chargeability of the photoreceptor deteriorates.

When the first rotation charge decline occurs, background fouling, in that the background portion of an image is soiled with toner particles, is caused in the first sheet of printing, resulting in production of a poor quality image. In addition, toner particles contaminate an intermediate transfer member, resulting in promotion of contamination of paper. To solve the above problems, the photoreceptor needs to idle after each printing operation. Alternatively, a preliminary charging means needs to be provided so as to improve chargeability of the photoreceptor. The first rotation charge decline not only deteriorates the resultant image quality, but also prevents the image forming apparatus from being capable of high-speed and full-color printing and small in size. Moreover the printing time cannot be shortened. However, any conventional technique does not solve the above problems.

To prevent the occurrence of the first rotation charge decline, the following attempts have been made.

Published unexamined Japanese patent application No. (hereinafter referred to as JP-A) 10-63015 proposes a model for explaining the mechanism of the first rotation charge decline, in which a carrier generated in a charge generation layer, due to an irradiation of weak light and thermal excitation before a charging process, is trapped in a charge transport layer. According to the model, the following electrophotographic photoreceptor is disclosed: a photoreceptor in which the difference in ionization potential between the charge generation layer and the charge transport layer is smaller so that the hole mobility is increased, and an undercoat layer has a higher resistivity so that the ratio of rebinding charges is increased. However, it is described therein that the higher resistivity of the undercoat layer produces a side effect of increasing residual potential, resulting in easy trap of charges. Although the measurement method of the hole mobility is mentioned, a clear definition thereof is not mentioned at all. In addition, no mention is made of the reason why the ratio of hole-trapping decreases as the hole mobility increases.

JP-A 2002-162763 discloses an electrophotographic photoreceptor used for an electrophotographic process having a process speed of 100 mm/sec or more, in which the ionization potential of a charge transport layer is larger than that of a charge generation layer, a charge transport material and a binder resin are included at a specific ratio, and the charge transport layer has a specific transportability in an electric field having a predetermined strength. Since the ionization potential of the charge transport layer is larger than that of the charge generation layer, residual potential increases, resulting in deterioration of stability of electrostatic properties. Although the measurement method of the transportability is mentioned, a clear definition thereof is not mentioned at all. In addition, the transportability is not corresponding to the real transit time (to be explained later) of the present invention.

JP-A 2000-194145 discloses an electrophotographic photoreceptor in which activation energy required for depolarization of a charge generation layer is not greater than 0.32 eV. It is considered therein that the first rotation charge decline occurs because disordered molecules in photosensitive layers require a long time to be molecularly oriented by an electric field, i.e., the molecules are in disorder state within the first rotation. Although the electrophotographic photoreceptor includes a distyrylbenzene derivative as a charge transport material, no mention is made of a relationship between the charging time of the photoreceptor and the occurrence of the first rotation charge decline.

Japanese Patent No. (hereinafter referred to as JP) 3604914 discloses an electrophotographic photoreceptor including an intermediate layer including a polyamide resin, a specific carboxylate, and a titanium oxide, and a charge generation layer including a X-type or r-type metal-free phthalocyanine. It is considered therein that the first rotation charge decline is caused due to generation of dark charge from the phthalocyanine compound being left. It is disclosed therein that the photoreceptor is sufficiently charged even in the first rotation because of including the intermediate layer including the titanium oxide and the carboxylate. However, it is unclear whether or not the first rotation charge decline occurs even after repeated use, because only unused photoreceptors are evaluated in Examples.

JP-A 2000-321805 discloses an electrophotographic photoreceptor including an undercoat layer having a specific electron transportability, specifically including a charge transport material. It is described therein that increase of residual potential and deterioration of sensitivity are prevented in such an electrophotographic photoreceptor. Although the electrophotographic photoreceptor includes a distyrylbenzene derivative as a charge transport material, no mention is made of a relationship between the charging time of the photoreceptor and the occurrence of the first rotation charge decline.

JP-A 10-186703 discloses an electrophotographic photoreceptor including an undercoat layer including a semiconductive material having a band gap of 2.2 eV or more and a binder resin, and a photosensitive layer including a phthalocyanine compound as a charge generation material. It is considered therein that the first rotation charge decline is caused due to generation of dark charge from the phthalocyanine compound being left, or charge injection from a substrate or the undercoat layer. However, the photoreceptors disclosed in Examples do not have much effect on prevention of the first rotation charge decline.

JP-A 2001-350329 discloses an electrostatic printing device in which the charging time of a photoreceptor is from 50 to 1,000 msec. It is disclosed therein that the photoreceptor has an unstable charge potential if the charging time is less than 50 msec. However, no mention is made of the transit time (to be explained later).

JP-A 08-36301 discloses an electrophotographic copying method in which an image is formed without optical diselectrification in the first rotation while an image is formed with optical diselectrification in the second or later rotation. It is considered therein that the first rotation charge decline is a phenomenon specific to a photoreceptor including a phthalocyanine compound. A model in which an excessive amount of carriers produced in the optical diselectrification are temporarily trapped in electron traps in a charge generation layer, and subsequently a part of the trapped charges are discharged at a time of the next charging process is proposed. According to the model, it is disclosed therein that diselectrification is not needed in the first rotation. However, there is a concern that the background fouling and ghost image are caused in the resultant image, particularly when the linear velocity is large.

JP-A 2002-268335 discloses an image forming method including an irradiating process in which a photoreceptor including an intermediate layer including N-type semiconductive particles and a charge generation layer including a phthalocyanine pigment is irradiated with light containing image information; and a preliminary charging process, an optical diselectrification process, and a charging process, which are preceding the irradiating process. The preliminary charging process has an effect on increasing chargeability of the photoreceptor. However, the preliminary charging process requires a large number of members provided around the photoreceptor, and therefore reducing of the diameter of the photoreceptor is limited. Moreover, the generation amount of an oxidizing gas increases, resulting in acceleration of deterioration of electrostatic properties of the photoreceptor.

As mentioned above, various attempts have made to prevent the first rotation charge decline, from the viewpoints of charge generation layer, charge transport layer, and undercoat layer of photoreceptor, and the like. Various assumed models have also been proposed to explain the mechanism of the first rotation charge decline, but the truth is not clear yet. The conventional techniques for preventing the first rotation charge decline are still unsatisfactory. For example, a technique causes side effects such that residual potential increases and image quality deteriorates. Another technique can be applied only for low-speed machines, and cannot be applied for high-speed machines. Yet another technique does not allow a photoreceptor to reduce the diameter thereof and an image forming apparatus to downsize, because the layout around the photoreceptor is complicated.

### SUMMARY OF THE INVENTION

Accordingly, an object of the present invention is to provide a compact image forming apparatus and a process cartridge, capable of producing high quality images in high-speed. Specifically, the occurrence of the first rotation charge decline is prevented without deteriorating electrostatic properties of the photoreceptor used and the quality of the resultant image.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a graph, having a shape of rectangular wave, for explaining how to determine the transit time of a charge transport layer;

FIG. 2 is another graph, having a shape of dispersive wave, for explaining how to determine the transit time of a charge transport layer;

FIG. 3 is yet another graph for explaining how to determine the transit time of a charge transport layer;

FIG. 4 is a schematic view illustrating an embodiment of an apparatus for measuring the real transit time;

FIG. 5 is an optical attenuation curve obtained by an apparatus for measuring the real transit time;

FIG. 6 is a graph for explaining how to determine the real transit time;

FIG. 7 is a schematic view for explaining how to determine the charging width of a scorotron charger;

FIG. 8 is a schematic view for explaining how to determine the charging width of a contact roller charger;

FIG. 9 is a schematic view illustrating an embodiment of a closely spacing roller charger;

FIG. 10 is a schematic view illustrating an embodiment of an image forming apparatus of the present invention;

FIG. 11 is a schematic view illustrating an embodiment of a tandem image forming apparatus of the present invention;

FIG. 12 is a schematic view illustrating an embodiment of a process cartridge of the present invention;

FIGS. 13 to 18 are schematic cross sectional views illustrating embodiments of image bearing member used for the present invention; and

FIG. 19 is an X-ray diffraction spectrum of the charge generation material used in Examples.

### DESCRIPTION OF THE PREFERRED EMBODIMENTS

The present invention will be explained in detail.

The present inventors assume that the first rotation charge decline is caused by holes trapped in a charge generation layer, due to electrostatic fatigue of a photoreceptor. These holes trapped in the charge generation layer are thermally relaxed as being left, and become easily releasable. When the photoreceptor is charged, the thermally relaxed and easily releasable holes are injected from the charge generation layer to a charge transport layer due to a force of an electric field, and transfer to the surface of the photoreceptor through the charge transport layer so that the surface charge is neutralized. Thus, the charge decline is caused.

According to the above-described assumption, it is considered that the first rotation charge decline can be prevented if almost all of the trapped and released holes reach the surface of the photoreceptor within the initial stage of the first charging. The present inventors found that the first rotation charge decline can be prevented when the charging time is longer than a time in which almost all of the holes injected from the charge generation layer into the charge transport layer reach the surface of the charge transport layer.

In order to lengthen the charging time, the linear velocity of the photoreceptor may slow down. The present inventors found that as the linear velocity decreases, the occurrence of the first rotation charge decline decreases. It is clear that decreasing of the linear velocity is effective for preventing the first rotation charge decline. In particular, the first rotation charge decline notably occurs when the rotational velocity of the photoreceptor is not less than 80 rpm. However, decreasing of the linear velocity is an obstacle for realizing high-speed printing. Therefore, decreasing of the linear velocity is not a suitable method for an image forming apparatus in which a photoreceptor has a rotational velocity of not less than 80 rpm.

Since the linear velocity (mm/min) largely differs depending on the outer diameter (mm) of a photoreceptor, the rotational velocity (rpm), obtained by dividing the linear velocity (mm/min) by the outer diameter (mm), is preferably used in the present invention.

To lengthen the charging time of an image forming apparatus in which a photoreceptor has a rotational velocity of not less than 80 rpm, a charger may be upsized or a plurality of chargers may be provided. For example, the charging time can be lengthened if a charger has a large width or a preliminary charger is provided. Although the first rotation charge decline can be prevented by the above-mentioned methods, upsizing of the image forming apparatus is inevitable. Particularly, a photoreceptor having a small diameter cannot be used because there is no space for providing a large-sized charger and a plurality of chargers around such a photoreceptor. This fact becomes a big problem particularly for tandem fill-color image forming apparatuses. The conventional method of lengthening the charging time is not suitable for preventing the first rotation charge decline, because high-speed printing and downsizing of an image forming apparatus are sacrificed.

In the present invention, prevention of the first rotation charge decline without sacrificing high-speed printing and downsizing of an image forming apparatus is achieved by using a photoreceptor including a charge transport layer including a charge transport material having high transportability with less dependence on electric field strength. Thereby, the real transit time (to be explained later) is always smaller than the charging time, and therefore the first rotation charge decline can be prevented even if the image forming apparatus has a high printing speed, the photoreceptor has a small diameter, a large-sized charger or a plurality of chargers are not provided, and/or the photoreceptor does not idle after the first rotation.

The present invention contemplates the provision of an image forming apparatus, including an image bearing member including a conductive substrate and a photosensitive layer including a charge generation material and a charge transport material, located overlying the conductive substrate; a charger configured to charge the image bearing member; an irradiator configured to irradiate the image bearing member so as to form an electrostatic latent image thereon; and a developing device configured to develop the electrostatic latent image formed on the image bearing member, wherein the following relationships (1) and (2) are satisfied:

T1≦T2 (1)

T2=W/V (2)

wherein T1 (msec) represents a real transit time, defined as a value on X-axis of a first flection point, at which a surface potential (Y) of the image bearing member firstly rises up when a time (X) between irradiating the image bearing member and measuring the surface potential of the irradiated portion thereof is shortened, in a graph showing a relationship between X and Y; T2 (msec) represents a charging time; W (mm) represents a charging width of the charger; and V (mm/msec) represents a linear velocity of the image bearing member.

When the relationship (1) is satisfied, almost all of the holes present in the photosensitive layer, which cause the first rotation charge decline, are capable of reaching the surface of the image bearing member within a predetermined time. Therefore, the first rotation charge decline can be prevented in the image forming apparatus of the present invention without decreasing the printing speed.

The first rotation charge decline can be much more effectively prevented when the photosensitive layer has a multilayer structure in which a charge generation layer and a charge transport layer are overlaid with each other. The multilayer structure also improves electrostatic properties and stability of the image bearing member, resulting in lengthening the life thereof

The charge transport material preferably includes a compound having the following formula (3):

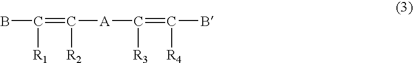

wherein each of R₁ to R₄ independently represents a hydrogen atom, an alkyl group having 1 to 4 carbon atoms, an alkoxy group having 1 to 4 carbon atoms, or a phenyl group which may have a substituent group such as an alkyl group having 1 to 4 carbon atoms and an alkoxy group having 1 to 4 carbon atoms; A represents a substituted or unsubstituted arylene group or the following functional group:

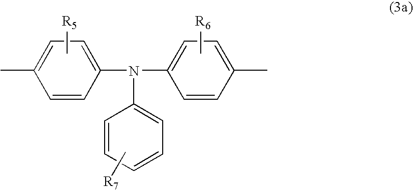

wherein each of R₅ to R₇ independently represents a hydrogen atom, an alkyl group having 1 to 4 carbon atoms, an alkoxy group having 1 to 4 carbon atoms, or a phenyl group which may have a substituent group such as an-alkyl group having 1 to 4 carbon atoms and an alkoxy group having 1 to 4 carbon atoms; and each of B and B′ independently represents a substituted or unsubstituted aryl group or the following functional group:

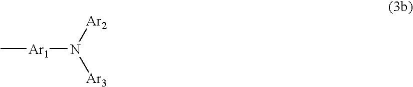

wherein Ar₁ represents an arylene group which may have a substituent group such as an alkyl group having 1 to 4 carbon atoms and an alkoxy group having 1 to 4 carbon atoms; and each of Ar₂ and Ar₃ independently represents an aryl group which may have a substituent group such as an alkyl group having 1 to 4 carbon atoms and an alkoxy group having 1 to 4 carbon atoms.

Use of the charge transport material having the formula (3) contributes to shorten the real transit time (to be explained later), resulting in effective prevention of the first rotation charge decline. The short real transit time provides a large margin of the charging time, resulting in high-speed printing. In addition, the diameter of the image bearing member can be reduced, resulting in downsizing of the image forming apparatus.

The compound having the formula (3) has an extremely high charge transportability. Further, the charge transportability less depends on electric field strength. In other words, a charge is sufficiently movable to the surface of the image bearing member even with a low electric field strength. It is also important that the charge mobility does not vary much among charges. The occurrence of the first rotation charge decline largely depends on a time when the movement of charges to the surface of the image bearing member is completed, not depending on a time when the movement of charges is started or is in progress. It is previously known that the compound having the formula (3) has a high charge transportability when measured by time-of-flight (TOF) method. On the other hand, the charge transportability is never evaluated in consideration of dependence to electric field strength and a time when the movement of charges to the surface of the image bearing member is completed. In the present invention, the charge transport material having the formula (3) allows almost all of the holes, which cause the first rotation charge decline, to reach the surface of the image bearing member within the initial stage of the charging in which an electric field having a weak strength is provided.

Among the charge transport materials having the formula (3), compounds having the following formulae (4) and (5) can effectively prevent the first rotation charge decline:

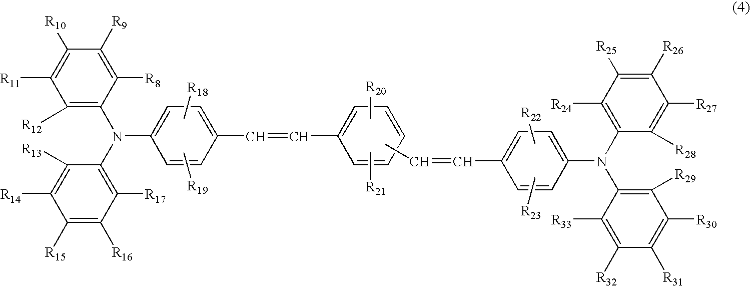

wherein each of R₈ to R₃₃ independently represents a hydrogen atom, an alkyl group having 1 to 4 carbon atoms, an alkoxy group having 1 to 4 carbon atoms, or a substituted or unsubstituted phenyl group;

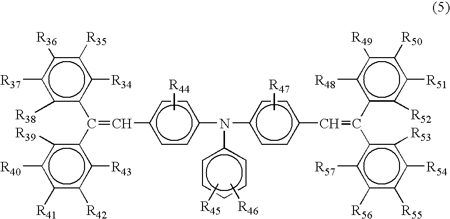

wherein each of R₃₄ to R₅₇ independently represents a hydrogen atom, an alkyl group having 1 to 4 carbon atoms, an alkoxy group having 1 to 4 carbon atoms, or a substituted or unsubstituted phenyl group.

The reason why the compounds having the formulae (4) and (5) can effectively prevent the first rotation charge decline is considered to be that π-conjugated systems are spread over the molecule, because the molecule has a large size and a linear structure and includes a triphenylamine structure and a plurality of styryl structures. Thereby, intramolecular charge transfer is more likely to occur than intermolecular charge transfer in the charge transport layer, resulting in very high charge transportability. As a result, almost all of the holes, which cause the first rotation charge decline, can reach the surface of the image bearing member even in an electric field having a weak strength, provided in the initial stage of the charging.

When the following relationship (6) is satisfied, holes are prevented from trapping in the interface between the charge generation layer and the charge transport layer, resulting in prevention of increase of residual potential:

Ip_{CGM}−Ip_{CTM}≧−0.1 (6)

wherein Ip_{CGM} (eV) represents an ionization potential of the charge generation material and Ip_{CTM} (eV) represents an ionization potential of the charge transport material.

If holes are trapped in the interface between the charge generation layer and the charge transport layer, the absolute amount of holes reaching the surface of the image bearing member decreases, and residual potential tends to increase while the occurrence of the first rotation charge decline is slightly reduced. The increase of residual potential causes deterioration of image density and gradation. In the present invention, the increase of residual potential and the first rotation charge decline can be simultaneously prevented. Therefore, the present invention can provide an image forming apparatus capable of producing high quality images with a high printing speed and a compact size.

In the present invention, the real transit time can be shortened when the photosensitive layer or the charge transport layer includes at least one of a polycarbonate and a polyarylate as a binder resin. The binder resin preferably does not inhibit the function of the charge transport material. In addition, the binder resin preferably has high electrostatic property and abrasion resistance.

In the present invention, the photosensitive layer or the charge transport layer may include a charge transport polymer as the binder resin. In this case, the binder resin also has a function of charge transportation. Thereby, the real transit time can be much more shortened, resulting in prevention of the first rotation charge decline.

In the present invention, the real transit time can be much more shortened when the photosensitive layer or the charge transport layer includes both the charge transport material and the charge transport polymer, in which the difference in ionization potential therebetween is not greater than 0.1 eV, resulting in prevention of the first rotation charge decline. In addition, increase of residual potential can be also prevented, resulting in stabilization of electrostatic properties and image quality. Therefore, the present invention can provide an image forming apparatus capable of producing high quality images with a high printing speed and a compact size.

In the present invention, the photosensitive layer or the charge transport layer may further include at least one compound having the following formulae (7) or (8):

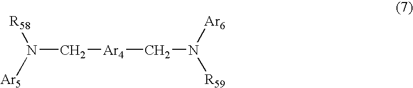

wherein Ar₄ represents a substituted or unsubstituted arylene group; each of Ar₅ and Ar₆ independently represents a substituted or unsubstituted aryl group, a substituted or unsubstituted alkyl group, or a substituted or unsubstituted aralkyl group; each of R₅₈ and R₅₉ independently represents a substituted or unsubstituted aralyl group or a substituted or unsubstituted aralkyl group; Ar₅ and R₅₈ optionally share bond connectivity to form a substituted or unsubstituted heterocyclic ring containing a nitrogen atom; and Ar₆ and R₅₉ optionally share bond connectivity to form a substituted or unsubstituted heterocyclic ring containing a nitrogen atom;

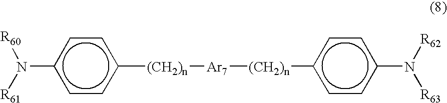

wherein Ar₇ represents a substituted or unsubstituted arylene group; each of R₆₀ to R₆₃ independently represents a substituted or unsubstituted alkyl group or a substituted or unsubstituted aralkyl group; and n represents an integer of 1 or 2.

The compound having the formulae (7) or (8) can prevent image deletion and deterioration of image resolution caused due to an oxidizing gas without influencing the real transit time, resulting in production of high quality images. The compound having the formula (3) has low stability with respect to an oxidizing gas because of having a distyryl structure. Therefore, image deletion and deterioration of image resolution may occur when the concentration of the oxidizing gas is very high. This phenomenon notably occurs when the charge transport material has a low ionization potential. A combination of the compound having the formulae (7) or (8) and the compound having the formula (3) can prevent not only image deletion and deterioration of image resolution caused due to an oxidizing gas, but also increase of residual potential and the first rotation charge decline. As a result, high quality images can be stably produced. In case the compound having the formula (3) may produce cracks on the photoreceptor, the compound having the formulae (7) or (8) can function as a crack inhibitor.

In the present invention, the photosensitive layer or the charge transport layer may further include at least two antioxidants each having one of the following formulae (9) to (12):

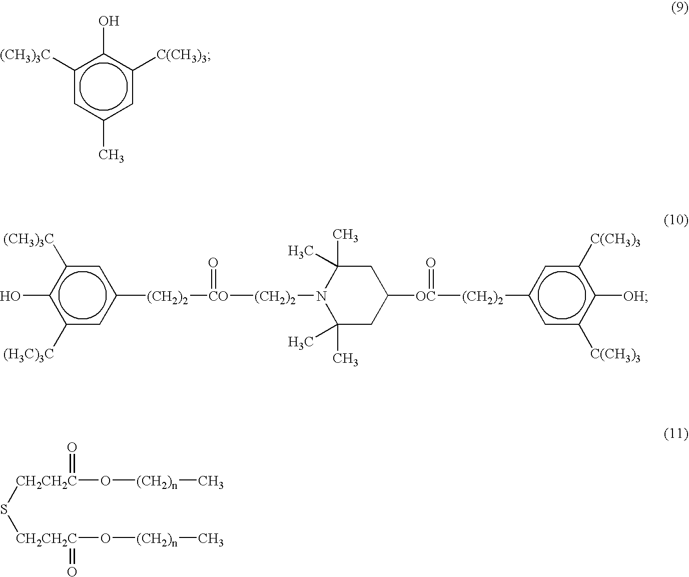

wherein n represents an integer of from 12 to 18; and

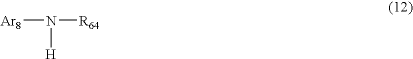

wherein Ar₉ represents a substituted or unsubstituted aryl group; and R₆₄ represents a hydrogen atom, a substituted or unsubstituted alkyl group, a substituted or unsubstituted aralkyl group, or a substituted or unsubstituted aryl group.

A combination of two antioxidants having one of the formulae (9) to (12) can prevent deterioration of image resolution caused due to an oxidizing gas. In addition, the photoreceptor is prevented from being electrostatically fatigued, resulting in prevention of the first rotation charge decline. A single antioxidant is also effective, however, a combination of two antioxidants is preferable in the present invention.

In the present invention, the charge generation material preferably includes a titanyl phthalocyanine pigment because of having high sensitivity. JP-A's 08-36301, 10-186703, and 2005-134674 have described that the first rotation charge decline is a problem specific to the use of phthalocyanine pigments; however, it is confirmed that the first rotation charge decline also occurs when azo pigments are used.

The charge generation material preferably includes an asymmetric bisazo pigment having the following formula (13):

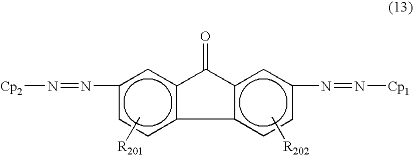

wherein each of R₂₀₁ and R₂₀₂ independently represents a hydrogen atom, a halogen atom, an alkyl group, an alkoxy group, or a cyano group; and each of Cp₁ and Cp₂, being different from each other, independently represents a residue group of a coupler, having the following formula (14):

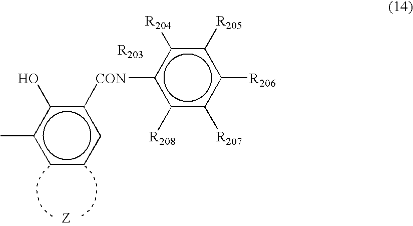

wherein R₂₀₃ represents a hydrogen atom, an alkyl group such as methyl group and ethyl group, or an aryl group such as phenyl group; each of R₂₀₄ to R₂₀₈ independently represents a hydrogen atom, a nitro group, a cyano group, a halogen atom such as fluorine, chlorine, bromine, and iodine, a trifluoromethyl group, an alkyl group such as methyl group and ethyl group, an alkoxy group such as methoxy group and ethoxy group, a dialkylamino group, or a hydroxyl group; and Z represents an atomic group needed for constituting a substituted or unsubstituted aromatic carbocyclic ring or a substituted or unsubstituted aromatic heterocyclic ring.

In this case, the image forming apparatus has high sensitivity, high chargeability, and less possibility to cause background fouling. Therefore, high-speed printing and production of high quality images are simultaneously achieved. In addition, the first rotation charge decline can be effectively prevented. Since the object of the present invention is to provide an image forming apparatus capable of stably producing high quality images even when the printing speed is high and the diameter of the image bearing member is small, the highly-sensitive charge generation materials mentioned above are necessary.

Since the asymmetric bisazo pigment having the formula (13) has a large ionized potential, residual potential hardly increases. Moreover, the residual potential has less dependence on electric field strength, and therefore the asymmetric bisazo pigment having the formula (13) is preferably used for full-color image forming apparatuses.

In the present invention, an undercoat layer and/or a resin layer may be provided between the conductive substrate and the photosensitive layer or the charge generation layer. Thereby, the occurrence of background fouling and moiré can be notably prevented. The undercoat layer is densely filled with a plurality of titanium oxide pigments each having a different number average primary particle diameter, and therefore the first rotation charge decline, increase of residual potential, and the occurrence of moiré are effectively prevented. On the other hand, the resin layer effectively prevents the occurrence of background fouling. When a coating liquid for the charge transport layer including the charge transport material having the formulae (3), (4), or (5) is coated on the charge generation layer, the charge transport material may penetrate to the undercoat layer. In this case, background fouling may notably occur because holes are excessively injected from the substrate, due to high charge injection ability and transportability of the charge transport material. The hole injection can be effectively prevented by providing the resin layer.

In the image forming apparatus of the present invention, the image bearing member can be uniformly charged by use of a scorotron charger. Since the scorotron charger is not in contact with the image bearing member, the scorotron charger is preferably used from the viewpoint of increasing the linear velocity of the image bearing member. In addition, the first rotation charge decline is effectively prevented even when the linear velocity of the image bearing member increases, because the charging time can be easily lengthened because of the structure of the scorotron charger. Since the first rotation charge decline is prevented by transporting almost all of the holes to the surface of the image bearing member, the use of the scorotron charger which can lengthen the charging time is effective for the present invention.

In the present invention, use of a scorotron charger including a plurality of wires can much more lengthen the charging time, resulting in improvement of chargeability of the image bearing member. Since the first rotation charge decline notably occurs as the printing speed increases, the use of the scorotron charger including a plurality of wires is effective for preventing the first rotation charge decline in a high-speed image forming apparatus.

Since a tandem image forming apparatus includes at least four image bearing members corresponding to four developing parts, the diameters of the image bearing members need to be reduced. Therefore, provision of a preliminary charger is limited in the tandem image forming apparatus. On the other hand, the tandem image forming apparatus is capable of producing full-color images in high speed. By providing the image forming apparatus of the present invention in a tandem manner, high quality images can be produced with reducing the diameters of the image bearing members and increasing the printing speed.

The process cartridge of the present invention is detachably attachable to the image forming apparatus of the present invention. Therefore, the image forming apparatus has high maintainability. By use of the process cartridge, the image bearing member and components provided around the image bearing member are easily replaced even when these components are damaged due to high-speed printing.

As mentioned above, recent image forming apparatuses are required to print full-color images in higher speed, be smaller in size, shorten the printing time, etc., but the first rotation charge decline is being an obstacle for all of the above requirements.

Increase of the linear velocity and reduction of the diameter of an image bearing member deteriorate chargeability thereof and cause the first rotation charge decline. Conventionally, to avoid the effect of the first rotation charge decline, an image bearing member is idled in the first rotation, resulting in lengthening of the printing time. To avoid the lengthening of the printing time, a technique for providing a preliminary charger is proposed. However, this technique is not suitable for reducing the diameter of an image bearing member and downsizing an image forming apparatus because the number of components provided around the image bearing member increases. Further, in order to produce full-color images, an image forming apparatus is much more required to print images in higher speed and be smaller in size because at least four toner images are superimposed. Particularly, reduction of the diameters of image bearing members in a tandem image forming apparatus, which realizes high-speed full-color printing, is necessary because the image forming apparatus includes four image bearing members corresponding to four developing parts. If the first rotation charge decline is prevented, the above-mentioned problems are also solved.

In addition to preventing the first rotation charge decline, deterioration of electrostatic properties (e.g., increase of residual potential, deterioration of sensitivity and chargeability) should also be prevented. This is because the deterioration of electrostatic properties causes various image defects such as low image density, poor color reproducibility, and background fouling. The electrostatic properties should be stabilized for another reason that the occurrence of the first rotation charge decline increases as the level of electrostatic fatigue of an image bearing member increases. The present inventors found that a most effective way to prevent the first rotation charge decline and to stabilize electrostatic properties of an image bearing member at the same time is to transport almost all of the holes, which cause the first rotation charge decline, to the surface of the image bearing member within the initial stage of the charging process.

As mentioned above, it is considered that the first rotation charge decline is caused by holes trapped in the photosensitive layer or the charge generation layer, due to the electrostatic fatigue of the image bearing member, which are thermally relaxed as being left and become easily releasable. In order to transport almost all of the holes to the surface of the image bearing member within the initial stage of the charging process, the transportability of the charge transport layer is increased or the charging time is lengthened. The lengthening of the charging time is not suitable for realizing high-speed printing even if the first rotation charge decline is prevented. Although reduction of the diameter of the image bearing member is effective for shortening the charging time, downsizing of the image forming apparatus is limited. Therefore, it is necessary that the holes accumulated in the photosensitive layer due to the electrostatic fatigue, which causes the first rotation charge decline, have as high a mobility as possible so as to reach the surface of the image bearing member within the charging time, even if the charging time is short.

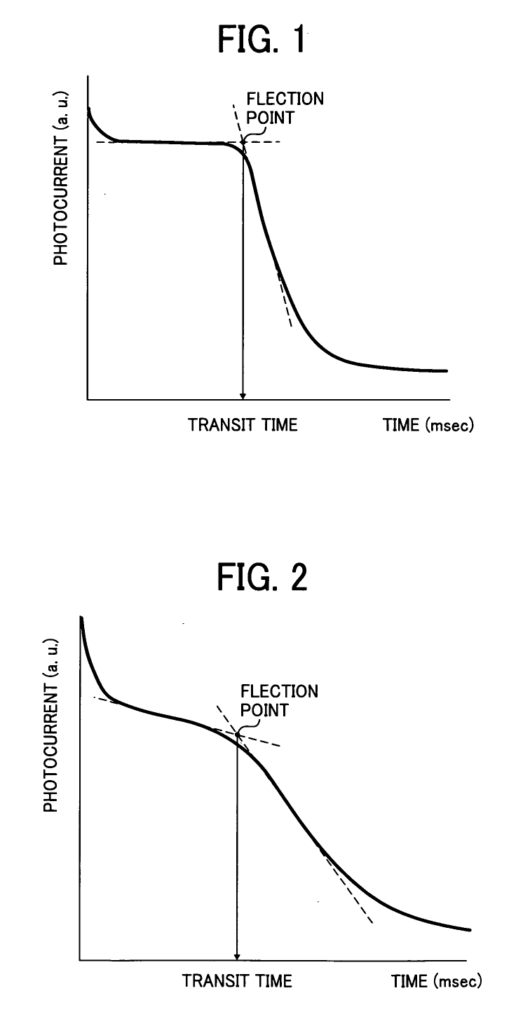

Techniques to increase the transportability of the charge transport layer have proposed to prevent the first rotation charge decline. Almost all of the transportability discussed in the conventional techniques is calculated from a transit time determined by time-of-flight (TOF) method, which is one of typical and effective methods for designing an image bearing member. The transit time is defined as a time required for most of photocarriers, produced in an image bearing member, to transport through the image bearing member along an external electric field. As illustrated in FIG. 1, the transit time is estimated by finding a flection point in a graph showing the time dependency of the photocurrent. The transit time depends on the thickness of the photosensitive layer of an image bearing member. Therefore, the drift transportability defined by the following equation (15) is typically used:

μ=d²/(TrV) (15)

wherein μ (cm²/V·s) represents a drift transportability, d (cm) represents the thickness of a photosensitive layer, Tr (sec) represents the transit time, and V (V) represents the voltage (V).

The graph illustrated in FIG. 1 has a shape of a rectangular wave, showing that a time between starting and finishing transportation of charges is relatively short. On the other hand, the graph illustrated in FIG. 2 has a shape of dispersive wave, showing that transportability largely varies among charges. It is difficult to consider that the transit time determined from the flection point represents a movement time required for most of the photocarriers produced in the image bearing member to move therein. Particularly in FIG. 2, there is a large difference between the transit time determined from the flection point and a real time in which most of the charges move to the surface of the image bearing member. In order to prevent the first rotation charge decline, according to the present invention, almost all of the holes present in the photosensitive layer need to quickly move to the surface of the image bearing member within a short charging time. Therefore, the first rotation charge decline cannot be prevented when a large amount of time is required for the charge transportation, even if the transit time determined from the flection point is short or the charge transportability is large.

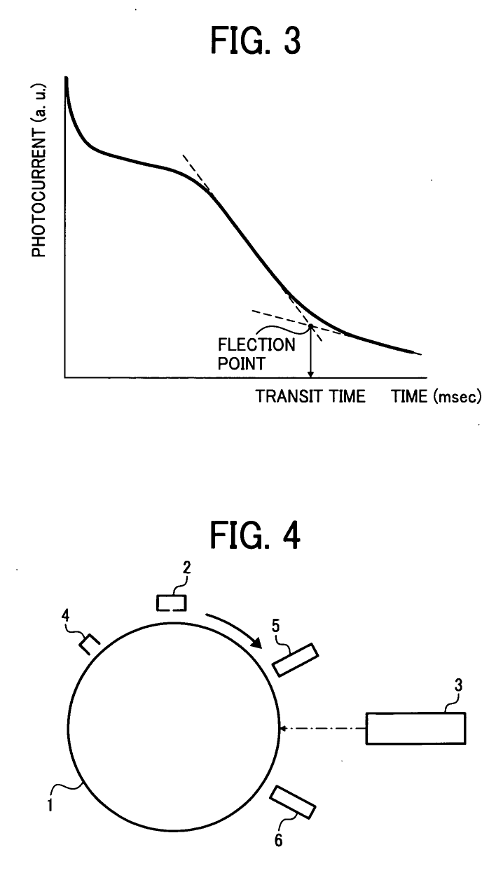

As another method for estimating the transit time, a method using a time when the photocurrent is ½ or 1/10 of the photocurrent at the above-mentioned transit time determined from the flection point, and a method using a flection point as illustrated in FIG. 3 (disclosed in JP-A 2003-195536) has proposed. These methods can provide a nearly real time in which almost all of the charges finish moving. However, a large noise prevents the accurate estimation of the transit time.

The TOF method has a disadvantage that the transit time is estimated under the fixed electric field strength, while the electric field strength varies every moment in a real image formating apparatus due to irradiation of the image bearing member. The TOF method has another disadvantage that the light source used therein differs from a typical irradiator used in an image forming apparatus. There is a concern that the charge transport material is influenced by the light source used in the TOF method so that new trap sites are formed. Moreover, in the TOF method, since the measurement is performed by sandwiching the charge transport layer with a pair of electrodes, an influence of charge injection occurred at the interface between the charge generation layer and the charge transport layer is ignored in a multilayer image bearing member. For the above reasons, the TOF method is suitable for comparing the transportability of charge transport materials themselves, but not suitable for accurately estimating the transit time of an image bearing member, particularly a multilayer image bearing member, used in a real image forming apparatus.

A charge transport layer having high transportability is generally effective for preventing the first rotation charge decline because almost all of the holes present in the photosensitive layer reach the surface of the image bearing member within a short charging time. However, the transit time determined by the TOF method does not accurately represent the behavior of charges in an image bearing member used in a real image forming apparatus. Therefore, it is not clear whether or not the transit time determined by the TOF method has a relationship with the occurrence of the first rotation charge decline.

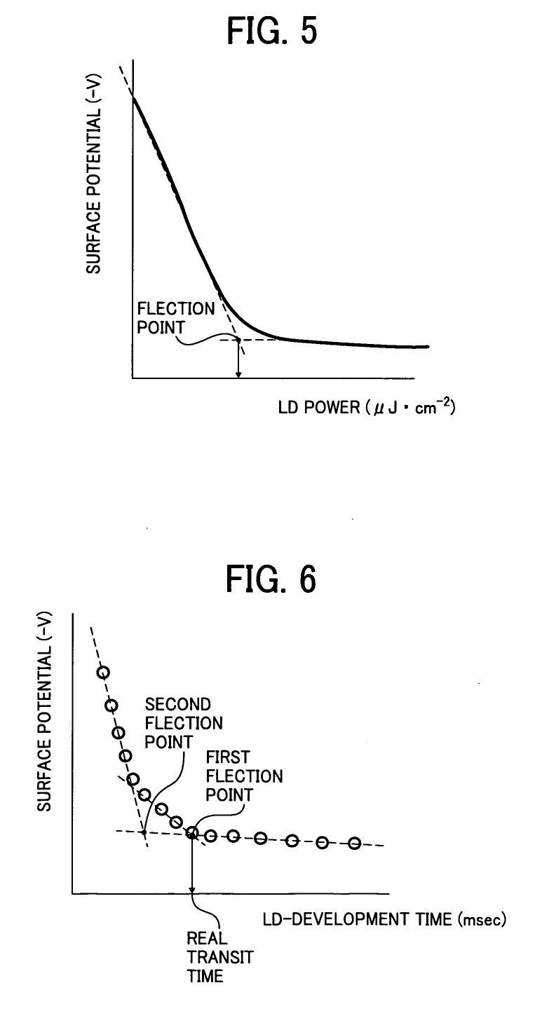

JP-A 2000-275872 discloses an apparatus for determining the transit time in which almost all of holes present in an image bearing member, which cause the first rotation charge decline, reach the surface of the image bearing member. As illustrated in FIG. 4, an image bearing member 1 is charged with a charger 2 and the surface potential of non-irradiated portion is measured with a first surface electrometer 5. Subsequently, the image bearing member 1 is irradiated by an irradiator 3 and the surface potential of irradiated portion is measured with a second surface electrometer 6 located in a developing part. The image bearing member 1 is finally diselectrified with a diselectrification device 4. By varying the amount of the irradiating light, an optical attenuation curve as illustrated in FIG. 5 is obtained.

Since the angle between the irradiator 3 and the second surface electrometer 6 located in a developing part is variable, a time between irradiating the image bearing member 1 with a predetermined amount of irradiating light and measuring the surface potential of the irradiated portion (this time may be hereinafter referred to as “development time”) is also variable. When the measurement of the surface potential of the irradiated portion is repeated by varying the development time, a relationship between the development time and the surface potential of the irradiated portion is obtained as illustrated in FIG. 6. The predetermined amount of irradiating light is determined from a flection point of the optical attenuation curve illustrated in FIG. 5. Referring to FIG. 6, as the development time becomes shorter, the surface potential of the irradiated portion linearly increases, and a first flection point and a second flection point are observed.

In 2000-275872, a development time at the first flection point is regarded as the transit time, at which almost all of holes present in the image bearing member, which cause the first rotation charge decline, reach the surface of the image bearing member. By using the above apparatus, the transit time of a real image bearing member can be easily and accurately measured under much the same conditions of the real image forming apparatus.

In the present invention, the transit time determined by the above-mentioned apparatus or the like, capable of measuring the transit time of a real image bearing member under much the same conditions of a real image forming apparatus, is defined as “the real transit time”.

The shorter real transit time an image bearing member has, the higher printing speed and the smaller size an image forming apparatus employing the image bearing member has. However, the first rotation charge decline cannot be prevented when the charging time is shorter than the real transit time or the charging is uneven, even if the real transit time is small. Therefore, a charger capable of providing a charging time longer than the real transit time of an image bearing member and uniformly charging the image bearing member is needed.

Any chargers capable of providing a charging time longer than the real transit time of an image bearing member can be used in the present invention. Suitable chargers for use in the present invention include, but are not limited to, corona discharge chargers, such as corotron and scorotron, in which a high voltage is applied to a wire; solid discharge chargers in which a high-frequency high voltage is applied to sheet-like electrodes sandwiching an insulating plate; contact roller chargers in which a roller-shaped member to which a high voltage is applied is in contact with an image bearing member; closely spacing roller chargers in which a roller-shaped member forms a gap of not greater than 100 μm from an image bearing member in an image forming part; and contact chargers in which a brush, a film, a blade, and the like, is in contact with an image bearing member.

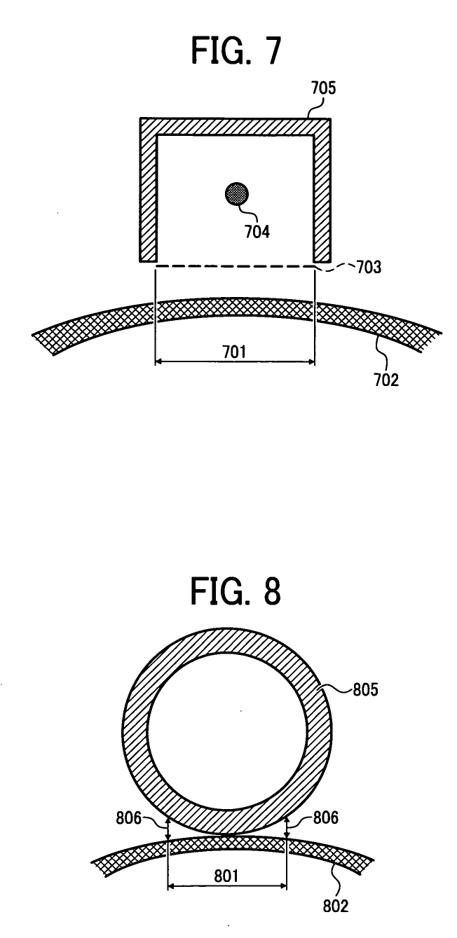

Among these chargers, corona discharge chargers are most preferably used in the present invention. In the corona discharge charger, a high voltage is applied to a wire having a diameter of from 50 to 100 μm so that air around the wire is ionized and the ions are moved to an image bearing member, resulting in charging of the image bearing member. The corona discharge chargers are broadly classified into corotron and scorotron. The scorotron has a configuration such that a screen electrode (i.e., grid) 703 is provided in the corotron, as illustrated in FIG. 7. The screen electrode 703 has a pitch of from 1 to 3 mm and provided forming a gap of from 1 to 2 mm from an image bearing member 702. Thereby, the surface potential of the image bearing member 702 can be saturated even if the charging time is long, because the charging potential is controlled by a voltage applied to the grid 703. The charging potential is controlled by the grid voltage, resulting in uniform charging of the image bearing member. The scorotron, capable of uniformly charging an image bearing member, is more preferably used in the present invention because the first rotation charge decline is effectively prevented, a margin for realizing high-speed printing and downsizing of an apparatus increases, and high quality images can be produced.

To respond to a demand of high-speed printing, the use of a double-wire charger in which two wires are stretched is effective. In particular, a double-wire charger in which two wires are partitioned is also effective. In order to prevent the occurrence of discharge between the two wires or between the wires and a casing, a gap of not less than 1.5 mm per 1 kV needs to be formed. A double-wire scorotron has a large charging width, and therefore the charging time can be shortened. As a result, the first rotation charge decline is effectively prevented.

The charging width of the corotron is equal to the opening width of a casing. In the corotron, the charging current may vary by location. On the other hand, the scorotron is capable of uniformly charging the image bearing member 702 because of including the grid 703, resulting in effective prevention of the first rotation charge decline. As illustrated in FIG. 7, the charging width 701 of the scorotron depends on the width of the grid 703. The shape of a casing 705 may be box-like, cylindrical, etc., and is not particularly limited. The charging width absolutely depends on the opening width or grid width.

The charging time is defined by the following equation (2):

T2=W/V (2)

wherein T2 (msec) represents a charging time, W (mm) represents the charging width of a charger, and V (mm/msec) represents the linear velocity of an image bearing member.

When the charger is the scorotron or corotron, the charging time is determined by dividing the opening width of the casing of the corotron or the grid width of the scorotron, respectively, by the linear velocity of the image bearing member.

In the contact roller chargers, a conductive roller (i.e., charging roller) 805 to which a voltage is applied is in contact with an image bearing member 802 so as to give charges to the image bearing member 802, as illustrated in FIG. 8. The contact roller chargers have advantages over the corona discharge chargers that the applied voltage is smaller, the device is smaller in size, and a less amount of ozone is produced. However, when the contact roller charger is used in a high-speed apparatus, the roller may be contaminated and the life thereof may be shortened, resulting in deterioration of charging ability. Therefore, the contact roller charger is suitable for use in a compact image forming apparatus employing an image bearing member having a small diameter rather than a high-speed image forming apparatus.

Although the actual contact area between the charging roller 805 and the image bearing member 802 is very small, the charging width 801 depends on the width of a region where a gap 806 formed between the charging roller 805 and the image bearing member 802 has a distance not greater than 300 μm, as illustrated in FIG. 8. This is because the image bearing member is actually charged due to the charge-transfer caused by a discharge in the gap. When a DC (direct current) is overlapped with an AC (alternating current), the image bearing member is much more uniformly charged, resulting in effective prevention of the first rotation charge decline.

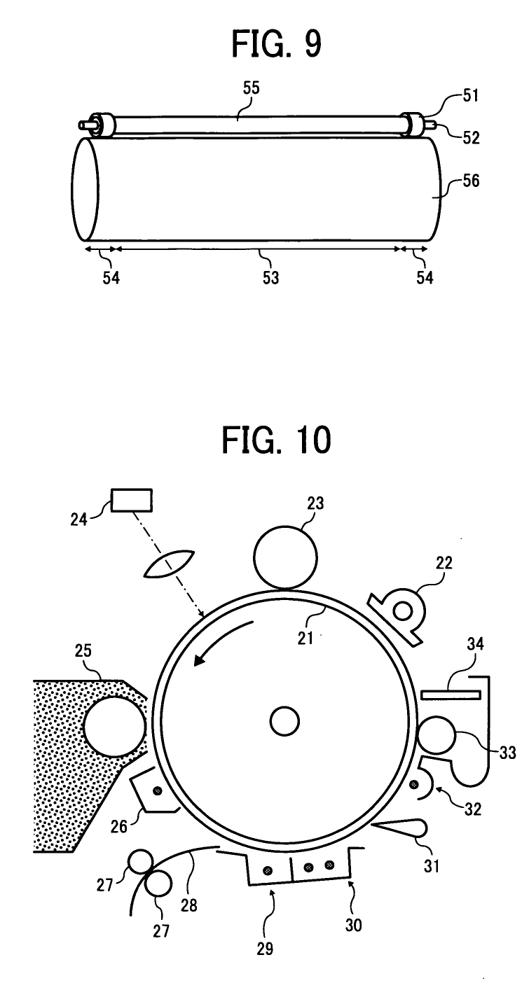

The closely spacing roller chargers in which a charging roller is not in contact with an image bearing member in the image forming part are also used. In the closely spacing roller charger, the charging roller is not so much contaminated with developer or paper powder even after repeated use, and prevented from being abraded. As a result, charging ability does not deteriorate and abnormal images are not produced. To closely provide the image bearing member to the charging roller in the image forming part, a method of forming a height gap on the non-image-forming part is proposed. For example, as illustrated in FIG. 9, a gap forming member 51 (such as a tape) having an even thickness may be provided on non-image-forming parts 54 of a charging roller 55. A reference number 52 represents a metal shaft and a reference number 53 represents an image-forming part. The gap formed between an image bearing member 56 and the charging roller 55 is preferably not greater than 100 μm, and more preferably not greater than 50 μm. When the charging roller is not in contact with the image bearing member, the discharge may be uneven, resulting in unstable charging of the image bearing member. To prevent the unstable charging of the image bearing member, a DC may be overlapped with an AC. There is a difference in discharge level between the regions where the rotating image bearing member comes into and goes out of the charging region, when only a DC is applied to the charging roller. When a DC overlapped with an AC is applied to the charging roller, the discharge is uniformly performed in the charging region. Therefore, the first rotation charge decline is much more effectively prevented.

The charging time of the above-described closely spacing roller charger is determined by dividing the width of the charging region in which a gap formed between the charging roller and the image bearing member has a distance not greater than 300 μm, by the linear velocity of the image bearing member. The charging width of the closely spacing roller charger, which is equal to the width of the charging region in which a gap formed between the charging roller and the image bearing member has a distance not greater than 300 μm, may be calculated or directly measured. Since a predetermined gap is formed between the charging roller and the image bearing member, the charging width of the closely spacing roller charger is shorter compared to the contact roller charger. However, the effect of the shorter charging width can be overcome by overlapping an AC with a DC.

It is also possible to provide a plurality of the above-described chargers. In this case, the total charging time (i.e., the sum of the charging times of each of the chargers) largely increases. Therefore, the printing speed may be increased. However, provision of a plurality of the chargers is not preferable in view of minimization of an apparatus and reduction of the diameter of an image bearing member. It is preferable to choose an appropriate method to satisfy the relationship (1) in consideration of the purpose of an image forming apparatus used.

The real transit time has a dependence on electric field strength. The higher strength an electric field has, the shorter real transit time an image bearing member has in the electric field. In other words, the thinner photosensitive layer an image bearing member has, the shorter real transit time the image bearing member has; and the higher surface potential a non-irradiated portion of an image bearing member has, the shorter real transit time the image bearing member has. The electric field strength at a time of charging the image bearing member for a predetermined charging time also influences the occurrence of the first rotation charge decline. Therefore, the real transit time of an image bearing member is preferably measured in an electric field having the same strength as a real image forming apparatus in which the image bearing member is used.

As mentioned above, in the image forming apparatus of the present invention, a real transit time T1 (msec) is not greater than a charging time T2 (msec) (i.e., the relationship (1): T1≦T2 is satisfied). When the real transit time T1 exceeds the charging time T2, holes accumulated in the photosensitive layer cannot reach the surface of the image bearing member within a predetermined charging time, and the holes remaining in the photosensitive layer deteriorate chargeability of the image bearing member. Therefore, it is important that the real transit time T1 is not greater than the charging time T2.

Only for the purpose of preventing the first rotation charge decline, conventional methods such as upsizing a charger, providing a plurality of chargers, reducing the linear velocity, and the like, have been proposed. However, these methods do not contribute to downsizing of an image forming apparatus, increase of the printing speed, and reduction of the diameter of an image bearing member. The image forming apparatus of the present invention satisfying the relationship (1) is capable of preventing the first rotation charge decline without sacrificing the printing speed and the size of the image forming apparatus. When the rotational velocity is less than 80 rpm, the effect of the first rotation charge decline is decreased but the printing speed cannot increase. In contrast, the first rotation charge decline is prevented even if the rotational velocity increases, in the present invention.

### (Image Forming Apparatus)

The image forming apparatus of the present invention includes the above-described image bearing member, a charger, an irradiator, and a developing device, and optionally includes a transfer device, a fixing device, a cleaning device, a diselectrification device, and the like, if desired.

FIG. 10 is a schematic view illustrating an embodiment of the image forming apparatus of the present invention.

The image forming apparatus illustrated in FIG. 10 includes an image bearing member 21, a diselectrification lamp 22, a charger 23, an irradiator 24, a developing device 25, a pre-transfer charger 26, a pair of registration rollers 27, a transfer charger 29, a separation charger 30, a separation pick 31, a pre-cleaning charger 32, a fur brush 33, and a blade 34.

The image bearing member 21 has a drum-like shape, but the shape of the image bearing member is not particularly limited. For example, a sheet-like and an endless-belt-like image bearing members may also be used.

An image forming method performed by the image forming apparatus of the present invention comprises a charging process, an irradiating process, and a developing process, and optionally includes a transfer process, a fixing process, a cleaning process, a diselectrification process, and the like, if desired.

As the irradiator, any known irradiators irradiating a light beam which can be absorbed by a charge generation material in the image bearing member can be used. When the charged image bearing member is irradiated with a light beam, the light beam is absorbed by a charge generation material so that a pair of charges is produced. Subsequently, one of the pair of charges moves to the surface of the image bearing member so that the surface charge is neutralized. Thus, an electrostatic latent image is formed on the image bearing member. Suitable light sources used as the irradiator includes, but are not limited to, light emission diodes (LED), laser diodes (LD), electroluminescent lamps (EL), tungsten lamps, halogen lamps, mercury lamps, fluorescent lamps, and sodium lamps. Among these light sources, light emission diodes (LED) and laser diodes (LD) are preferably used in the present invention in terms of increasing the printing speed and downsizing the image forming apparatus. In addition, in order to obtain light having a desired wave length range, filters such as sharp-cut filters, band pass filters, near-infrared cutting filters, dichroic filters, interference filters, color temperature converting filters, and the like, can be used.

In the developing process, an electrostatic latent image formed by the irradiator is developed with a toner to form a toner image on the image bearing member. When the toner has the same charge polarity as the image bearing member, a negative image is obtained (i.e., the reversal development). When the toner has a different polarity to the image bearing member, a positive image is obtained. Developing methods are broadly classified into one-component developing methods using a developer including a toner and no carrier and two-component developing methods using a developer including a toner and a carrier. Both developing methods can be used in the present invention. Since a full-color image is developed by superimposing a plurality of toner images on the image bearing member, the previously developed toner image may be disturbed in contact developing methods. To solve this problem, non-contact developing methods, such as a jumping developing method, can also be used.

In the transfer process, the toner image formed on the image bearing member is transferred onto a transfer medium (such as paper). As the transfer device, a transfer charger (such as the transfer charger 29 illustrated in FIG. 10) and a combination of the transfer charger and a separation charger (such as the separation charger 30 illustrated in FIG. 10) are preferably used. Transfer methods includes direct transfer methods in which a toner image is directly transferred from the image bearing member onto the transfer medium using the transfer device, and intermediate transfer methods in which a toner image is firstly transferred from the image bearing member onto an intermediate transfer member and secondly transferred from the intermediate transfer member onto the transfer medium. Both transfer methods can be used in the present invention. The intermediate transfer methods are suitable for producing high-quality full-color images.

Further, the transfer process is performed by a constant voltage method or a constant current method. Both methods can be used in the present invention. The constant current method is more preferable because the transferred amount of charge can be kept constant. As the transfer current becomes larger, transferability increases. Since transferability deteriorates when the linear velocity becomes larger, the larger transfer current is effective for preventing deterioration of transferability in high-speed machines. Moreover, the larger transfer current is effective for reducing the level of electrostatic fatigue, because the amount of charge flowing into the image bearing member at a time of diselectrification decreases as the transfer current becomes larger. However, if the transfer current is too large, the surface of the image bearing member is charged to positive. Such a positively charged surface of the image bearing member cannot be satisfactorily diselectrified, so that the charge amount of the image bearing member may be decreased in the next charging process. In order to prevent the first rotation charge decline, it is important to set the transfer current so as not to positively charge the image bearing member after the transfer process.

In the fixing process, the toner image transferred onto the transfer medium such as paper is fixed thereon by application of heat and/or pressure. Any fixing methods capable of fixing the toner image on the transfer medium can be used. For example, a method applying heat and/or pressure, such as a method using a combination of a heat roller and pressure roller, and optionally an endless belt, can be used. The heating temperature is preferably from 80 to 200° C.

In the cleaning process, residual toner particles remaining on the image bearing member after the toner image is transferred therefrom onto the transfer medium are removed. Any cleaning methods capable of removing the residual toner particles from the image bearing member can be used. For example, a method using a fur brush, a blade, a magnetic brush, an electrostatic brush, a magnetic roller, and the like, and combinations thereof, can be used.

In the cleaning process, foreign substances adhered to the image bearing member other than the residual toner particles such as developer components, paper powder, products of discharge, etc., which largely influence the image quality, are also removed from the image bearing member. However, if an excessive amount of the foreign substances are adhered to the image bearing member by repeated use, the adhered foreign substances are hardly removed, resulting in production of abnormal images. To solve this problem, a lubricant may be adhered/applied to the surface of the image bearing member so that the foreign substances hardly adhere thereto.

In the diselectrification process, an electrostatic latent image contrast remaining on the image bearing member, after residual toner particles are removed therefrom in the cleaning process, is removed so as not to visualize a residual image or a ghost image. Any diselectrification device capable of irradiating a light beam which can be absorbed by a charge generation material can be used. Suitable light sources used as the diselectrification device include, but are not limited to, light emission diodes (LED), laser diodes (LD), electroluminescent lamps (EL), tungsten lamps, halogen lamps, mercury lamps, fluorescent lamps, and sodium lamps. In addition, above-described optical filters used for the irradiator can also be used. Other than the light irradiating methods, a method applying a reverse bias is preferably used in terms of preventing electrostatic fatigue.

Since irradiation of light to the image bearing member accelerates electrostatic fatigue, and provision of the diselectrification device prevents downsizing of the image forming apparatus, the diselectrification process may be eliminated. However, it is preferable to provide the diselectrification device so that a residual image or a ghost image are not produced and the first rotation charge decline is prevented, in a case an electrostatic latent image contrast remains on the image bearing member or a part of the surface of the image bearing member is positively charged.

The image forming apparatus of the present invention is preferably applied to a full-color tandem image forming apparatus, which is required to have a higher printing speed and a smaller size. The tandem image forming apparatus includes a plurality of developing devices each containing a different-color toner and the same number of image bearing members provided corresponding to each of the developing devices. Each of the developing devices independently and simultaneously develops an electrostatic latent image with each of the different-color toners, and the different-color toner images are superimposed on one another to form a full-color image. In particular, the tandem image forming apparatus includes at least four developing devices and image bearing members to form yellow (Y), magenta (M), cyan (C), and black (K) images. Compared to the conventional full-color image forming apparatus employing a single drum method in which a developing process is repeated four times, the printing time is extremely shortened in the tandem image forming apparatus.

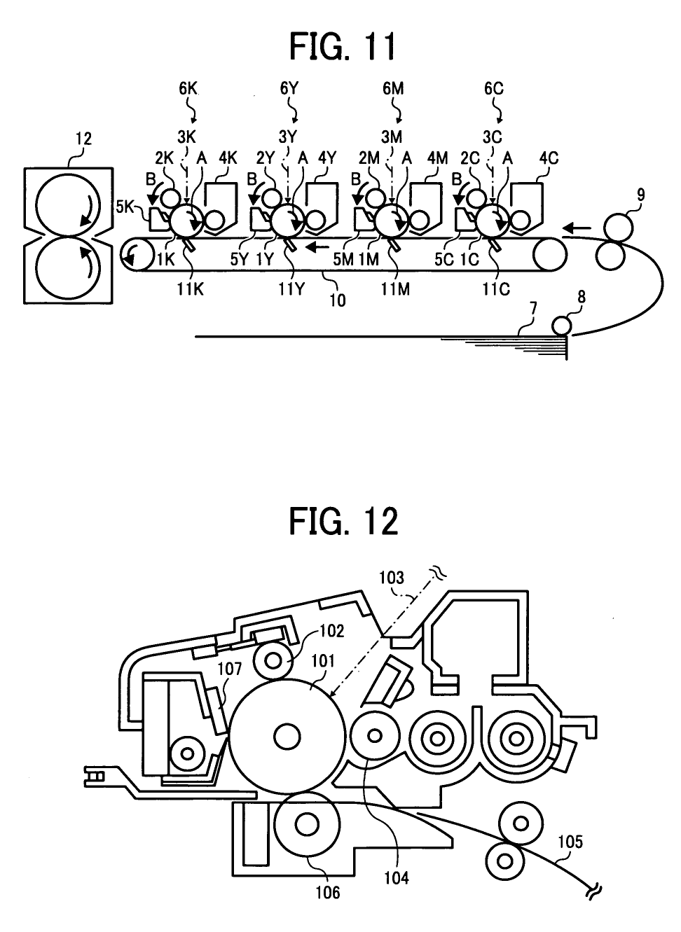

FIG. 11 is a schematic view illustrating an embodiment of the full-color tandem image forming apparatus of the present invention. As image bearing members 1C, 1M, 1Y, and 1K, the above-mentioned image bearing member is used. The image bearing members 1C, 1M, 1Y, and 1K rotate in a direction indicated by arrows A, and chargers 2C, 2M, 2Y, and 2K, developing devices 4C, 4M, 4Y, and 4K, and cleaning devices 5C, 5M, 5Y, and 5K, are provided around the image bearing members 1C, 1M, 1Y, and 1K in this order relative to rotation directions of the image bearing members 1C, 1M, 1Y, and 1K, respectively.

Laser light beams 3C, 3M, 3Y, and 3K emitted by an irradiator (not shown) to irradiate portions of the surfaces of the image bearing members 1C, 1M, 1Y, and 1K between the chargers 2C, 2M, 2Y, and 2K are provided and the developing devices 4C, 4M, 4Y, and 4K are provided, respectively, so that electrostatic latent images are formed on the image bearing members 1C, 1M, 1Y, and 1K, respectively. Image forming units 6C, 6M, 6Y, and 6K including the above-described components such as the image bearing members 1C, 1M, 1Y, and 1K, respectively, are arranged along a transfer conveyance belt 10 serving as a transfer conveyance device. The transfer conveyance belt 10 contacts the image bearing members 1C, 1M, 1Y, and 1K at portions of the surfaces thereof between the developing devices 4C, 4M, 4Y, and 4K and the cleaning devices 5C, 5M, 5Y, and 5K, respectively. Transfer brushes 11C, 11M, 11Y, and 11K, to apply a transfer bias, are provided in contact with the backside of the transfer conveyance belt 10 at portions facing the image bearing members 1C, 1M, 1Y, and 1K, respectively. Each of the image forming units 6C, 6M, 6Y, and 6K has the same configuration except for containing a different-color toner.

An image forming operation of the full-color tandem image forming apparatus illustrated in FIG. 11 will be explained. In the image forming units 6C, 6M, 6Y, and 6K, the image bearing members 1C, 1M, 1Y, and 1K are charged by the chargers 2C, 2M, 2Y, and 2K rotating in a direction indicated by arrows B, and subsequently irradiated with the laser light beams 3C, 3M, 3Y, and 3K emitted by an irradiator (not shown) provided outside the image bearing members, respectively, so that electrostatic latent images corresponding to each color information are formed thereon. The developing devices 4C, 4M, 4Y, and 4K develop the electrostatic latent images with cyan, magenta, yellow, black toners to form cyan, magenta, yellow, black toner images, respectively. The toner images formed on the image bearing members 1C, 1M, 1Y, and 1K, respectively, are superimposed on a transfer paper 7. The transfer paper 7 is fed from a tray by a paper feeding roller 8 and once stopped by a pair of registration rollers 9. Subsequently, the transfer paper 7 is fed onto the transfer conveyance belt 10 in synchronization with timing of forming electrostatic latent images on the image bearing members. The transfer paper 7 is conveyed by the transfer conveyance belt 10 so that the cyan, magenta, yellow, black toner images are transferred from the image bearing members 1C, 1M, 1Y, and 1K onto the transfer paper 7, respectively.

Each of the four-color toner images is transferred onto the transfer paper 7 by an electric field formed due to a potential difference between a transfer bias applied to the transfer brushes 11C, 11M, 11Y, and 11K and a potential of the image bearing members 1C, 1M, 1Y, and 1K, respectively. The transfer paper 7 on which the four-color toner images are superimposed is conveyed to a fixing device 12 so that the superimposed toner image is fixed thereon. The transfer paper 7 having the fixed toner image thereon is discharged to a discharging part (not shown). Residual toner particles which are not transferred and remain on the image bearing members 1C, 1M, 1Y, and 1K are collected by the cleaning devices 5C, 5M, 5Y, and 5K, respectively.

In FIG. 11, the cyan, magenta, yellow, and black image forming units are arranged in this order from an upstream side to a downstream side relative to the conveyance direction of the transfer paper. However, the arrangement order is not limited thereto. It is preferable to provide a mechanism to stop the operations of the image forming units 6C, 6M, and 6Y (except for the black image forming unit 6K) so as to produce a monochrome image. In FIG. 11, the charger is in contact with the image bearing member. Alternatively, the charger may be provided forming a gap (of about from 10 to 200 μm) with the image bearing member, as shown in FIG. 9. In the latter case, a toner film is hardly formed on the charger.

### (Process Cartridge)

The above-described image forming units may be installed in an image forming apparatus such as a copier, a facsimile, and a printer. Alternatively, the above-described image forming units may be integrally supported in a form of a process cartridge to be installed in the image forming apparatus. The process cartridge includes an image bearing member and at least one member selected from a charger, an irradiator, a developing device, a transfer device, a cleaning device, and a diselectrification device. The configuration of the process cartridge of the present invention is not particularly limited. FIG. 12 is a schematic view illustrating an embodiment of the process cartridge of the present invention. The process cartridge illustrated in FIG. 12 includes an image bearing member 101, a contact charger 102, a developing device 104, a contact transfer device 106, and a cleaning device 107. A reference number 103 represents a light beam containing image information and a reference number 105 represents a transfer medium. As the image bearing member 101, the above-described image bearing member is used.

### (Layer Structure of Image Bearing Member)

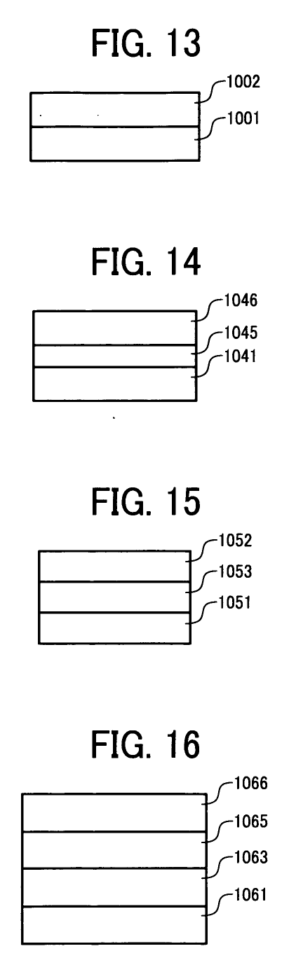

The layer structure of the image bearing member for use in the present invention will be explained. The image bearing member for use in the present invention may have a single-layer structure or a multilayer structure, and is not particularly limited. FIGS. 13 to 18 are cross-sectional schematic views illustrating embodiments of the image bearing members for use in the present invention.

Within the context of the present invention, if a first layer is stated to be “overlaid” on, or “overlying” a second layer, the first layer may be in direct contact with a portion or all of the second layer, or there may be one or more intervening layers between the first and second layer, with the second layer being closer to the substrate than the first layer.

An image bearing member illustrated in FIG. 13 includes a conductive substrate 1001 and a photosensitive layer 1002 overlaid on the conductive substrate 1001. As illustrated in FIG. 15, an undercoat layer 1053 may be provided between a conductive substrate 1051 and a photosensitive layer 1052. As illustrated in FIG. 17, both an undercoat layer 1073 and a resin layer 1074 may be provided between a conductive substrate 1071 and a photosensitive layer 1072. Only a resin layer may be provided between a conductive substrate and a photosensitive layer, not shown.

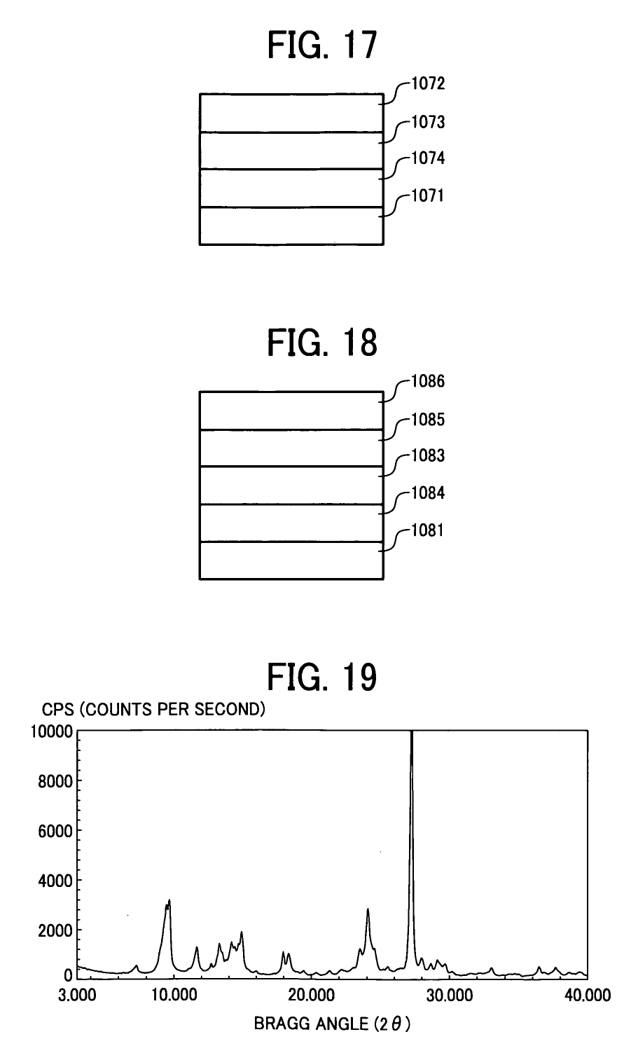

An image bearing member illustrated in FIG. 14 includes a conductive substrate 1041, and a charge generation layer 1045 and a charge transport layer 1046 overlaid on the conductive substrate 1041 in this order. As illustrated in FIG. 16, an undercoat layer 1063 may be provided between a conductive substrate 1061 and a charge generation layer 1065. (A reference number 1066 represents a charge transport layer.) As illustrated in FIG. 18, both an undercoat layer 1083 and a resin layer 1084 may be provided between a conductive substrate 1081 and a charge generation layer 1085. (A reference number 1086 represents a charge transport layer.) Only a resin layer may be provided between a conductive substrate and a charge generation layer, not shown.

The image bearing member for use in the present invention preferably includes the undercoat layer for the purpose of preventing the first rotation charge decline. Particularly, the image bearing member for use in the present invention more preferably includes both the resin layer and the undercoat layer for the purpose of improving the resultant image quality. The image bearing member for use in the present invention preferably has the multilayer structure in terms of durability. The structure of the image bearing member for use in the present invention is not limited to the above-described structures.

### (Conductive Substrate)

Suitable materials for use as the conductive substrate includes material having a volume resistivity not greater than 10¹⁰ΩQ·cm. Specific examples of such materials include, but are not limited to, plastic films, plastic cylinders, or paper sheets, on the surface of which a metal such as aluminum, nickel, chromium, nichrome, copper, gold, silver, platinum, and the like, or a metal oxide such as tin oxides, indium oxides, and the like, is formed by deposition or sputtering. In addition, a metal cylinder can also be used as the conductive substrate, which is prepared by tubing a metal such as aluminum, aluminum alloys, nickel, and stainless steel by a method such as impact ironing or direct ironing, and then treating the surface of the tube by cutting, super finishing, polishing, and the like treatments. Further, an endless nickel belt disclosed in published examined Japanese patent application No. (hereinafter referred to as JP-B) 52-36016 and an endless stainless belt can also be used as the conductive substrate.

Furthermore, substrates, in which a conductive layer is formed on the above-described conductive substrates by applying a coating liquid including a binder resin and a conductive powder thereto, can be used as the conductive substrate. Specific examples of such conductive powders include, but are not limited to, carbon black, acetylene black, powders of metals such as aluminum, nickel, iron, nichrome, copper, zinc, and silver, and metal oxides such as conductive tin oxides and ITO. Specific examples of the binder resins include known thermoplastic, thermosetting, and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylate, phenoxy resins, polycarbonate, cellulose acetate resins, ethylcellulose resins, polyvinyl butyral, polyvinyl formal, polyvinyl toluene, poly(N-vinylcarbazole), acrylic resins, silicone resins, epoxy resins, melamine resins, urethane resins, phenol resins, and alkyd resins. Such a conductive layer can be formed by coating a coating liquid in which a conductive powder and a binder resin are dispersed or dissolved in a proper solvent such as tetrahydrofuran, dichloromethane, methyl ethyl ketone, toluene, and the like solvent, and then drying the coated liquid.

In addition, substrates, in which a conductive layer is formed on a surface of a cylindrical substrate using a heat-shrinkable tube which is made of a combination of a resin such as polyvinyl chloride, polypropylene, polyester, polystyrene, polyvinylidene chloride, polyethylene, chlorinated rubber, and polytetrafluoroethylene fluorine-containing resin, with a conductive powder, can also be used as the conductive substrate.

Moreover, a cylindrical substrate made of aluminum, which can be easily subjected to an anodic oxidation treatment, is preferably used as the conductive substrate. The aluminum includes both pure aluminum and aluminum alloys. In particular, aluminums and aluminum alloys in the JIS (i.e., the Japanese Industrial Standards) 1000's, 3000's, and 6000's are preferably used. In the anodic oxidation treatment, a metal or an alloy is anodized in an electrolyte solution so that an anodic oxidation film is formed thereon. In particular, when aluminum or an aluminum alloy is anodized in an electrolyte solution, an anodic oxidation film called alumite is formed thereon. The alumite contributes to prevention of residual potential increase and background fouling occurred in the reversal development.

The anodic oxidation treatment is typically performed in a bath of an acid such as chromic acid, sulfuric acid, oxalic acid, phosphoric acid, boric acid, and sulfamic acid. Among these acids, sulfuric acid is most preferably used for the bath for the anodic oxidation treatment. For example, the anodic oxidation treatment is performed under conditions such that a sulfuric acid concentration is from 10 to 20%, a bath temperature is from 5 to 25° C., a current density is from 1 to 4 A/dm³, an electrolysis voltage is from 5 to 30 V, and a treatment time is from 5 to 60 minutes. However, the treatment conditions are not limited thereto. Since the anodic oxidation film is typically porous and highly insulative, the surface thereof is very unstable. Therefore, physical properties of the anodic oxidation film tend to vary with time. To prevent the time variation, the anodic oxidation film is preferably subjected to a sealing treatment. Suitable methods for the sealing treatment includes a method in which an anodic oxidation film is dipped into an aqueous solution including nickel fluoride or nickel acetate; a method in which an anodic oxidation film is dipped into boiling water; and a method in which an anodic oxidation film is exposed to steam under pressure. Among these methods, the method in which an anodic oxidation film is dipped into an aqueous solution including nickel fluoride is most preferably used. The sealing-treated anodic oxidation film is subsequently subjected to a washing treatment so as to remove undesired substances such as metal salts adhered to the anodic oxidation film during the sealing treatment. If an excessive amount of the undesired substances remain on the surface of the anodic oxidation film, quality of a film formed thereon may be adversely affected, and the resultant image bearing member may cause background fouling because low-resistivity substances may remain thereon. The washing treatment may include both a single washing process using pure water or multiple washing processes. In the multiple washing processes, the last washing water is preferably as pure as possible, i.e., the last washing water is preferably deionized. The multiple washing processes preferably include a physical scrub washing process in which a contact member scrubs the film. The thus prepared anodic oxidation film preferably has a thickness of from 5 to 15 μm. When the anodic oxidation film is too thin, the anodic oxidation film cannot sufficiently exert barrier effect. When the anodic oxidation film is too thick, the time constant thereof serving as an electrode is too large, resulting in increase of residual potential and deterioration of responsiveness of the resultant image bearing member.

### (Photosensitive Layer)

The photosensitive layer will be explained. The photosensitive layer may be a single-layer photosensitive layer or a multilayer photosensitive layer including a charge generation layer and a charge transport layer that are overlaid on each other.

### (Charge Generation Layer)

The charge generation layer includes a charge generation material as a main component. Specific examples of the charge generation material include, but are not limited to, monoazo pigments, bisazo pigments, asymmetric bisazo pigments, trisazo pigments, azo pigments having a carbazole skeleton (disclosed in JP-A 53-95033), azo pigments having a distyrylbenzene skeleton (disclosed in JP-A 53-133445), azo pigments having a triphenylamine skeleton (disclosed in JP-A 53-132347), azo pigments having a diphenylamine skeleton, azo pigments having a dibenzothiophene skeleton (disclosed in JP-A 54-21728), azo pigments having a fluorenone skeleton (disclosed in JP-A 54-22834), azo pigments having an oxadiazole skeleton (disclosed in JP-A 54-12742), azo pigments having a bisstilbene skeleton (disclosed in JP-A 54-17733), azo pigments having a distyryl oxadiazole skeleton (disclosed in JP-A 54-2129), azo pigments having a distyryl carbazole skeleton (disclosed in JP-A 54-14967), azulenium salt pigments, squaric acid methine pigments, perylene pigments, anthraquinone or polycyclic quinone pigments, quinonimine pigments, diphenylmethane or triphenylmethane pigments, benzoquinone or naphthoquinone pigments, cyanine or azomethine pigments, indigoid pigments, bisbenzimidazole pigments, and phthalocyanine pigments (such as metal phthalocyanine and metal-free phthalocyanine) having the following formula (16):

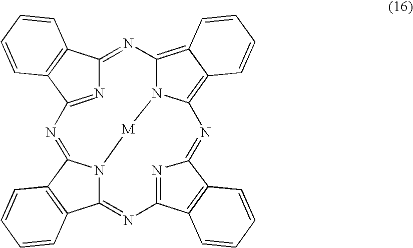

wherein M (central metal) represents a metal atom (e.g., Li, Be, Na, Mg, Al, Si, K, Ca, Sc, Ti, V, Cr, Mn, Fe, Co, Ni, Cu, Zn, Ga, Ge, Y, Zr, Nb, Mo, Tc, Ru, Rh, Pd, Ag, Cd, In, Sn, Sb, Ba, Hf, Ta, W, Re, Os, Ir, Pt, Au, Hg, Tl, La, Ce, Pr, Nd, Pm, Sm, Eu, Gd, Th, Dy, Ho, Er, Tm, Yb, Lu, Th, Pa, U, Np, Am) or an oxide, a chloride, a fluoride, a hydroxide, or a bromide thereof; or a hydrogen atom.

The central metal represented by M is not limited to the above-described atoms.

In addition to phthalocyanine pigments having at least one unit of the basic phthalocyanine skeleton having the formula (16), phthalocyanine pigments having a multimeric structure such as dimer and trimer or a highly polymeric structure can also be used as the charge generation material in the present invention. The basic phthalocyanine skeleton may have a substituent group. Among various phthalocyanine pigments, titanyl phthalocyanine including TiO as the central metal, metal-free phthalocyanine, chlorogallium phthalocyanine, and hydroxygallium phthalocyanine are preferably used from the viewpoint of photoconductive properties. It is known that phthalocyanine has various crystal systems. For example, titanyl phthalocyanine has α, β, γ, m, and Y crystal systems, and copper phthalocyanine has α, β, and γ crystal systems. It is known that different crystal systems have different properties even if the central metals are same. It is also known that photoreceptors using phthalocyanine pigments having different crystal systems have different properties. Properties of a photoreceptor largely depend on the crystal system of a phthalocyanine used.

Among various phthalocyanine pigments, a titanyl phthalocyanine crystal having an X-ray diffraction spectrum in which a maximum diffraction peak is observed at a Bragg angle (2θ+0.2°) of 27.2°, obtained using a characteristic X-ray specific to CuKα having a wavelength of 1.542 Å, is preferably used in the present invention, because such a titanyl phthalocyanine crystal has high sensitivity. In particular, a titanyl phthalocyanine crystal having an X-ray diffraction spectrum in which a maximum diffraction peak is observed at 27.2°, main diffraction peaks are observed at 9.4°, 9.6°, and 24.0°, a diffraction peak with the smallest angle is observed at 7.3°, and no diffraction peak is observed either in a range of greater than 7.3° and less than 9.4° or at 26.3°, among each of Bragg angles (2θ+0.2°), obtained using a characteristic X-ray specific to CuKα having a wavelength of 1.542 Å, is more preferably used in the present invention, because such a titanyl phthalocyanine crystal has large charge generation efficiency and good electrostatic properties.

The above-described charge generation materials can be used alone or in combination.

The smaller size a charge generation material has, the better charge generation efficiency the charge generation material has. In particular, phthalocyanine pigments preferably have a volume average particle diameter of not greater than 0.25 μm, and more preferably not greater than 0.2 μm. In order to control the volume average particle diameter of a charge generation material, a method including preparing a dispersion of a charge generation material and removing coarse particles of the charge generation material having a particle diameter of greater than 0.25 μm from the dispersion is proposed. The volume average particle diameter can be measured using a centrifugal automatic particle analyzer CAPA-700 (manufactured by Horiba, Ltd.) as the median diameter that represents a diameter when the cumulative distribution of particles is 50%. However, a slight amount of coarse particles may not be detected by the above analyzer. Therefore, the size of the charge generation material is more preferably measured by directly observing a powder or a dispersion of the charge generation material with an electron microscope.

The above-described method in which coarse particles of a charge generation material are removed from a dispersion thereof will be explained in detail. At first, a charge generation material is dispersed in a dispersion medium so that particles of the charge generation material are as fine as possible. Subsequently, the dispersion is filtered with a proper filter. The dispersion is prepared by a typical method such that the charge generation material, optionally together with a binder resin, is dispersed in a solvent using a ball mill, an attritor, a sand mill, a bead mill, an ultrasonic disperser, or the like. The binder resin may be selected from the viewpoint of desired electrostatic properties of the resultant photoreceptor, and the solvent may be selected from the viewpoint of wettability and dispersibility of the pigment (i.e., charge generation material).

In particular, the dispersion is filtered with a filter having an effective opening diameter of not greater than 5 μm, and preferably not greater than 3 μm, so that the dispersion includes only small particles of the charge generation material having a particle diameter of not greater than 0.25 μm, and preferably not greater than 0.2 μm. Thereby, the resultant photoreceptor has good and stable electrostatic properties.

If the dispersion includes particles having too large a particle diameter or the dispersed particles have too large a particle diameter distribution, filtration efficiency deteriorates and/or the filter is clogged. For this reason, the dispersion is preferably well dispersed before being filtered such that the dispersed particles have an average particle diameter of not greater than 0.3 μm with a standard deviation of not greater than 0.2 μm. When the average particle diameter is greater than 0.3 μm, filtration efficiency largely deteriorates. When the standard deviation is greater than 0.2 μm, the filtration time is lengthened.

The above-described charge generation materials have very strong intermolecular hydrogen bonding force, which is a characteristic of highly sensitive charge generation materials. Therefore, the interaction among the dispersed particles of the charge generation material is also very strong. As a result, the dispersed particles of the charge generation material are likely to be reaggregated when the dispersion is diluted. However, the aggregates can be removed by a filtration with a filter having a specific opening diameter. Since the dispersion is in a thixotropic state, particles having a particle diameter smaller than the effective opening diameter of the filter are also removed. When the dispersion has structural viscosity, the dispersion may be in Newtonian state after the filtration. By removing coarse particles of the charge generation material, the resultant photoreceptor has better properties.

Among the azo pigments, an asymmetric azo pigment having the following formula (13) is preferably used:

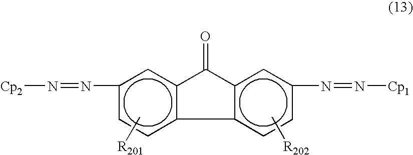

wherein each of R₂₀₁ and R₂₀₂ independently represents a hydrogen atom, a halogen atom, an alkyl group, an alkoxy group, or a cyano group; and each of Cp₁ and Cp₂, being different from each other, independently represents a residue group of a coupler, having the following formula (14):

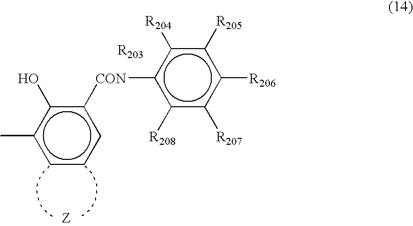

wherein R₂₀₃ represents a hydrogen atom, an alkyl group such as methyl group and ethyl group, or an aryl group such as phenyl group; each of R₂₀₄ to R₂₀₈ independently represents a hydrogen atom, a nitro group, a cyano group, a halogen atom such as fluorine, chlorine, bromine, and iodine, a trifluoromethyl group, an alkyl group such as methyl group and ethyl group, an alkoxy group such as methoxy group and ethoxy group, a dialkylamino group, or a hydroxyl group; and Z represents an atomic group needed for constituting a substituted or unsubstituted aromatic carbocyclic ring or a substituted or unsubstituted aromatic heterocyclic ring.

In particular, the asymmetric azo pigment in which Cp₁ and Cp₂ are different from each other is preferably used in the present invention because of having large charge generation efficiency, which contributes to high-speed printing.

These charge generation materials can be used alone or in combination.

Specific examples of the binder resin optionally used for the charge generation layer include, but are not limited to, polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, polyacrylamide, polyvinyl benzal, polyester, phenoxy resins, vinyl chloride-vinyl acetate copolymers, polyvinyl acetate, polyphenylene oxide, polyvinyl pyridine, cellulose resins, casein, polyvinyl alcohol, and polyvinyl pyrrolidone. Among these binder resins, polyvinyl butyral is preferably used. These binder resins can be used alone or in combination.

Specific examples of the solvents for use in the dispersion of the charge generation material include, but are not limited to, organic solvents such as isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, and ligroin. Among these solvents, ketone solvents, ester solvents, and ether solvents are preferably used. These solvents can be used alone or in combination.

The charge generation layer can be prepared as follows, for example. At first, a charge generation material is dispersed in a solvent optionally together with a binder resin using a typical dispersion means such as a ball mill, an attritor, a sand mill, or an ultrasonic disperser, to prepare a charge generation layer coating liquid. The binder resin may be added to the coating liquid either before or after the charge generation material is dispersed therein. The charge generation layer coating liquid includes the charge generation material, the solvent, and the binder resin as main components, and optionally includes additives such as an intensifier, a dispersing agent, a surfactant, and a silicone oil. The charge generation layer optionally includes a charge transport material to be described later. The content of the binder resin in the charge generation layer is preferably from 0 to 500 parts by weight, and more preferably from 10 to 300 parts by weight, per 100 parts by weight of the charge generation material included in the charge generation layer.

The charge generation layer is formed by coating the charge generation layer coating liquid on a conductive substrate or an undercoat layer, followed by drying. Suitable coating methods include, but are not limited to, a dip coating method, a spray coating method, a bead coating method, a nozzle coating method, a spinner coating method, and a ring coating method. The charge generation layer preferably has a thickness of from 0.01 to 5 μm, and more preferably from 0.1 to 2 μm. The drying of the charge generation layer is performed by application of heat using an oven, and the like. The drying temperature is preferably from 50 to 160° C., and more preferably from 80 to 140° C.

### (Charge Transport Layer)

The charge transport layer includes a charge transport material and a binder resin as main components. Charge transport materials are classified into positive-hole transport materials and electron transport materials. The charge transport material has a function of transporting a charge to the surface of an image bearing member. Therefore, the charge transport material has an important role in the present invention to shorten the real transit time so that the printing speed of an image forming apparatus increases.

Specific examples of the electron transport materials include, but are not limited to, electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trimtrothioxanthone, 2,6,8-trimtro-4H-indeno[1,2-b]thiophene-4-one, 1,3,7-trinitrodibenzothiophene-5,5-dioxide and benzoquinone derivatives.

Specific examples of the positive-hole transport materials include, but are not limited to, poly(N-vinylcarbazole) and derivatives thereof, poly(γ-carbazolylethylglutamate) and derivatives thereof, pyrene-formaldehyde condensation products and derivatives thereof, polyvinyl pyrene, polyvinyl phenanthrene, polysilane, oxazole derivatives, oxadiazole derivatives, imidazole derivatives, monoarylamine derivatives, diarylamine derivatives, triarylamine derivatives, stilbene derivatives, α-phenylstilbene derivatives, aminobiphenyl derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, distyrylbenzene derivatives, and enamine derivatives.

These charge transport materials can be used alone or in combination.

Among these charge transport materials, compounds having a distyryl structure are preferably used. Particularly, a compound having the following formula (3) is more preferably used:

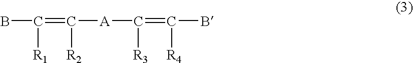

wherein each of R₁ to R₄ independently represents a hydrogen atom, an alkyl group having 1 to 4 carbon atoms, an alkoxy group having 1 to 4 carbon atoms, or a phenyl group which may have a substituent group such as an alkyl group having 1 to 4 carbon atoms and an alkoxy group having 1 to 4 carbon atoms; A represents a substituted or unsubstituted arylene group or a functional group having the following formula (3a):

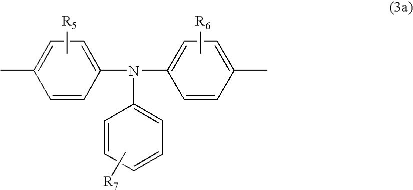

wherein each of R₅ to R₇ independently represents a hydrogen atom, an alkyl group having 1 to 4 carbon atoms, an alkoxy group having 1 to 4 carbon atoms, or a phenyl group which may have a substituent group such as an alkyl group having 1 to 4 carbon atoms and an alkoxy group having 1 to 4 carbon atoms; and each of B and B′ independently represents a substituted or unsubstituted aryl group or a functional group having the following formula (3b):

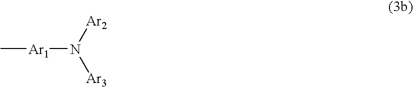

wherein Ar₁ represents an arylene group which may have a substituent group such as an alkyl group having 1 to 4 carbon atoms and an alkoxy group having 1 to 4 carbon atoms; and each of Ar₂ and Ar₃ independently represents an aryl group which may have a substituent group such as an alkyl group having 1 to 4 carbon atoms and an alkoxy group having 1 to 4 carbon atoms.

Among the compounds having the formula (3), a compound having the following formulae (4) or (5) is much more preferably used:

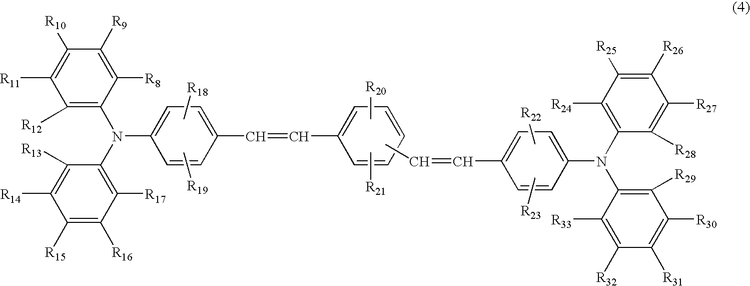

wherein each of R₈ to R₃₃ independently represents a hydrogen atom, an alkyl group having 1 to 4 carbon atoms, an alkoxy group having 1 to 4 carbon atoms, or a substituted or unsubstituted phenyl group;

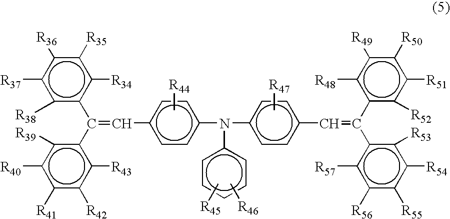

wherein each of R₃₄ to R₅₇ independently represents a hydrogen atom, an alkyl group having 1 to 4 carbon atoms, an alkoxy group having 1 to 4 carbon atoms, or a substituted or unsubstituted phenyl group.

The above-described compounds have high charge transportability. In addition, it takes a short time to transport all charges when the above-described compound is used. In other words, each of the charges has small variation in moving speed when the above-described compound is used. Namely, the compounds having the formula (3), particularly the formulae (4) and (5), contribute to shorten a time in which almost all of holes present in an image bearing member, which causes the first rotation charge decline, reach the surface of the image bearing member. This is because the molecule of the compounds having the formulae (3) to (5) has a large size and a linear structure, and π-conjugated systems are spread over the molecule. Thereby, intramolecular charge transfer is more likely to occur than intermolecular charge transfer in the charge transport layer, resulting in very high charge transportability with less dependence on electric field strength.

Specific examples of the charge transport material for use in the present invention include, but are not limited to, the following compounds No. 1 to No. 58.

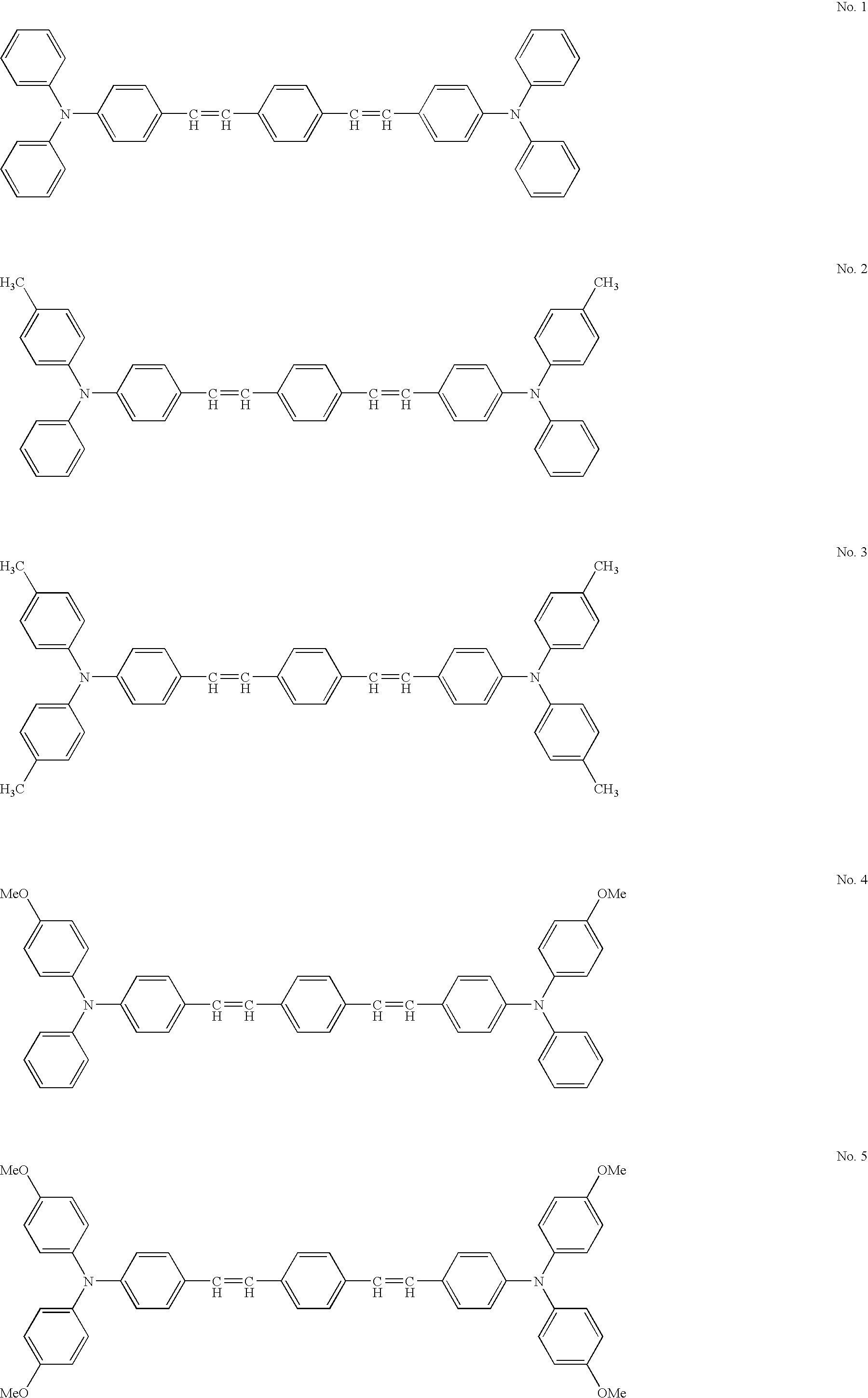

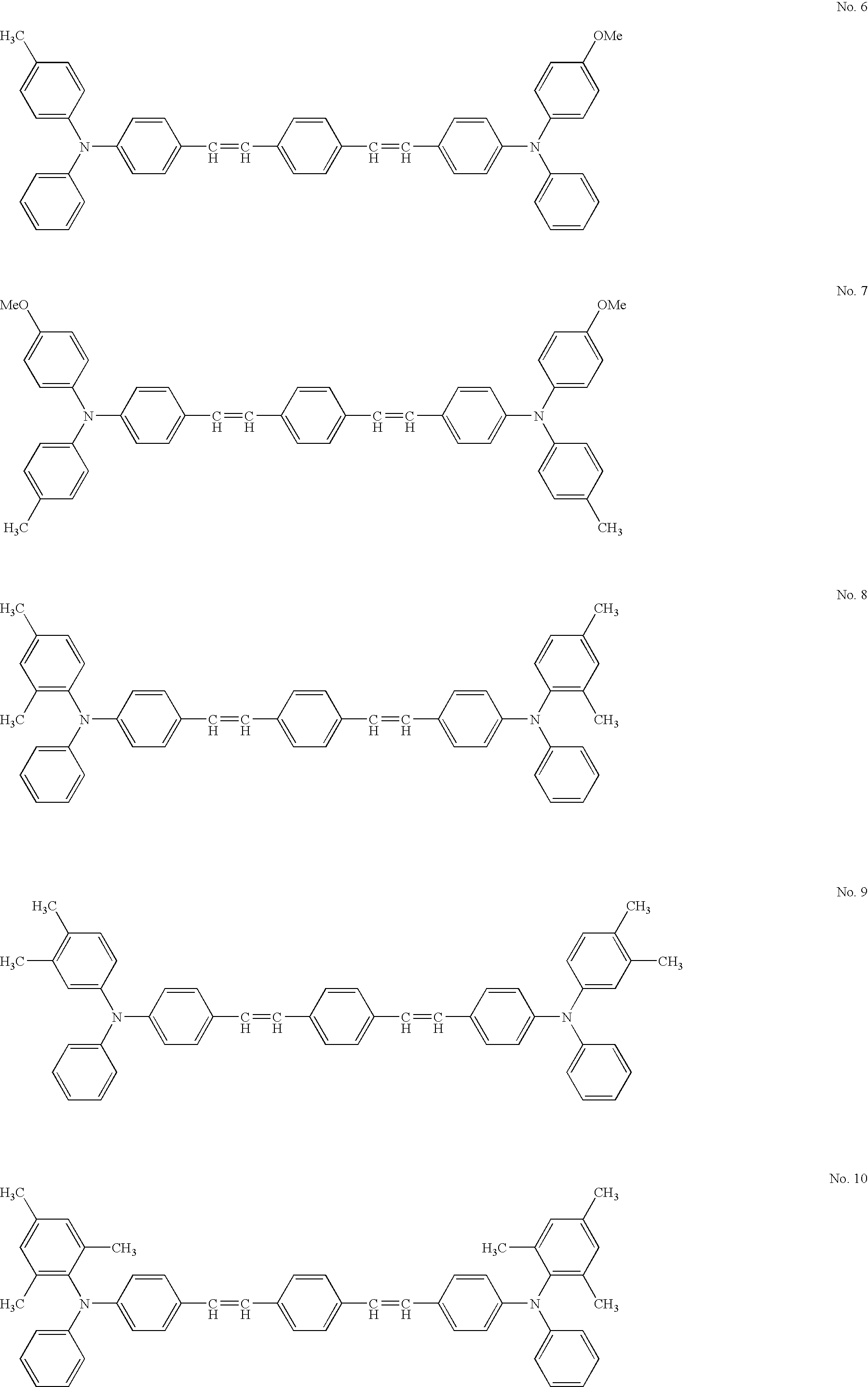

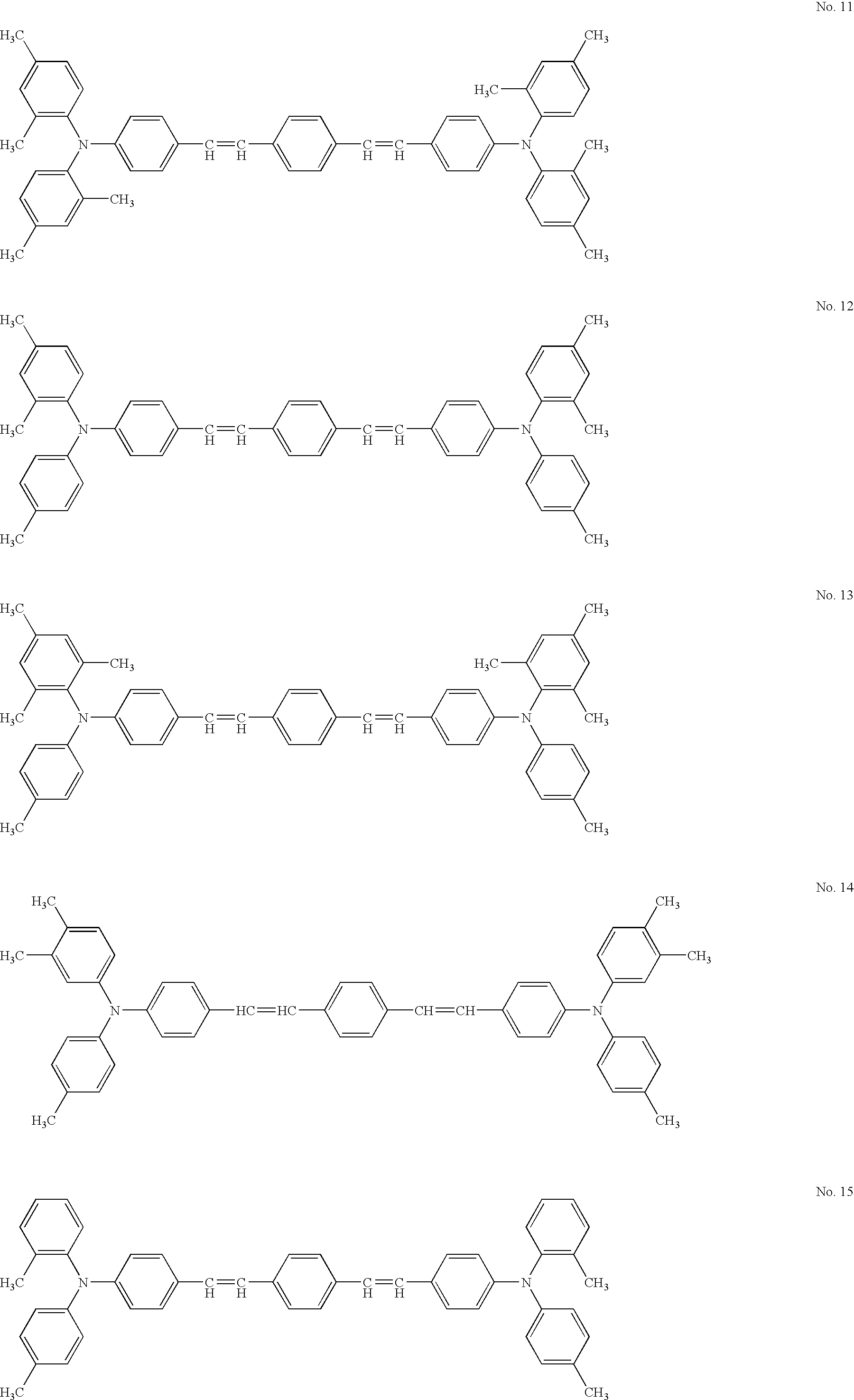

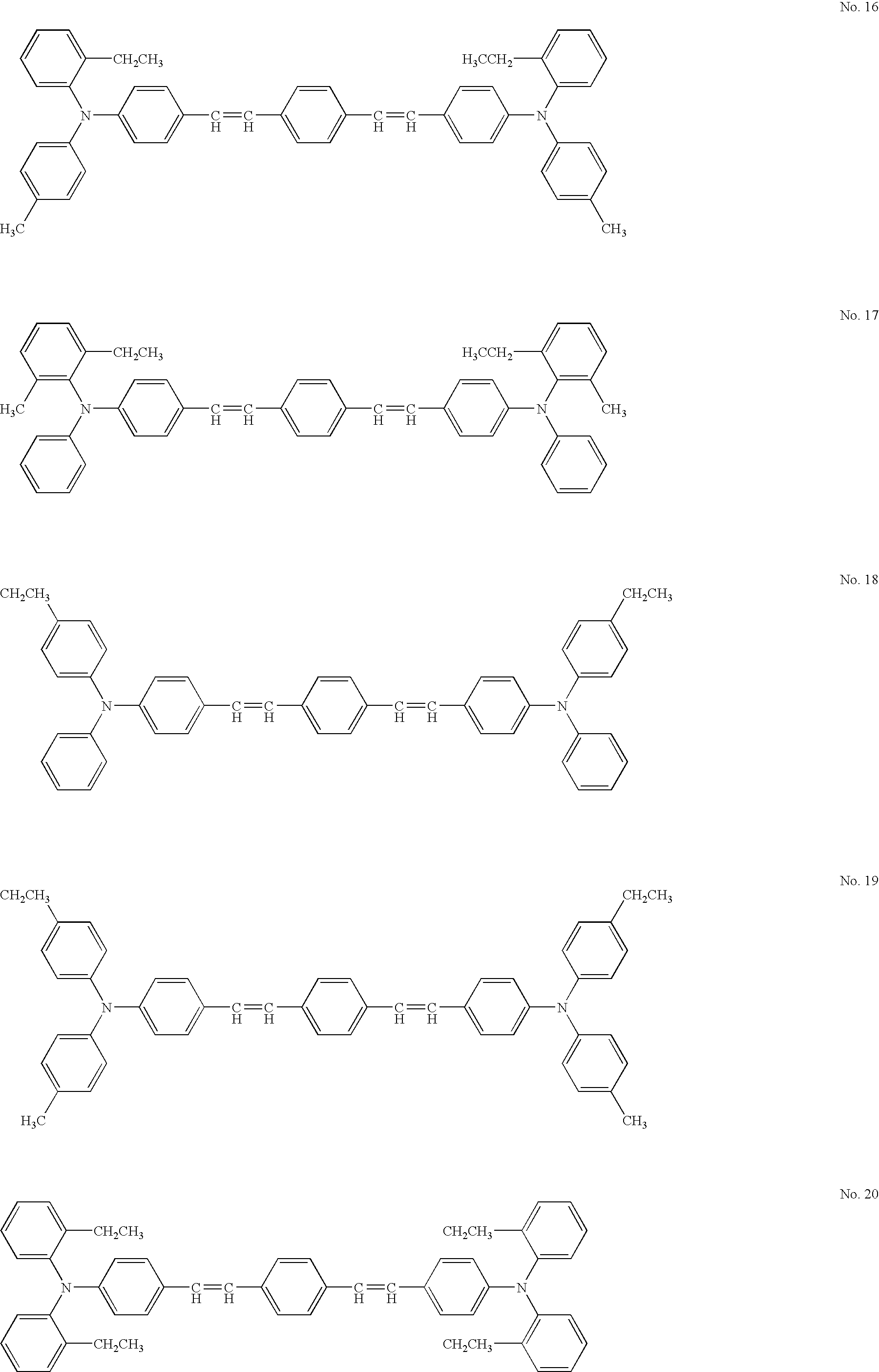

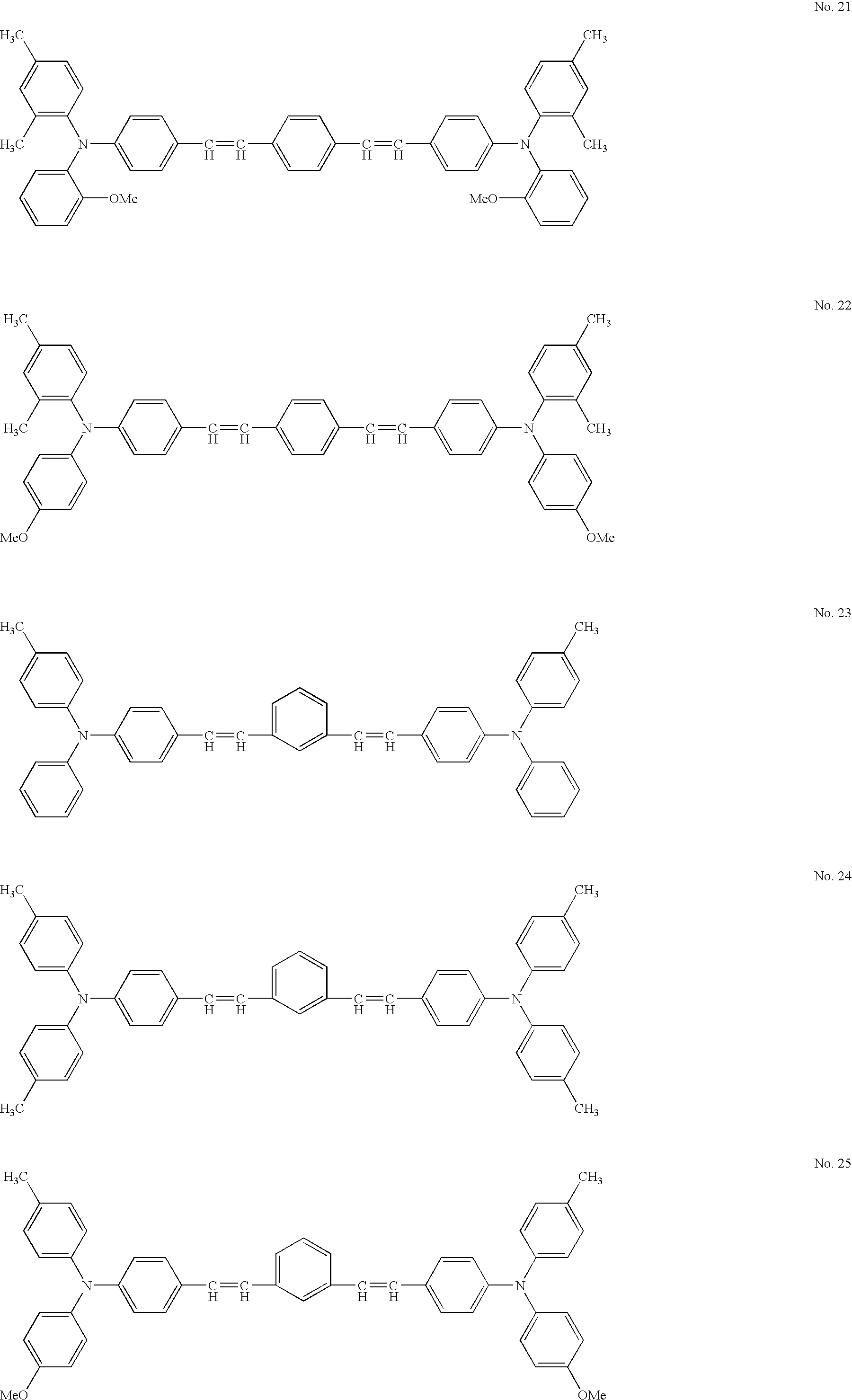

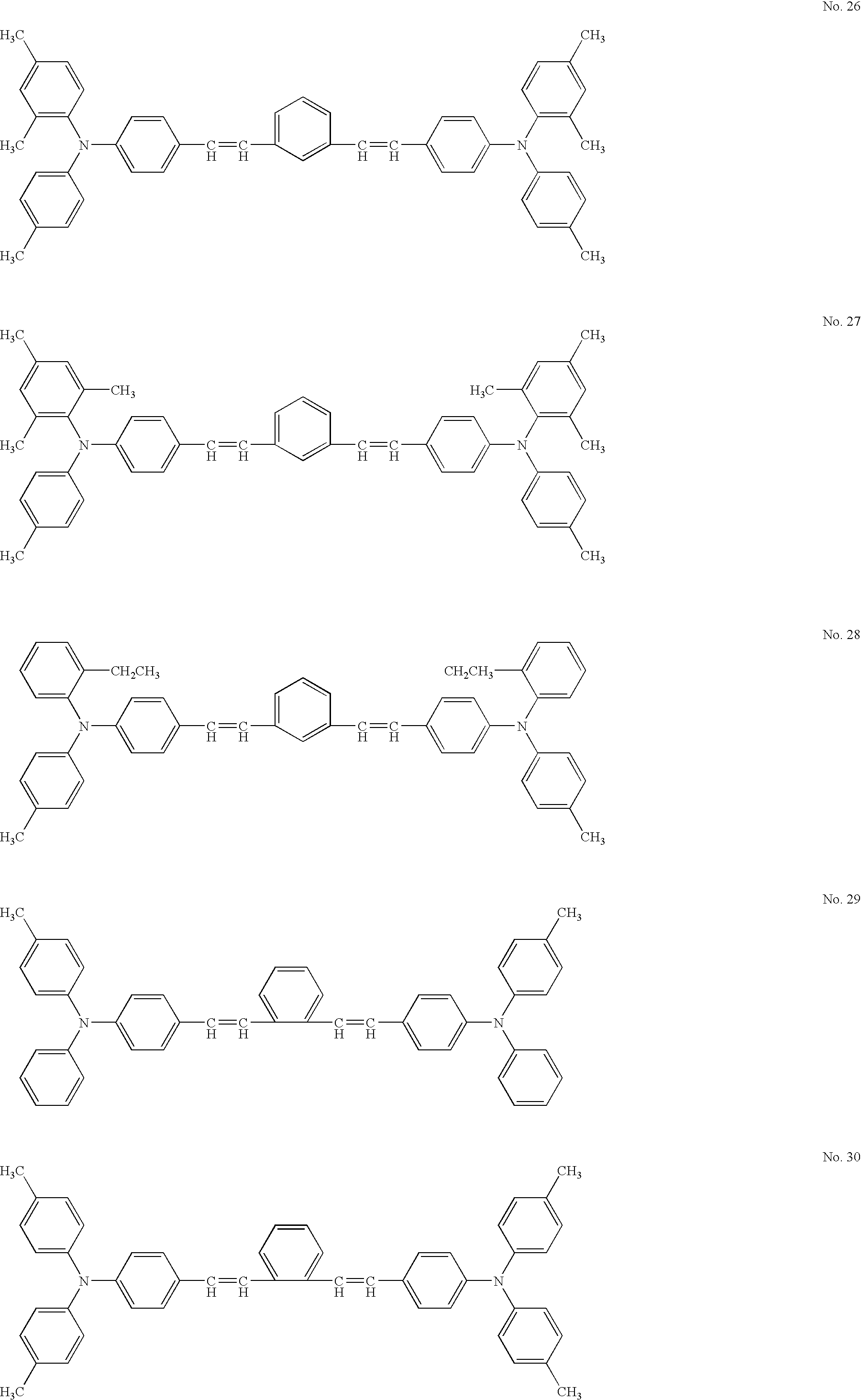

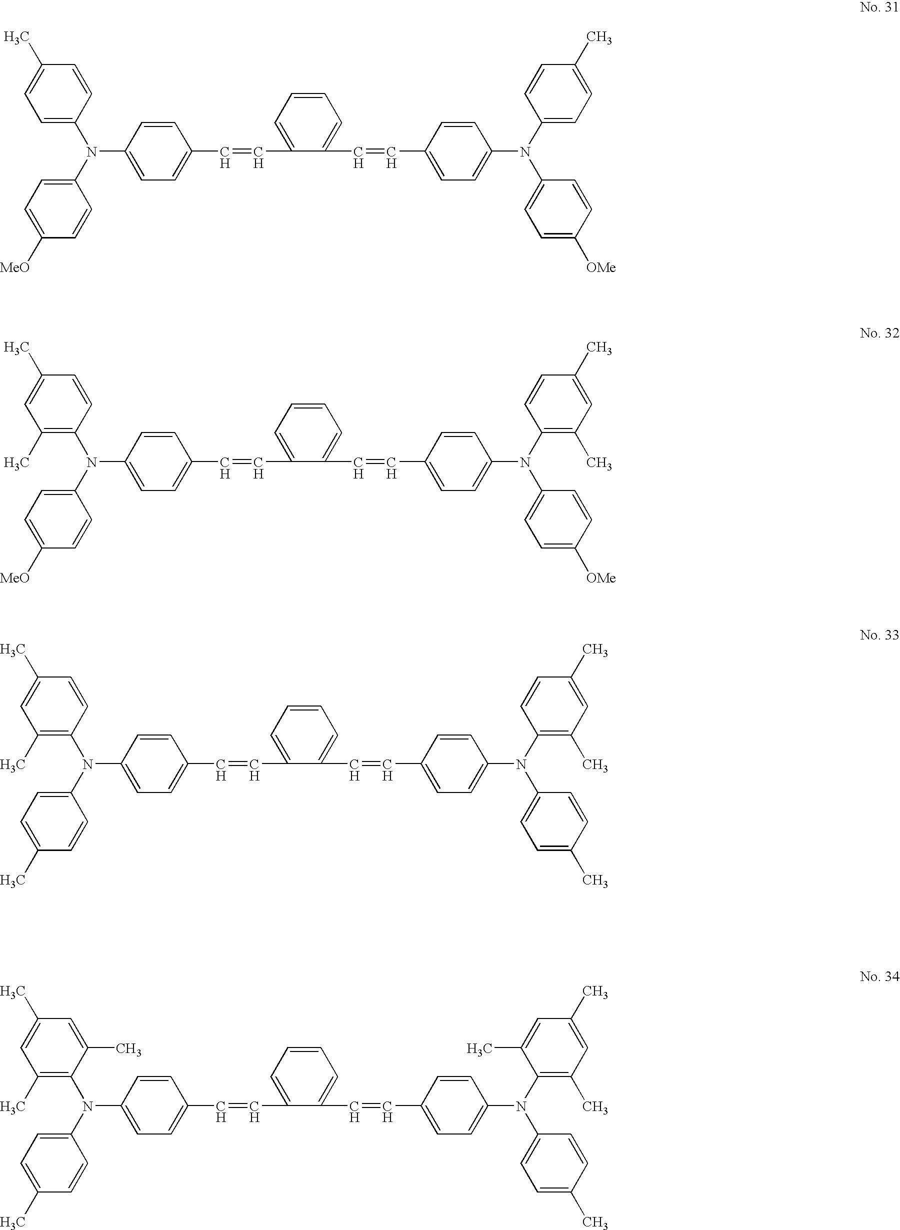

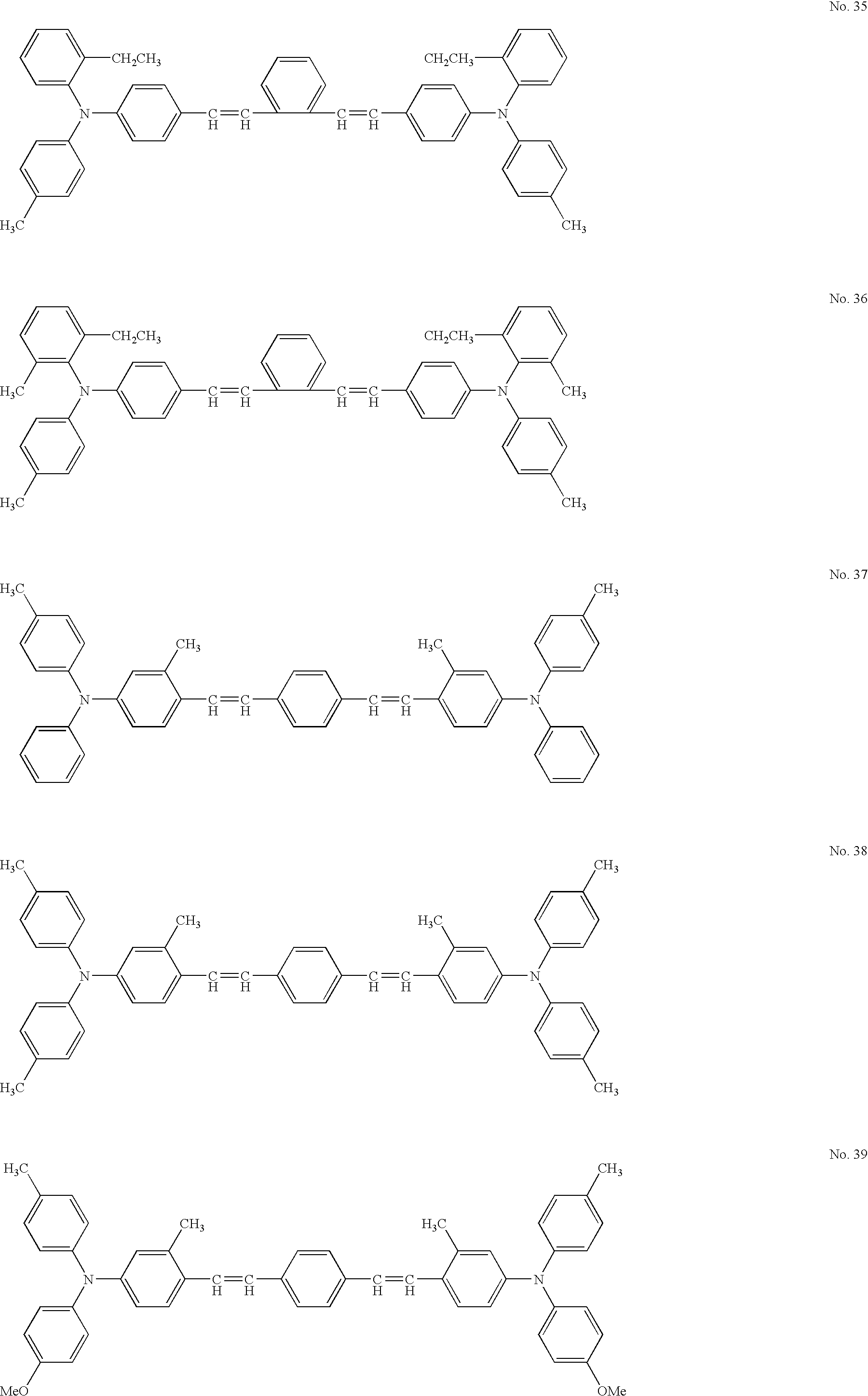

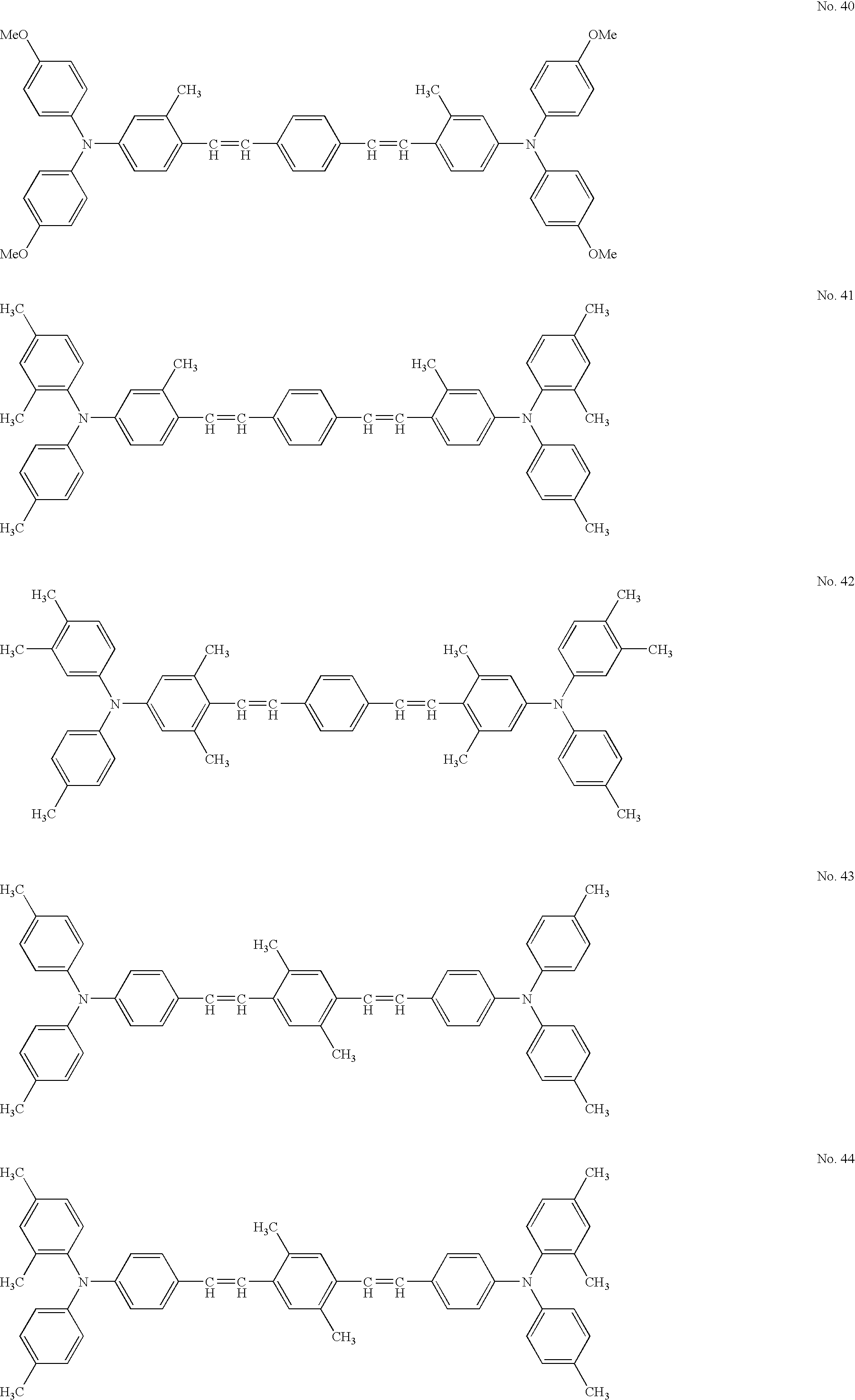

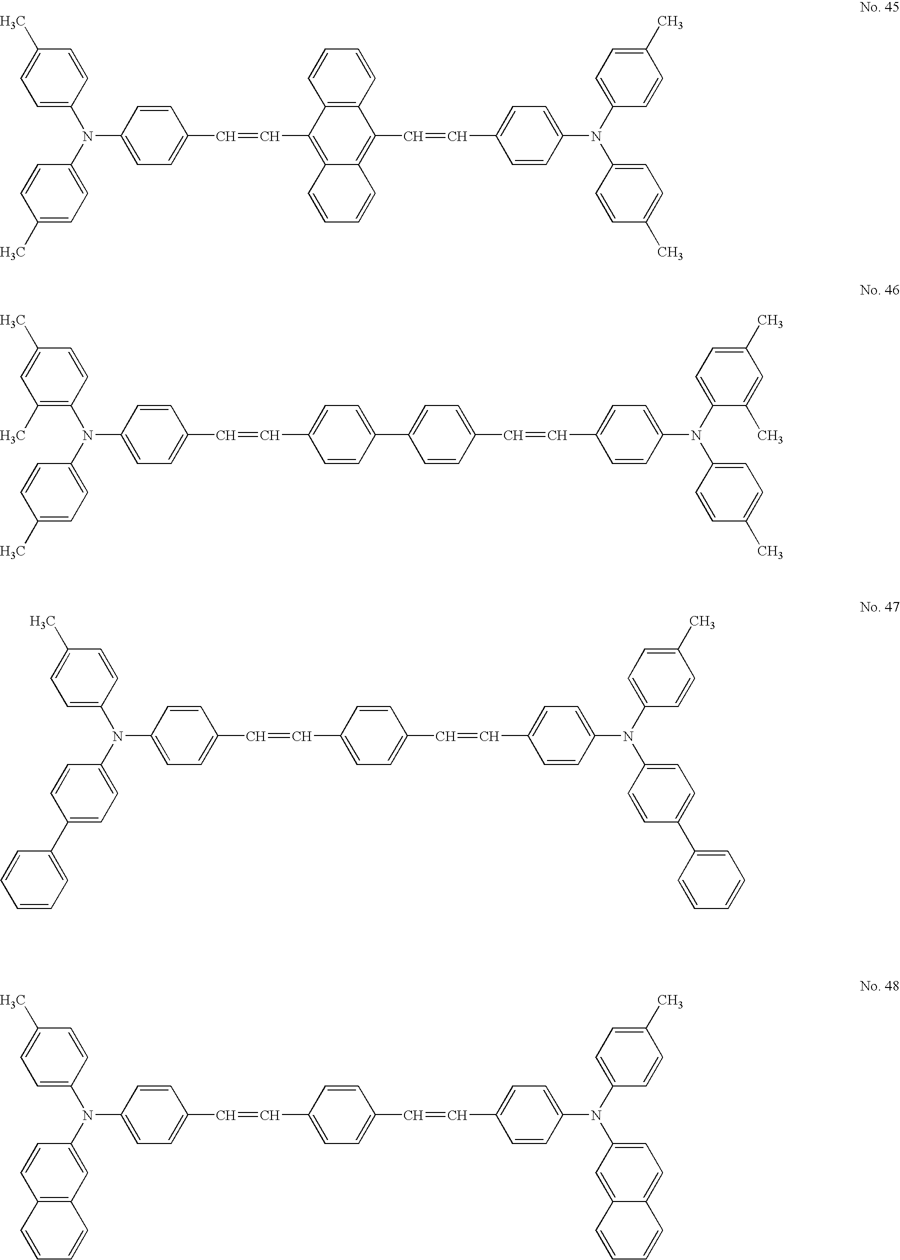

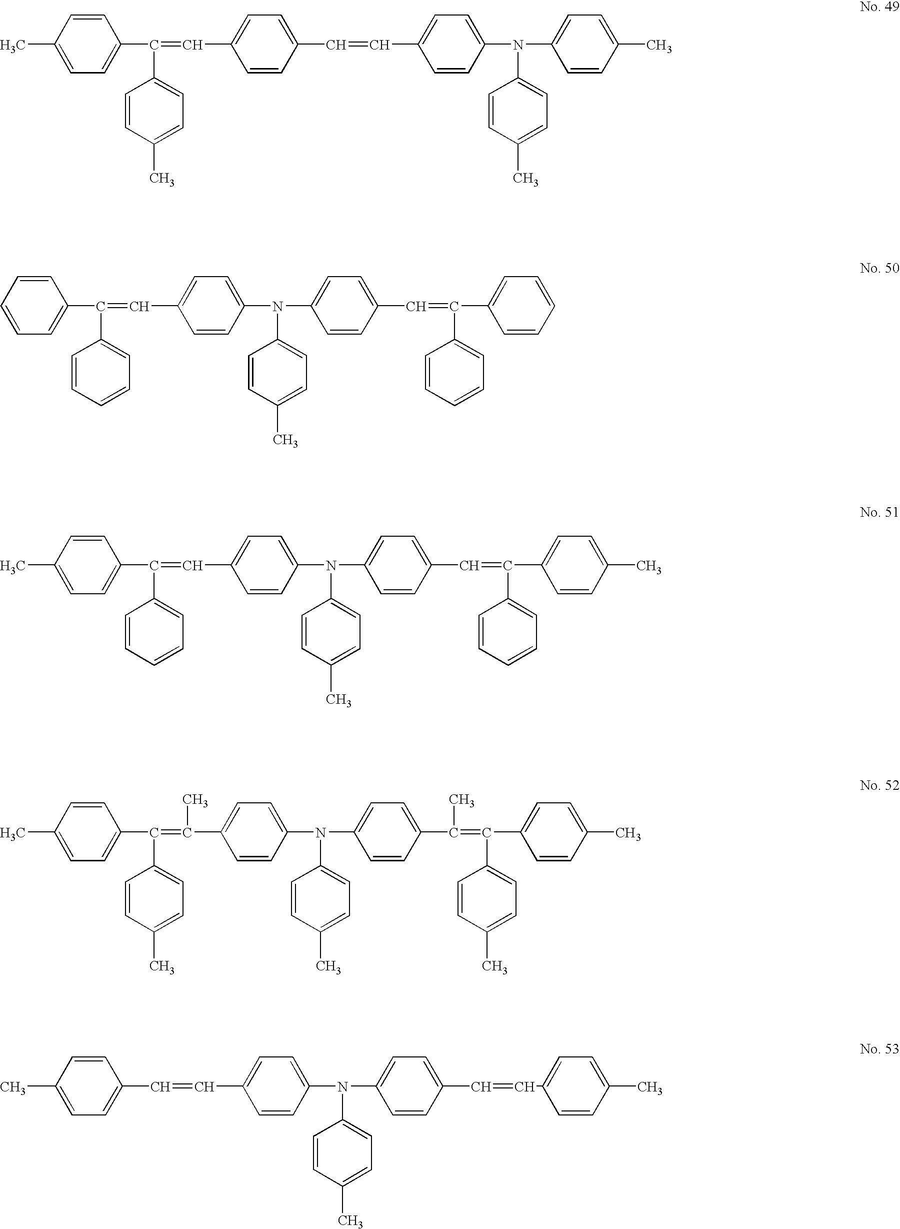

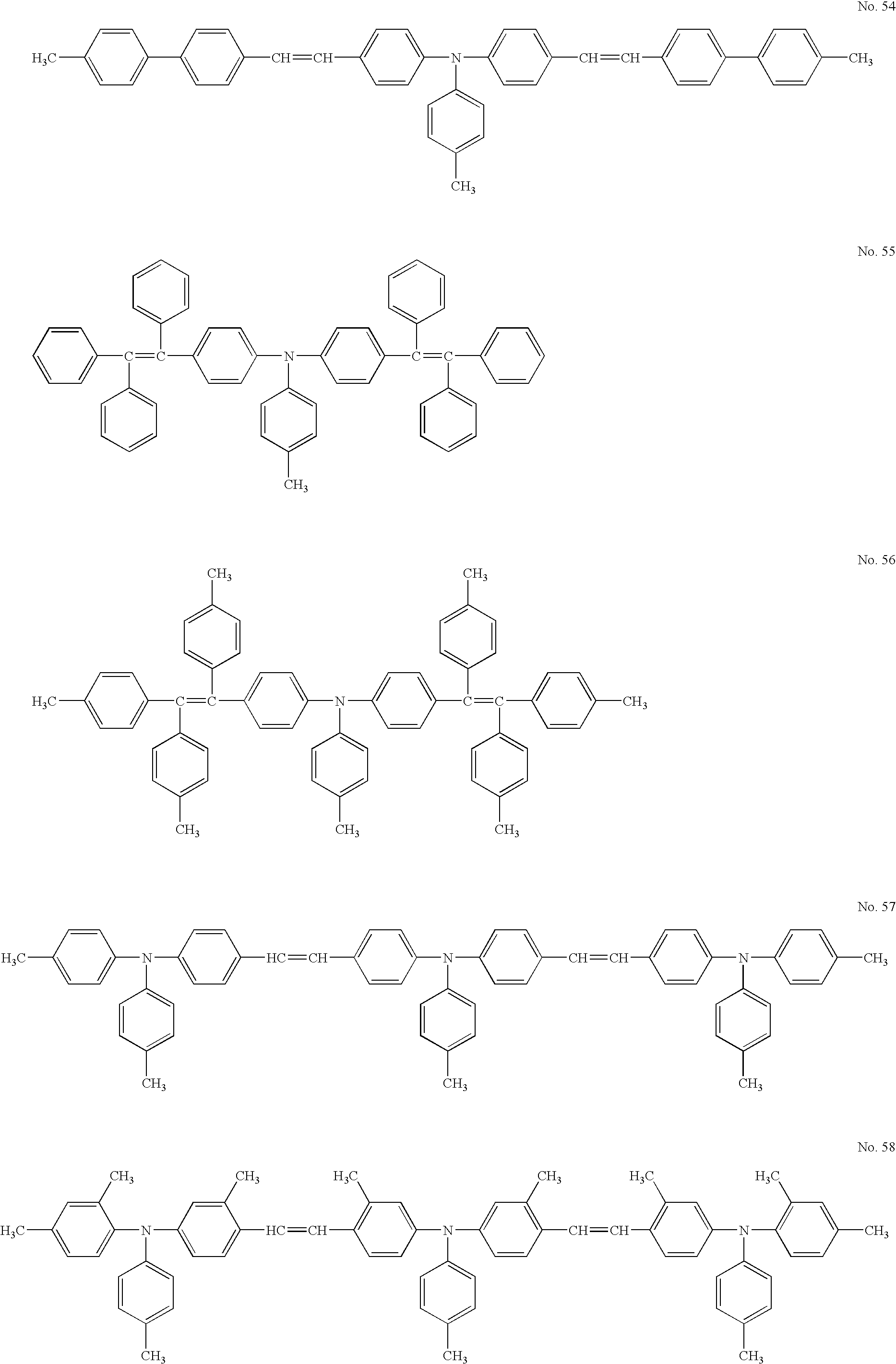

The ionization potentials of a charge generation material included in the charge generation layer and a charge transport material included in the charge transport layer preferably satisfy the following relationship (6):

Ip_{CGM}−Ip_{CTM}≧−0.1 (6)

wherein Ip_{CGM} (eV) represents the ionization potential of the charge generation material and Ip_{CTM} (eV) represents the ionization potential of the charge transport material.

When the relationship (6) is satisfied, residual potential is reduced and increase of residual potential due to electrostatic fatigue is prevented. In the present invention, the ionized potential represents an energy needed for taking out one electron from the ground state of a material.

The ionization potentials (Ip_{CGM} and Ip_{CTM}) of the charge generation material and the charge transport material can be determined by either directly measuring the materials or measuring the charge generation layer and the charge transport layer including the materials, by using an instrument such as PHOTOELECTRON SPECTROMETER SURFACE ANALYZER MODEL AC-1, AC-2, or AC-3 (manufactured by Riken Keiki Co., Ltd.).

Specific examples of the binder resins for use in the charge transport layer include, but are not limited to, thermoplastic and thermosetting resins such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate, phenoxy resins, polycarbonate, cellulose acetate resins, ethylcellulose resins, polyvinyl butyral, polyvinyl formal, polyvinyl toluene, poly(N-vinylcarbazole), acrylic resins, silicone resins, epoxy resins, melamine resins, urethane resins, phenol resins, and alkyd resins.

To shorten the real transit time in the present invention, it is important to select not only a proper charge transport material, but also a proper binder resin used for the charge transport layer, so that the binder resin does not weaken high transportability of the charge transport material. In the present invention, binder resins having a low dielectric constant such as polycarbonate and polyarylate are preferably used.

Charge transport polymers, which have functions of both a binder resin and a charge transport material, can be preferably used for the charge transport layer because the resultant charge transport layer has good abrasion resistance. In addition, the first rotation charge decline can be effectively prevented. Any known charge transport polymers can be used. Particularly, polycarbonates having a triarylamine group in a main chain and/or side chain thereof are preferably used. Among these, charge transport polymers having the following formulae (I) to (X) are preferably used:

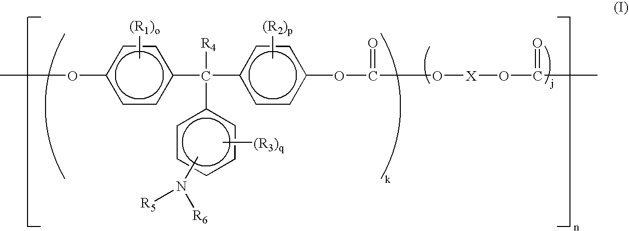

wherein each of R₁, R₂, and R₃ independently represents a substituted or unsubstituted alkyl group or a halogen atom; R₄ represents a hydrogen atom or a substituted or unsubstituted alkyl group; each of R₅ and R₆ independently represents a substituted or unsubstituted aryl group; each of o, p, and q independently represents an integer of from 0 to 4; k represents a number of from 0.1 to 1 and j represents a number of from 0 to 0.9; n represents an integer of from 5 to 5000; and X represents a divalent aliphatic group, a divalent alicyclic group, or a divalent group having the following formula (I-a):

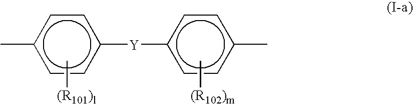

wherein each of R₁₀₁, and R₁₀₂ independently represents a substituted or unsubstituted alkyl group, a substituted or unsubstituted aryl group, or a halogen atom; each of 1 and m independently represents an integer of from 0 to 4; and Y represents a single bond, a linear, branched, or cyclic alkylene group having 1 to 12 carbon atoms, —O—, —S—, —SO—, —SO₂—, —CO—, —CO—O-Z-O—CO— (Z represents a divalent aliphatic group), or a group having the following formula (1-b):

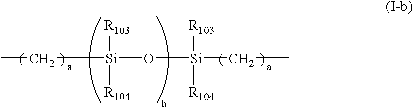

wherein a represents an integer of from 1 to 20; b represents an integer of from 1 to 2000; and each of R₁₀₃ and R₁₀₄ independently represents a substituted or unsubstituted alkyl group or a substituted or unsubstituted aryl group, wherein R₁₀₁, R₁₀₂, R₁₀₃, and R₁₀₄ may be the same or different from the others;

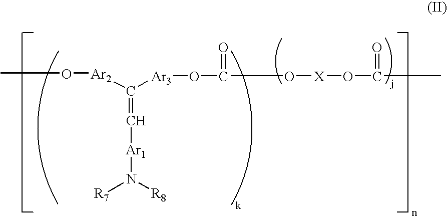

wherein each of R₇ and R₈ independently represents a substituted or unsubstituted aryl group; each of Ar₁, Ar₂, and Ar₃ independently represents an arylene group; and X, k, j, and n are as defined in the formula (1);

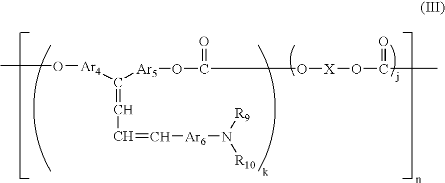

wherein each of R₉ and R₁₀ independently represents a substituted or unsubstituted aryl group; each of Ar₄, Ar₅, and Ar₆ independently represents an arylene group; and X, k, j, and n are as defined in the formula (1);

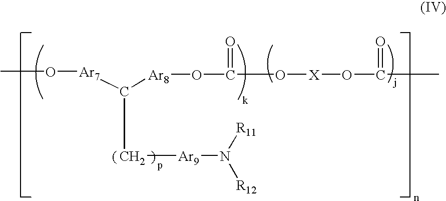

wherein each of R₁₁ and R₁₂ independently represents a substituted or unsubstituted aryl group; each of Ar₇, Ar₈, and Ar₉ independently represents an arylene group; p represents an integer of from 1 to 5; and X, k, j, and n are as defined in the formula (1);

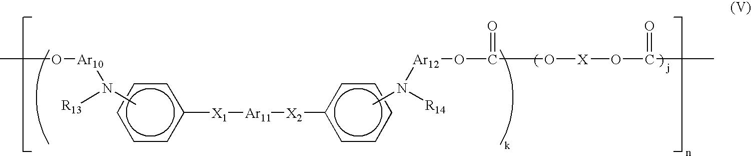

wherein each of R₁₃ and R₁₄ independently represents a substituted or unsubstituted aryl group; each of Ar₁₀, Ar₁₁, and Ar₁₂ independently represents an arylene group; each of X₁ and X₂ independently represents a substituted or unsubstituted ethylene group or a substituted or unsubstituted vinylene group; and X, k, j, and n are as defined in the formula (1);

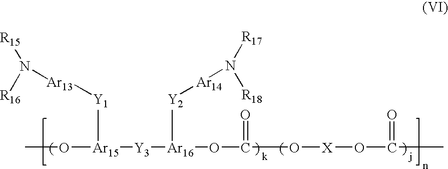

wherein each of R₁₅, R₁₆, R₁₇, and R₁₈ independently represents a substituted or unsubstituted aryl group; each of Ar₁₃, Ar₁₄, Ar₁₅, and Ar₁₆ independently represents an arylene group; each of Y₁, Y₂, and Y₃ independently represents a single bond, a substituted or unsubstituted alkylene group, a substituted or unsubstituted cycloalkylene group, a substituted or unsubstituted alkylene ether group, an oxygen atom, a sulfur atom, or a vinylene group; and X, k, j, and n are as defined in the formula (I);

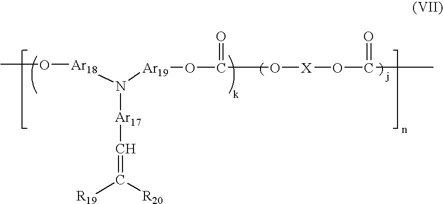

wherein each of R₁₉ and R₂₀ independently represents a hydrogen atom or a substituted or unsubstituted aryl group, and R₁₉ and R₂₀ optionally share bond connectivity to form a ring; each of Ar₁₇, Ar₁₈, and Ar₁₉ independently represents an arylene group; and X, k, j, and n are as defined in the formula (1);

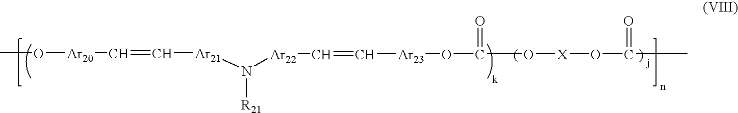

wherein R₂₁ represents a substituted or unsubstituted aryl group; each of Ar₂₀, Ar₂₁, Ar₂₂, and Ar₂₃ independently represents an arylene group; and X, k, j, and n are as defined in the formula (1);

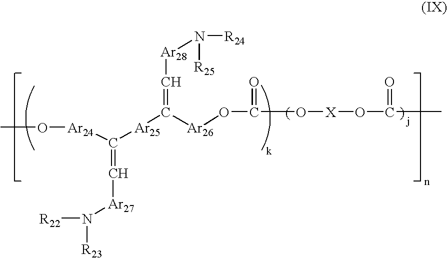

wherein each of R₂₂, R₂₃, R₂₄, and R₂₅ independently represents a substituted or unsubstituted aryl group; each of Ar₂₄, Ar₂₅, Ar₂₆, Ar₂₇, and Ar₂₈ independently represents an arylene group; and X, k, j, and n are as defined in the formula (I); and

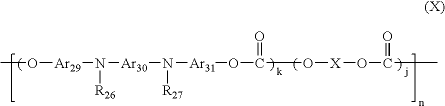

wherein each of R₂₆ and R₂₇ independently represents a substituted or unsubstituted aryl group; each of Ar₂₉, Ar₃₀, and Ar₃₁ independently represents an arylene group; and X, k, j, and n are as defined in the formula (I).

Although the formulae (I) to (X) are described in the form of alternating copolymer, these charge transport polymers may be in the form of random copolymer.

A combination of the charge transport polymer and the charge transport material contributes to shortening of the real transit time, resulting in effective prevention of the first rotation charge decline. However, if the difference in ionized potential between the charge transport polymer and the charge transport material is greater than 0.1 eV, the first rotation charge decline is not satisfactorily prevented and residual potential increases. When the difference in ionized potential between the charge transport polymer and the charge transport material is not greater than 0.1 eV, preferably not greater than 0.05 eV, the first rotation charge decline is satisfactorily prevented and residual potential may not much increase.

The content of the charge transport material in the charge transport layer is typically 20 to 300 parts by weight, and preferably from 40 to 150 parts by weight, per 100 parts by weight of the binder resin included in the charge transport layer. Two or more charge transport materials can be used in combination. Two or more binder resins can be used in combination. Prevention effect of the first rotation charge decline depends on the combination of the charge transport material and the binder resin.

Suitable solvents for use in a charge transport layer coating liquid include, but are not limited to, tetrahydrofuran, dioxane, dioxolane, toluene, cyclohexanone, methyl ethyl ketone, xylene, acetone, and diethyl ether. Among these solvents, cyclic ethers such as tetrahydrofuran and dioxane and aromatic hydrocarbons such as xylene are preferably used. These solvents can be used alone or in combination. Although halogen solvents such as dichloromethane, dichloroethane, and monochlorobenzene do not adversely affect properties of an image bearing member, these solvents are not preferably used for the purpose of reducing environmental load.

The charge transport layer coating liquid may optionally include a plasticizer, a leveling agent, an antioxidant, a lubricant, and the like. There is a problem that a charge transport layer including a charge transport material having a large molecular structure, which is effective for shortening the real transit time, easily peels off and cracks are easily produced thereon. In particular, the charge transport materials having the formulae (3) to (5) have a high melting point, a high crystallinity because of having a large molecular structure in which π-conjugated system is spread, and a low solubility. Therefore, cracks may be produced on the charge transport layer including the charge transport materials having the formulae (3) to (5) by adhesion of sebum or application of stress, in some cases. The peeling off of such a charge transport layer and the production of cracks thereon can be prevented when a plasticizer is added to the coating liquid. Specific examples of the plasticizer include, but are not limited to, dibutyl phthalate and octyl phthalate. The content of the plasticizer is preferably from 0 to 30% by weight, and more preferably from 1 to 10% by weight, based on the binder resin.

The above-described compounds having the formulae (7) or (8) effectively prevent the production of cracks. In addition, the compounds having the formulae (7) or (8) also prevent the occurrence of image deletion even in a high-concentration oxidizing gas atmosphere. Although the charge transport materials having the formulae (3) to (5) have low stability with respect to an oxidizing gas because of having a distyryl structure, a combination of the charge transport material having the formulae (3) to (5) and the compound having the formulae (7) or (8) can prevent the occurrence of image deletion and deterioration of image resolution even in an oxidizing gas atmosphere. The combination of the charge transport material having the formulae (3) to (5) and the compound having the formulae (7) or (8) can also prevent deterioration of chargeability due to electrostatic fatigue. As a result, high quality images can be stably produced. Besides, the compounds having the formulae (7) or (8) have a charge transport structure, and therefore residual potential does not increase even if a large amount of the compound having the formulae (7) or (8) is used.

Specific examples of the compounds having the formulae (7) or (8) include, but are not limited to, the following compounds No. 101 to 130.

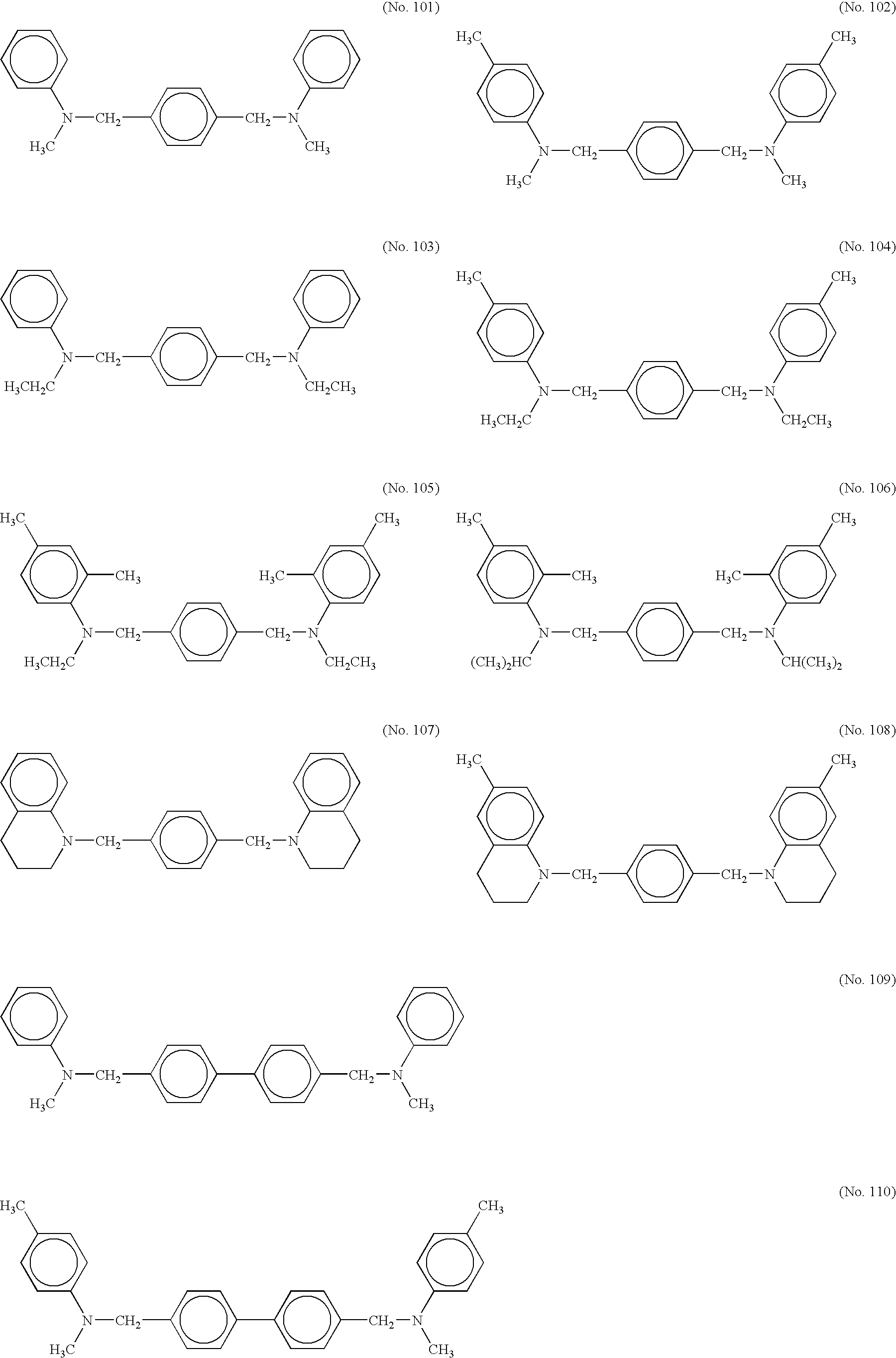

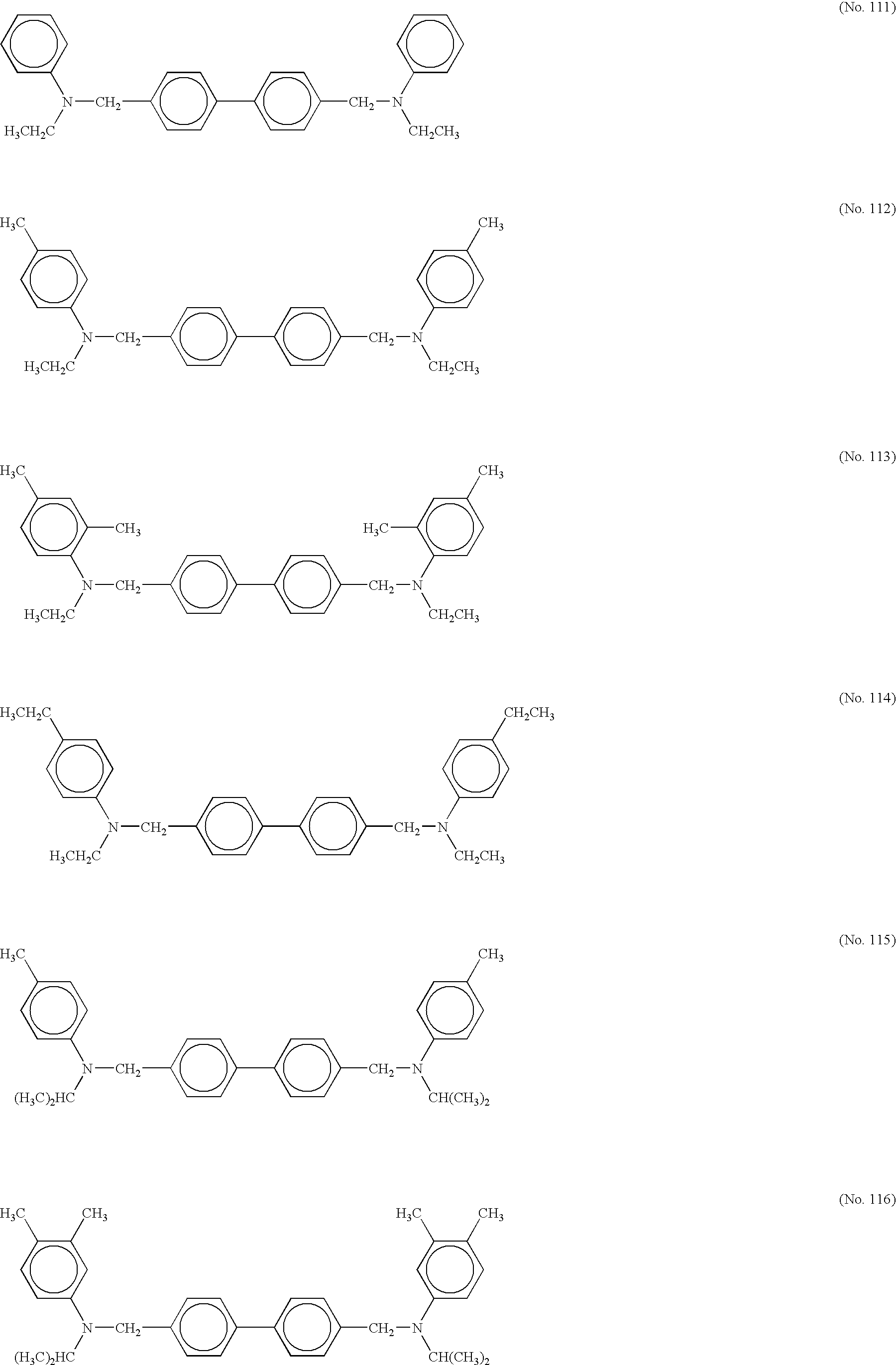

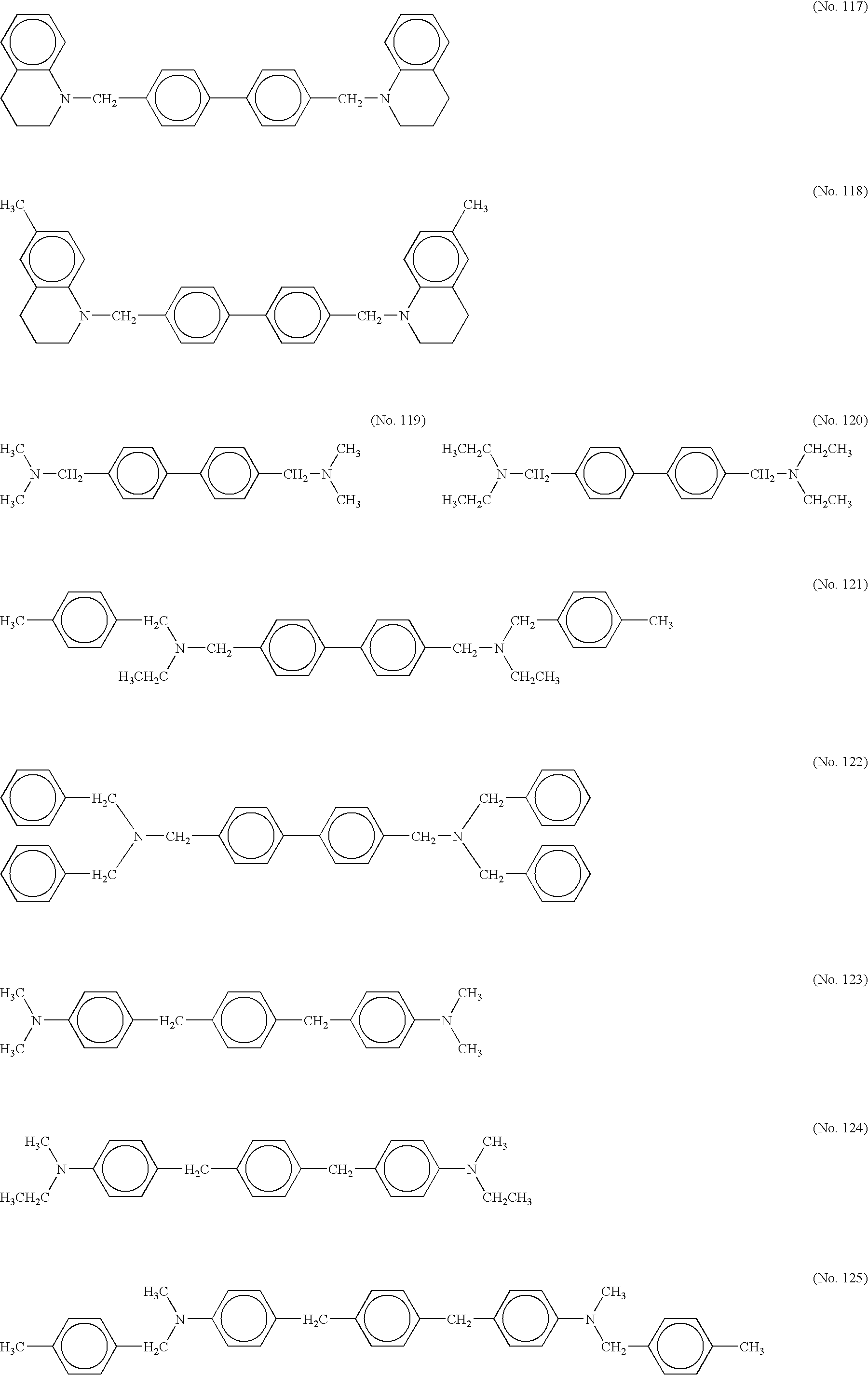

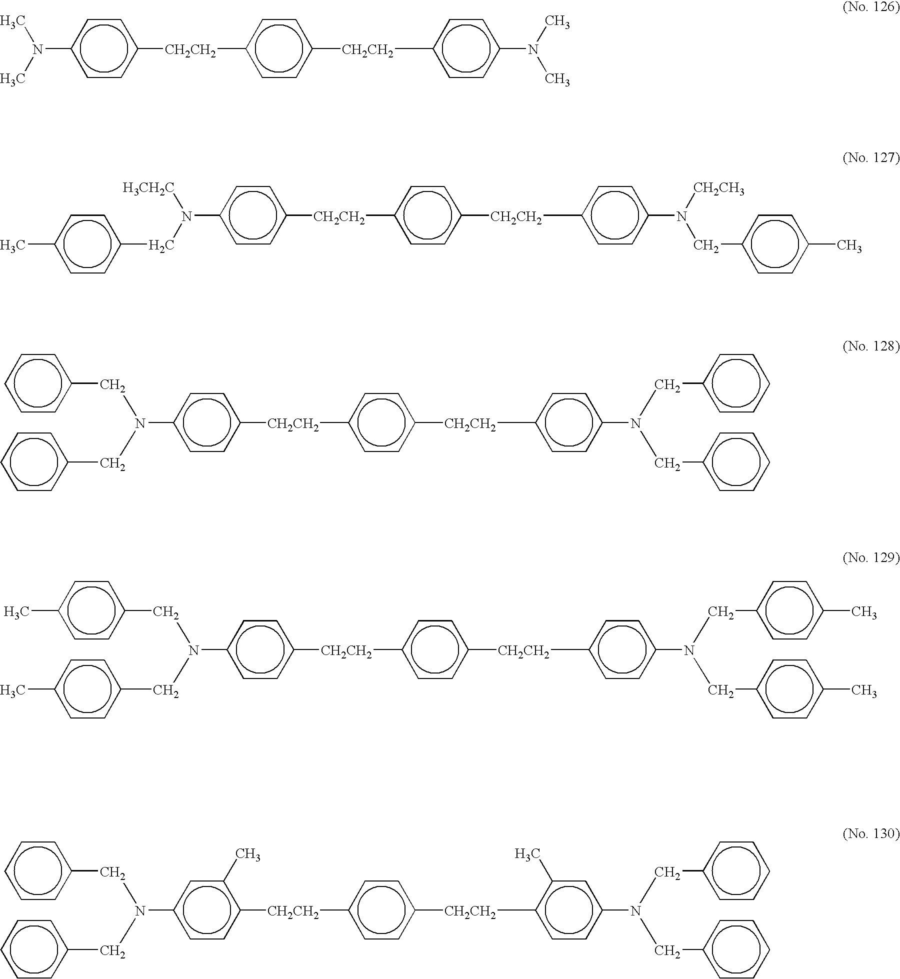

The content of the compound having the formulae (7) or (8) is preferably 0 to 30% by weight, and more preferably 1.0 to 15% by weight, based on the charge transport material included in the charge transport layer. When the content is too large, residual potential may increase. When the content is too small, image resolution may decrease in a high-concentration oxidizing gas atmosphere, and cracks may be produced by adhesion of sebum.

In the present invention, an antioxidant is preferably used. Specific examples of the antioxidants include, but are not limited to, phenol compounds, p-phenylenediamines, hydroquinones, organic sulfur compounds, organic phosphor compounds, and hindered amines. These compounds can effectively stabilize electrostatic properties even when the resultant image bearing member is repeatedly used. Specifically, the above-described compounds having the formulae (9) to (12) have high antioxidant ability. Although the charge transport material having the formulae (3) to (5) have relatively low stability in an oxidizing gas atmosphere, a combination of the charge transport material having the formula (3) to (5) and the above-described antioxidant can prevent deterioration of chargeability and the occurrence of image deletion. Use of a mixture of two antioxidants is much effective. Furthermore, use of a mixture of the two antioxidants and the compounds having the formulae (7) or (8) is much more effective. There are various materials producing various effects. For example, a material having a high antioxidant performance against ozone which is produced by a charger; a material having a high antioxidant performance against NOx gases; a material that effectively prevents deterioration of chargeability, occurred due to release of charges accumulated in an electrostatically fatigued photosensitive layer; and a material that effectively prevents the occurrence of image deletion, deterioration of image resolution, and production of ghost image, can be mentioned. Mixtures of these materials can simultaneously produce various effects, resulting in production of high quality images.

The content of the antioxidant is preferably 0 to 20% by weight, and more preferably 0.1 to 10% by weight, based on the charge transport material. When the content is too large, residual potential may rapidly increase. When the content is too small, image resolution may deteriorate in an oxidizing gas atmosphere, and chargeability deteriorates due to electrostatic fatigue.

Specific examples of the leveling agent include, but are not limited to, silicone oils such as dimethyl silicone oil and methylphenyl silicone oil, and polymers and oligomers having a perfluoroalkyl group in a side chain thereof. The content of the leveling agent is preferably from 0 to 1% by weight, and more preferably from 0.01 to 0.5% by weight, based on the binder resin. Use of the leveling agent prevents coating defect of the photosensitive layer or the charge transport layer, resulting in provision of a smooth layer.

The lubricant is effective for enhancing slip property of the surface of the resultant image bearing member and preventing adhesion of foreign substances to the surface of the resultant image bearing member. Specific examples of the lubricant include, but are not limited to, silicone oils, fine particles of silicones, fine particles of fluorocarbon resins, and waxes. The content of the lubricant is preferably from 0 to 30% by weight, and more preferably from 1 to 20% by weight, based on the binder resin.

Suitable coating methods of the charge transport layer include, but are not limited to, a dip coating method, a spray coating method, a bead coating method, a nozzle coating method, a spinner coating method, and a ring coating method. The coated layer is dried to the touch, and subsequently dried upon application of heat using an oven, and the like. The drying temperature is preferably from 80 to 150° C., and more preferably from 100 to 140° C., but the drying temperature depends on the solvent used in the coating liquid. The charge transport layer typically has a thickness of from 10 to 50 μm. The image bearing member for use in the present invention preferably has as thick a charge transport layer as possible from the viewpoint of durability. In contrast, the image bearing member for use in the present invention preferably has as thin a charge transport layer as possible from the viewpoint of prevention of the first rotation charge decline, because the real transit time depends on the thickness of the charge transport layer. Considering the above matters, the charge transport layer preferably has a thickness of from 15 to 40 μm, and more preferably from 20 to 35 μm.

### (Single-Layer Photosensitive Layer)

In the present invention, the photosensitive layer may be a single-layer photosensitive layer. In this case, the photosensitive layer is typically formed by coating a coating liquid, which is prepared by dispersing or dissolving a charge generation material, a charge transport material, a binder resin in a solvent, on a conductive substrate or an undercoat layer, followed by drying. Suitable materials for use as the charge generation material and the charge transport material include the materials described above for use as the charge generation material in the charge generation layer and the charge transport material in the charge transport layer, respectively. Suitable materials for use as the binder resin include the materials described above for use as the binder resin in the charge generation layer and the charge transport layer. In addition, the charge transport polymers described above can also be preferably used for the single-layer photosensitive layer. The content of the charge generation material is preferably from 5 to 40 parts by weight, more preferably from 10 to 30 parts by weight, and the content of the charge transport material is preferably from 0 to 190 parts by weight, more preferably from 50 to 150 parts by weight, per 100 parts by weight of the binder resin included in the layer.

The single-layer photosensitive layer is typically prepared by coating a coating liquid, which is prepared by dissolving or dispersing a charge generation material, a binder resin, and optionally together with a charge transport material in a solvent such as tetrahydrofuran, dioxane, dichloroethane, cyclohexanone, toluene, methyl ethyl ketone, and acetone. Suitable coating methods include a dip coating method, a spray coating method, a bead coating method, a ring coating method, and the like. Additives such as a plasticizer, a leveling agent, an antioxidant, and a lubricant can be added to the coating liquid, if desired. The photosensitive layer preferably has a thickness of from 5 to 25 μm. The distance to the surface of the image bearing member which is traveled by charges is shorter in the single-layer photosensitive layer than in the multilayer photosensitive layer. However, each charge has variation in moving speed because the charge generation material is present in the layer. In the present invention, the multilayer photosensitive layer is more preferably used for the purpose of preventing the first rotation charge decline.

### (Undercoat Layer)

The image bearing member for use in the present invention can include an undercoat layer between the conductive substrate and the photosensitive layer. The undercoat layer typically includes a resin as a main component. Since the photosensitive layer is typically formed on the undercoat layer by a wet coating method, the undercoat layer preferably has a good resistance to the solvent included in the coating liquid of the photosensitive layer. Suitable resins for use in the undercoat layer include, but are not limited to, water-soluble resins such as polyvinyl alcohol, casein, and sodium polyacrylate; alcohol-soluble resins such as copolymer polyamide (copolymer nylon) and methoxymethylated polyamide (nylon); and cured resins forming a three-dimensional network structure such as polyurethane, melamine resins, phenol resins, alkyd-melamine resins, isocyanate, and epoxy resins.

In addition, to prevent the occurrence of moiré and to decrease residual potential, the undercoat layer can include a metal oxide. The moiré is an image defect with an interference fringe caused by optical interference of a coherent writing light beam such as a laser light beam in the photosensitive layer. Since the occurrence of the moiré can be prevented when the laser light beam is scattered by the undercoat layer, the undercoat layer preferably includes a material having a large refractive index. An undercoat layer in which an inorganic pigment is dispersed in a binder resin is the most preferable configuration for preventing the occurrence of the moiré. Suitable inorganic pigments for use in the undercoat layer include, but are not limited to, white metal oxides such as titanium oxide, zinc oxide, calcium oxide, silicon oxide, magnesium oxide, aluminum oxide, tin oxide, zirconium oxide, and indium oxide; and calcium fluoride.

To reduce residual potential, the undercoat layer preferably has a function of transporting a charge having the same polarity to the charge of the surface of the image bearing member from the photosensitive layer to the conductive substrate. The above-described inorganic pigments have such a function. When the surface of the image bearing member is negatively charged, the undercoat layer preferably has electron conductivity to reduce residual potential. When the undercoat layer includes an inorganic pigment with a low resistivity or the ratio of the inorganic pigment to the binder resin in the undercoat layer increases, residual potential is largely reduced, however, background fouling tends to occur in the resultant image. It is important to prevent the occurrence of background fouling and to reduce residual potential at the same time by controlling the layer structure or the thickness of the undercoat layer or the content of the inorganic pigment. Among the above-described metal oxides, titanium oxide is most preferably used in consideration of prevention of the occurrence of moiré and background fouling, increase of residual potential, and the first rotation charge decline.

In the present invention, the metal oxide for use in the undercoat layer preferably has a number average primary particle diameter of from 0.01 to 0.8 μm, and more preferably from 0.05 to 0.5 μm. When a metal oxide having a number average primary particle diameter of not greater than 1 μm is used, the occurrence of background fouling can be prevented, but the occurrence of moiré may not be effectively prevented. On the other hand, when a metal oxide having a number average primary particle diameter of greater than 0.4 μm is used, the occurrence of moiré can be prevented, but the occurrence of background fouling may not be effectively prevented. For the above reason, a mixture of metal oxides each having a different number average primary particle diameter is preferably used to simultaneously prevent the occurrence of background fouling and moiré. The mixture of metal oxides each having a different number average primary particle diameter is also effective for reducing residual potential and preventing the first rotation charge decline. This is because the amount of charges trapped in the undercoat layer may decrease for the following reason: since the undercoat layer is densely filled with particles of metal oxides each having a different number average primary particle diameter, contact area between each of the metal oxide particles becomes large.

The undercoat layer includes a binder resin and an inorganic pigment (metal oxide) as main components. An undercoat layer coating liquid is prepared by dissolving or dispersing the binder resin and the inorganic pigment in a solvent. Suitable solvents for use in the coating liquid include, but are not limited to, acetone, methyl ethyl ketone, methanol, ethanol, butanol, cyclohexanone, dioxane, and the like, and mixtures thereof. The inorganic pigment is dispersed in the solvent together with the binder resin by a typical dispersion means such as a ball mill, a sand mill, and an attritor, to prepare the coating liquid. The binder resin may be added to the undercoat layer coating liquid either before or after the inorganic pigment is dispersed therein. The undercoat layer coating liquid optionally includes an agent needed for curing (crosslinking), an additive, a curing accelerator, a dispersing agent for inorganic pigments, and the like, if desired. The undercoat layer coating liquid is coated on the conductive substrate, or the like, by a typical coating method such as a dip coating method, a spray coating method, a ring coating method, a bead coating method, and a nozzle coating method. Subsequently, the coated liquid is dried, heated, and/or optionally irradiated with a light beam to be cured, to form an undercoat layer. The undercoat layer preferably has a thickness of from 0 to 20 μm, and more preferably from 2 to 10 μm, but it depends on the inorganic pigment used.

Further, a resin layer can be provided between the conductive substrate and the undercoat layer, or between the undercoat layer and the photosensitive layer or charge generation layer. The resin layer is provided for the purpose of preventing hole injection from the conductive substrate, resulting in prevention of the occurrence of background fouling. The resin layer typically includes a binder resin as a main component. Suitable resins for use in the resin layer include, but are not limited to, polyamide, alcohol-soluble polyamide (soluble nylon), copolymer polyamide (copolymer nylon), methoxymethylated polyamide (nylon), water-soluble polyvinyl butyral, polyvinyl butyral, and polyvinyl alcohol. A provision of the resin layer is effective for preventing the occurrence of background fouling and deterioration of chargeability. When the charge transport materials having the formulae (3) to (5), which have high charge injection ability and charge transport ability, or materials having a lower ionized potential than the charge transport materials are used, the level of the occurrence of background fouling may deteriorate in some cases. This is because the charge transport material penetrates to the conductive substrate after the charge transport layer coating liquid is coated, resulting in increase of hole injection ability of the conductive substrate. This phenomenon may occur in an image bearing member having an undercoat layer. When the resin layer is provided between the conductive substrate and the photosensitive layer or charge generation layer, hole injection from the conductive substrate can be prevented. As a result, the occurrence of background fouling and deterioration of chargeability can be prevented. Among the above-described resins, a polyamide resin, more specifically N-methoxymethylated polyamide (nylon), is preferably used in the present invention, because such a resin can effectively prevent charge injection without influencing residual potential in any temperature and humidity environments.

The resin layer preferably has a thickness of from 0.05 to 2 μm, and more preferably from 0.5 to 1.0 μm. When the thickness is too large, the amount of charge decline in the first rotation and residual potential may increase. When the thickness is too small, charge injection cannot be effectively prevented, and therefore chargeability decreases. The resin layer can be prepared by any known typical coating methods such as a dip coating method, a spray coating method, a ring coating method, a bead coating method, and a nozzle coating method.

The combination of the resin layer and the undercoat layer contributes to prevention of the occurrence of background fouling and moire and decrease of residual potential, resulting in production of high quality images.

At least one of the charge generation layer, charge transport layer, single-layer photosensitive layer, undercoat layer, and resin layer preferably includes an antioxidant, a plasticizer, a lubricant, an ultraviolet absorber, and/or a leveling agent for the purpose of improving environmental stability, particularly preventing deterioration of sensitivity and chargeability and increase of residual potential.

Specific examples of suitable antioxidants include the following compounds, but are not limited thereto.

### (a) Phenol Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol),
2,2′-methylene-bis-(4-methyl-6-t-butylphenol),
2,2′-methylene-bis-(4-ethyl-6-t-butylphenol), 4,4′-thiobis-(3-methyl-6-t-butylphenol),
4,4′-butylidenebis-(3-methyl-6-t-butylphenol),
1,1,3-tris-(2-methyl-4-hydroxy-5-t-butylphenyl)butane,
1,3,5-trimethyl-2,4,6-tris(3,5-di-t-butyl-4-hydroxybenzyl)benzene,
tetrakis-[methylene-3-(3′,5′-di-t-butyl-4′-hydroxyphenyl)propionate]methane,
bis[3,3′-bis(4′-hydroxy-3′-t-butylphenyl)butyric acid]glycol ester, tocopherols, etc.

### (b) Paraphenylenediamines

N-phenyl-N′-isopropyl-p-phenylenediamine, N,N′-di-sec-butyl-p-phenylenediamine,
N-phenyl-N-sec-butyl-p-phenylenediamine, N,N′-di-isopropyl-p-phenylenediamine,
N,N′-dimethyl-N,N′-di-t-butyl-p-phenylenediamine, etc.

### (c) Hydroquinones

2,5-di-t-octylhydroquinone, 2,6-didodecylhydroquinone, 2-dodecylhydroquinone,
2-dodecyl-5- chlorohydroquinone, 2-t-octyl-5-methylhydroquinone,
2-(2-octadecenyl)-5-methylhydroquinone, etc.

### (d) Organic Sulfur Compounds

dilauryl-3,3′-thiodipropionate, distearyl-3,3′-thiodipropionate,
ditetradecyl-3,3′-thiodipropionate, etc.

### (e) Organic Phosphor Compounds

triphenylphosphine, tri(nonylphenyl)phosphine, tri(dinonylphenyl)phosphine,
tricresylphosphine, tri(2,4-dibutylohenoxy)phosphine, etc.

Specific examples of suitable plasticizers include the following compounds, but are not limited thereto.

### (a) Phosphate Plasticizers

triphenyl phosphate, tricresyl phosphate, trioctyl phosphate, octyl diphenyl phosphate,
trichloroethyl phosphate, cresyl diphenyl phosphate, tributyl phosphate, tri-2-ethylhexyl phosphate, triphenyl phosphate, etc.

### (b) Phthalate Plasticizers

dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butyl benzyl phthalate, butyl lauryl phthalate, methyl oleyl phthalate, octyl decyl phthalate, dibutyl phthalate, dioctyl phthalate, etc.

### (c) Aromatic Carboxylate Plasticizers

trioctyl trimellitate, tri-n-octyl trimellitate, octyl oxybenzoate, etc.

### (d) Dibasic Esters of Aliphatic Series

dibutyl adipate, di-n-hexyl adipate, di-2-ethylhexyl adipate, n-octyl adipate,
n-octyl-n-decyl adipate, diisodecyl adipate, dicapryl adipate, di-2-ethylhexyl azelate,
dimethyl sebacate, diethyl sebacate, dibutyl sebacate, di-n-octyl sebacate,
di-2-ethylhexyl sebacate, di-s-ethoxyethyl sebacate, dioctyl succinate, diisodecyl succinate, dioctyl tetrahydrophthalate, di-n-octyl tetrahydrophthalate, etc.

### (e) Fatty Acid Ester Derivatives

butyl oleate, glycerin monooleate, methyl acetylricinolate, pentaerythritol esters, dipentaerythritol hexaesters, triacetin, tributyrin, etc.

### (f) Oxyacid Ester Plasticizers

methyl acetylricinolate, butyl acetylricinolate, butyl phthalyl butyl glycolate, tributyl acetylcitrate, etc.

### (g) Epoxy Plasticizers

epoxidized soybean oil, epoxidized linseed oil, butyl epoxystearate, decyl epoxystearate, octyl epoxystearate, benzyl epoxystearate, dioctyl epoxyhexahydrophthalate, didecyl epoxyhexahydrophthalate, etc.

### (h) Divalent Alcohol Ester Plasticizers

diethylene glycol dibenzoate, triethylene glycol di-2-ethylbutyrate, etc.

### (i) Chlorine-Containing Plasticizers

chlorinated paraffin, chlorinated diphenyl, methyl esters of chlorinated fatty acids, methyl esters of methoxychlorinated fatty acids, etc.

### (j) Polyester Plasticizers

polypropylene adipate, polypropylene sebacate, polyester, acetylated polyester, etc.

### (k) Sulfonic Acid Derivatives

p-toluene sulfonamide, o-toluene sulfonamide, p-toluene sulfonethylamide, o-toluene sulfonethylamide, toluenesulfon-N-ethylamide, p-toluenesulfon-N-cyclohexylamide, etc.

### (l) Citric Acid Derivatives

triethyl citrate, triethyl acetylcitrate, tributyl citrate, tributyl acetylcitrate, tri-2-ethylhexyl acetylcitrate, n-octyldecyl acetylcitrate, etc.

### (m) Others

terphenyl, partially hydrated terphenyl, camphor, 2-nitrodiphenyl, dinonyl naphthalene, methyl abietate, etc.

Specific examples of suitable lubricants include the following compounds, but are not limited thereto.

### (a) Hydrocarbon Compounds

liquid paraffin, paraffin wax, micro wax, low-polymerization polyethylene, etc.

### (b) Fatty Acid Compounds

lauric acid, myristic acid, palmitic acid, stearic acid, arachidic acid, behenic acid, etc.

### (c) Fatty Acid Amide Compounds

stearyl amide, palmitic acid amide, oleic acid amide, methylenebis stearamide, etc.

### (d) Ester Compounds

lower alcohol esters of fatty acids, polyol esters of fatty acids, polyglycol esters of fatty acids, etc.

### (e) Alcohol Compounds

cetyl alcohol, stearyl alcohol, ethylene glycol, polyethylene glycol, polyglycerol, etc.

### (f) Metallic Soaps

lead stearate, cadmium stearate, barium stearate, calcium stearate, zinc stearate, magnesium stearate, etc.

### (g) Natural Waxes

carnauba wax, candelilla wax, beeswax, spermaceti, insect wax, montan wax, etc.

### (h) Others

silicone compounds, fluorine compounds, etc.

Specific examples of suitable ultraviolet absorbers include the following compounds, but are not limited thereto.

### (a) Benzophenones

2-hydroxybenzophenone, 2,4-dihydroxybenzophenone, 2,2′,4-trihydroxybenzophenone,
2,2′,4,4′-tetrahydroxybenzophenone, 2,2′-dihydroxy-4-methoxybenzophenone, etc.

### (b) Salicylates

phenyl salicylate, 2,4-di-t-butylphenyl-3,5-di-t-butyl-4-hydroxybenzoate, etc.

### (c) Benzotriazoles

(2′-hydroxyphenyl)benzotriazole, (2′-hydroxy-5′-methylphenyl)benzotriazole,
(2′-hydroxy-3′-tert-butyl-5′-methylphenyl)5-chlorobenzotriazole, etc.

### (d) Cyanoacrylates

ethyl-2-cyano-3,3-diphenyl acrylate, methyl-2-carbomethoxy-3(paramethoxy) acrylate, etc.

### (e) Quenchers (Metal Complexes)

nickel(2,2′-thiobis(4-t-octyl)phenolate)n-butylamine, nickel dibutyldithiocarbamate, cobalt dicyclohexyldithiophosphate, etc.

### (f) HALS (Hindered Amines)

bis(2,2,6,6-tetramethyl-4-piperidyl)sebacate,
bis(1,2,2,6,6-pentamethyl-4-piperidyl)sebacate,
1-[2-{3-(3,5-di-t-butyl-4-hydroxyphenyl)propionyloxy}ethyl]-4-{3-(3,5-di-t-butyl-4-hyd roxyphenyl)propionyloxy}-2,2,6,6-tetramethylpyridine,
8-benzyl-7,7,9,9-tetramethyl-3-octyl-1,3,8-triazaspiro[4,5]undecane-2,4-dione,
4-benzoyloxy-2,2,6,6-tetramethylpiperidine, etc.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis Example of Titanyl Phthalocyanine Pigment

A titanyl phthalocyanine pigment was prepared with reference to JP-A 2004-83859 (the disclosure of which is incorporated herein by this reference) as follows.

At first, 292 parts of 1,3-diiminoisoindoline and 1,800 parts of sulfolane were mixed, and 204 parts of titanium tetrabutoxide were added thereto under nitrogen airflow. The mixture was gradually heated to 180° C., and reacted for 5 hours at a reaction temperature of from 170 to 180° C. while being agitated. After the reaction was terminated, the mixture was stood to cool and filtered. The deposited powders were washed with chloroform until the powder became blue, subsequently washed with methanol for several times, and further washed with hot water having a temperature of 80° C. for several times, followed by drying. Thus, a crude titanyl phthalocyanine was prepared.

The crude titanyl phthalocyanine was dissolved in twenty times the amount of concentrated sulfuric acid. The thus prepared sulfuric acid solution was dropped in one hundred times the amount of ice water under agitation. The deposited crystal was filtered, and subsequently repeatedly washed with ion-exchange water having a pH of 7 and a specific conductance of 1.0 μS/cm. After washing the deposited crystal, the ion-exchange water had a pH of 6.8 and a specific conductance of 2.6 μS/cm. Thus, a wet cake (water paste) (i) of a titanyl phthalocyanine pigment was prepared.

Next, 40 parts of the wet cake (water paste) (i) was poured into 200 parts of tetrahydrofuran, and the mixture was strongly agitated at room temperature at a revolution of 200 rpm using a HOMOMIXER MARK II f model (from Kenis, Ltd.) until the color of the paste was changed from navy blue to pale blue. (It took 20 minutes after the agitation was started.) Immediately after the agitation was stopped, the mixture was filtered under reduced pressure. The filtered crystal was washed with tetrahydrofuran, resulting in preparation of a wet cake (ii). The wet cake (ii) was dried for 2 days at 70° C. under a reduced pressure of 5 mmHg. Thus, 8.5 parts of a titanyl phthalocyanine pigment (1) was prepared.

The wet cake (ii) includes solid components in an amount of 15% by weight. Thirty-three times the amount of the crystal transformation solvent (i.e., tetrahydrofuran) was used based on the wet cake (ii). All of the raw materials used in this synthesis example include no halogen-containing compound.

The titanyl phthalocyanine pigment (1) had an X-ray diffraction spectrum in which a maximum diffraction peak was observed at 27.2°, main diffraction peaks were observed at 9.4°, 9.6°, and 24.0°, a diffraction peak with the smallest angle was observed at 7.3°, and no diffraction peak was observed either in a range of greater than 7.3° and less than 9.4° or at 26.3°, among each of Bragg angles (2θ±0.2°), obtained using a characteristic X-ray specific to CuKα having a wavelength of 1.542 Å. The X-ray diffraction spectrum of the titanyl phthalocyanine pigment (1) is illustrated in FIG. 17. The measurement conditions of the X-ray diffraction spectrum were as follows.
X-ray lamp: Cu
Voltage: 50 kV
Current: 30 mA
Scanning velocity: 2°/min
Scanning range: 3° to 40°
Time constant: 2seconds

Next, the titanyl phthalocyanine pigment (1) was dispersed in a 2-butanone solution, in which polyvinyl butyral was dissolved therein, using a commercially available bead mill with a PSZ ball having a diameter of 0.5 mm for 30 minutes at a revolution of 1200 rpm, to prepare a dispersion of the titanyl phthalocyanine pigment (1).

### Synthesis Examples of Azo Pigment

An azo pigment was prepared with reference to JP 3026645 (the disclosure of which is incorporated herein by this reference).

The above-prepared azo pigment was dispersed in a cyclohexanone solution, in which polyvinyl butyral was dissolved therein, using a ball mill with a PSZ ball having a diameter of 10 mm for 7 days at a revolution of 85 rpm. Thus, a dispersion of the azo pigment was prepared.

### Manufacturing Example 1 of Image Bearing Member

A resin layer coating liquid, an undercoat layer coating liquid, a charge generation layer coating liquid, and a charge transport layer coating liquid, each having the following compositions, were successively coated on an aluminum cylinder having an outer diameter of 30 mm and dried in an oven, in this order. The resin layer was dried at 130° C. for 10 minutes, the undercoat layer was dried at 130° C. for 20 minutes, the charge generation layer was dried at 90° C. for 20 minutes, and the charge transport layer was dried at 135° C. for 20 minutes. Thus, an image bearing member (1) having a resin layer having a thickness of about 0.7 μm, an under coat layer having a thickness of about 3.5 μm, a charge generation layer having a thickness of about 0.2 μm, and a charge transport layer having a thickness of about 27 μm are prepared.

### (Composition of Resin Layer Coating Liquid)

| | |
|---|---|
| N-methoxymethylated nylon | 5 parts |
| (FR101 from Namariichi Co., Ltd.) | |
| Methanol | 70 parts |
| n-Butanol | 30 parts |

### (Composition of Undercoat Layer Coating Liquid)

| | |
|---|---|
| Titanium oxide (1) | 50 parts |
| (CR-EL from Ishihara Sangyo Kaisha Ltd., having an average | |
| primary particle diameter of about 0.25 μm) | |
| Titanium oxide (2) | 20 parts |
| (PT-401M from Ishihara Sangyo Kaisha Ltd., having an | |
| average primary particle diameter of about 0.07 μm) | |
| Alkyd resin | 14 parts |
| (BECKOLITE ® M6401-50 from Dainippon Ink and | |
| Chemicals, Incorporated, including solid components | |
| in an amount of 50%) | |
| Melamine resin | 8 parts |
| (L-145-60 from Dainippon Ink and Chemicals, Incorporated, | |
| including solid components in an amount of 60%) | |
| 2-Butanone | 70 parts |

### (Composition of Charge Generation Layer Coating Liquid)

| | |
|---|---|
| Titanyl phthalocyanine pigment (1) | 8 parts |
| (having an ionization potential of 5.27 eV an | |
| X-ray diffraction spectrum illustrated in FIG. 17) | |
| Polyvinyl butyral | 5 parts |
| (BX-1 from Sekisui Chemical Co., Ltd.) | |
| 2-Butanone | 400 parts |

### (Composition of Charge Transport Layer Coating Liquid)

| | | |
|---|---|---|
| Polycarbonate | 10 | parts |
| (Z-form polycarbonate resin from Teijin Chemicals Ltd.) | | |
| Charge transport material No. 14 | 7 | parts |
| (having an ionization potential of 5.24 eV) | | |
| Silicone oil | 0.002 | parts |
| (1 cm²/s (100 cSt), from Shin-Etsu Chemical Co., Ltd.) | | |
| Tetrahydrofuran | 100 | parts |
| Compound having an alkylamino group, having the | 1 | part |
| following formula | | |

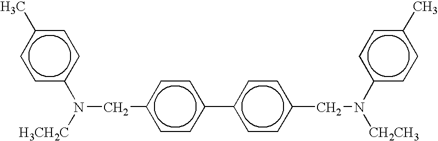

| | | |
|---|---|---|
| Antioxidant having the following formula | 0.03 | parts |

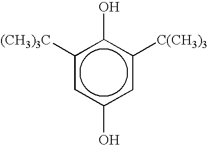

### Manufacturing Example 2 of Image Bearing Member

The procedure for preparing the image bearing member (1) in Manufacturing Example 1 was repeated except that the charge transport material No. 14 was replaced with the charge transport material No. 12 (having an ionization potential of 5.28 eV). Thus, an image bearing member (2) was prepared.

### Manufacturing Example 3 of Image Bearing Member

The procedure for preparing the image bearing member (1) in Manufacturing Example 1 was repeated except that the charge transport material No. 14 was replaced with the charge transport material No. 7 (having an ionization potential of 5.20 eV). Thus, an image bearing member (3) was prepared.

### Manufacturing Example 4 of Image Bearing Member

The procedure for preparing the image bearing member (1) in Manufacturing Example 1 was repeated except that the charge transport material No. 14 was replaced with the charge transport material No. 4 (having an ionization potential of 5.31 eV). Thus, an image bearing member (4) was prepared.

### Manufacturing Example 5 of Image Bearing Member

The procedure for preparing the image bearing member (1) in Manufacturing Example 1 was repeated except that the charge transport material No. 14 was replaced with the charge transport material No. 13 (having an ionization potential of 5.24 eV). Thus, an image bearing member (5) was prepared.

### Manufacturing Example 6 of Image Bearing Member

The procedure for preparing the image bearing member (1) in Manufacturing Example 1 was repeated except that the charge transport material No. 14 was replaced with the charge transport material No. 17 (having an ionization potential of 5.39 eV). Thus, an image bearing member (6) was prepared.

### Manufacturing Example 7 of Image Bearing Member

The procedure for preparing the image bearing member (1) in Manufacturing Example 1 was repeated except that the charge transport material No. 14 was replaced with the charge transport material No. 41 (having an ionization potential of 5.27 eV). Thus, an image bearing member (7) was prepared.

### Manufacturing Example 8 of Image Bearing Member

The procedure for preparing the image bearing member (1) in Manufacturing Example 1 was repeated except that the charge transport material No. 14 was replaced with the charge transport material No. 51 (having an ionization potential of 5.36 eV). Thus, an image bearing member (8) was prepared.

### Manufacturing Example 9 of Image Bearing Member

The procedure for preparing the image bearing member (1) in Manufacturing Example 1 was repeated except that the charge transport material No. 14 was replaced with an α-phenylstilbene derivative (having an ionization potential of 5.39 eV) having the following formula:

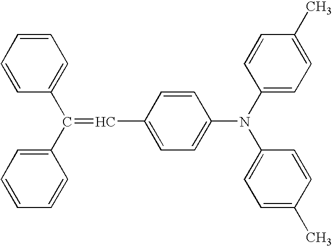

Thus, an image bearing member (9) was prepared.

### Manufacturing Example 10 of Image Bearing Member

The procedure for preparing the image bearing member (1) in Manufacturing Example 1 was repeated except that the charge transport material No. 14 was replaced with an α-phenylstilbene derivative (having an ionization potential of 5.26 eV) having the following formula:

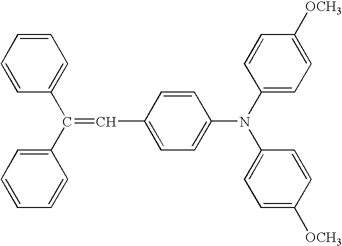

Thus, an image bearing member (10) was prepared.

### Manufacturing Example 11 of Image Bearing Member

The procedure for preparing the image bearing member (1) in Manufacturing Example 1 was repeated except that the charge transport material No. 14 was replaced with an α-phenylstilbene derivative (having an ionization potential of 5.50 eV) having the following formula:

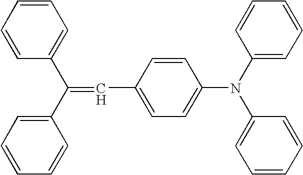

Thus, an image bearing member (11) was prepared.

### Manufacturing Example 12 of Image Bearing Member

The procedure for preparing the image bearing member (1) in Manufacturing Example 1 was repeated except that the charge transport material No. 14 was replaced with an aminobiphenyl derivative (having an ionization potential of 5.38 eV) having the following formula:

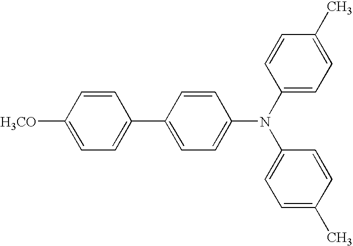

Thus, an image bearing member (12) was prepared.

### Manufacturing Example 13 of Image Bearing Member

The procedure for preparing the image bearing member (1) in Manufacturing Example 1 was repeated except that the charge transport material No. 14 was replaced with a stilbene derivative (having an ionization potential of 5.37 eV) having the following formula:

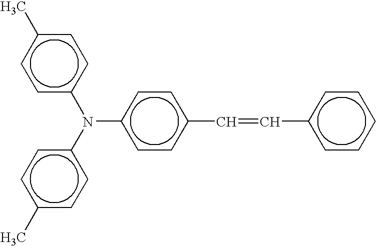

Thus, an image bearing member (13) was prepared.

### Manufacturing Example 14 of Image Bearing Member

The procedure for preparing the image bearing member (1) in Manufacturing Example 1 was repeated except that the charge transport material No. 14 was replaced with a benzidine derivative (having an ionization potential of 5.37 eV) having the following formula:

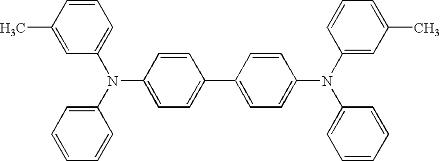

Thus, an image bearing member (14) was prepared.

### Manufacturing Example 15 of Image Bearing Member

The procedure for preparing the image bearing member (1) in Manufacturing Example 1 was repeated except that the polycarbonate, which was a binder resin of the charge transport layer, was replaced with a polyarylate (U-POLYMER 100 from Unitika Ltd.). Thus, an image bearing member (15) was prepared.

### Manufacturing Example 16 of Image Bearing Member

The procedure for preparing the image bearing member (1) in Manufacturing Example 1 was repeated except that the charge transport layer coating liquid was replaced with that having the following composition.

### (Composition of Charge Transport Layer Coating Liquid)

| | |
|---|---|
| Charge transport polymer having the following formula | 17 parts |
| 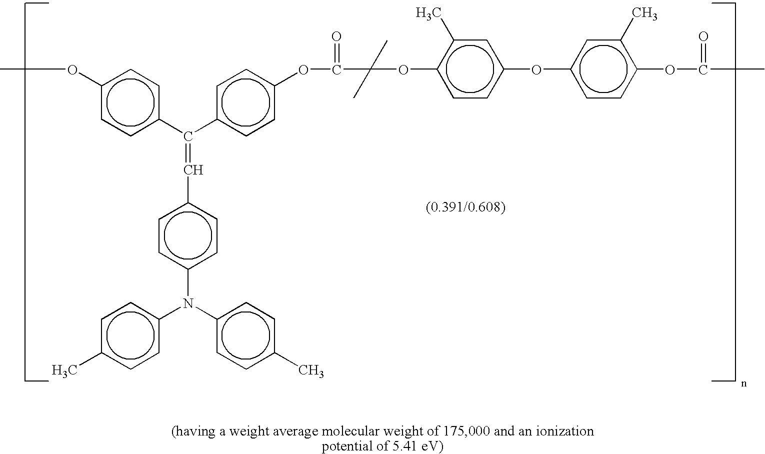 | |
| Silicone oil (1 cm²/s (100 cSt), from Shin-Etsu Chemical Co., Ltd.) | 0.002 parts |
| Tetrahydrofuran | 100 parts |

Thus, an image bearing member (16) was prepared.

### Manufacturing Example 17 of Image Bearing Member

The procedure for preparing the image bearing member (1) in Manufacturing Example 1 was repeated except that the charge transport layer coating liquid was replaced with that having the following composition.

### (Composition of Charge Transport Layer Coating Liquid)

| | |
|---|---|
| Charge transport polymer having the following formula | 12 parts |

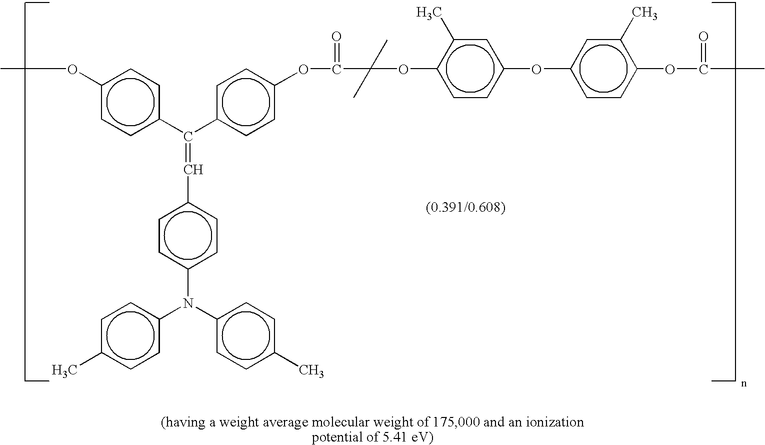

| | |
|---|---|
| α-Phenylstilbene derivative having the following formula | 5 parts |

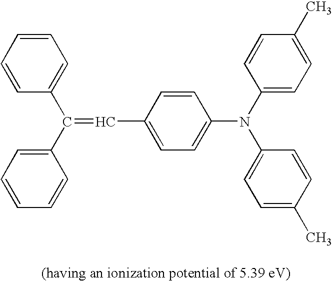

| | |
|---|---|
| Silicone oil (1 cm²/s (100 cSt), from Shin-Etsu Chemical Co., Ltd.) | 0.002 parts |
| Tetrahydrofuran | 100 parts |

Thus, an image bearing member (17) was prepared.

### Manufacturing Example 18 of Image Bearing Member

The procedure for preparing the image bearing member (17) in Manufacturing Example 17 was repeated except that the α-phenylstilbene derivative was replaced with an α-phenylstilbene derivative (having an ionization potential of 5.26 eV) having the following formula:

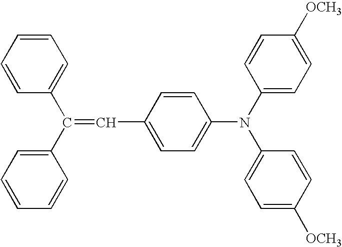

Thus, an image bearing member (18) was prepared.

### Manufacturing Example 19 of Image Bearing Member

The procedure for preparing the image bearing member (17) in Manufacturing Example 17 was repeated except that the α-phenylstilbene derivative was replaced with a distyrylbenzene derivative No. 17 (having an ionization potential of 5.39 eV). Thus, an image bearing member (19) was prepared.

### Manufacturing Example 20 of Image Bearing Member

The procedure for preparing the image bearing member (4) in Manufacturing Example 4 was repeated except that the amount of the charge transport material was changed from 7 parts to 4 parts. Thus, an image bearing member (20) was prepared.

### Manufacturing Example 21 of Image Bearing Member

The procedure for preparing the image bearing member (4) in Manufacturing Example 4 was repeated except that the amount of the charge transport material was changed from 7 parts to 2 parts. Thus, an image bearing member (21) was prepared.

### Manufacturing Example 22 of Image Bearing Member

The procedure for preparing the image bearing member (9) in Manufacturing Example 9 was repeated except that the charge generation layer coating liquid and the charge transport layer coating liquid were replaced with those having the following compositions, respectively.

### (Composition of Charge Generation Layer Coating Liquid)

| | |
|---|---|
| Azo pigment having the following formula | 5 parts |

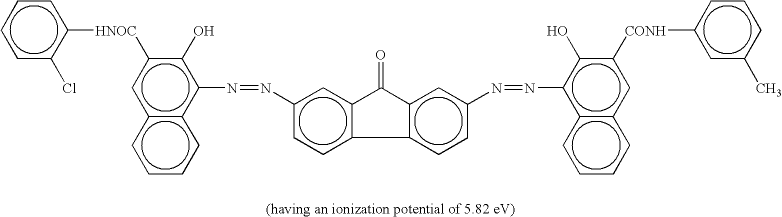

| | |
|---|---|
| Polyvinyl butyral (BM-S from from Sekisui Chemical Co., Ltd.) | 1.5 parts |
| Cyclohexanone | 250 parts |
| 2-Butanone | 100 parts |

### (Composition of Charge Transport Layer Coating Liquid)

| | |
|---|---|
| Polycarbonate | 10 parts |
| (Z-form polycarbonate resin from Teijin Chemicals Ltd.) | |
| α-Phenylstilbene derivative having the following formula | 7 parts |

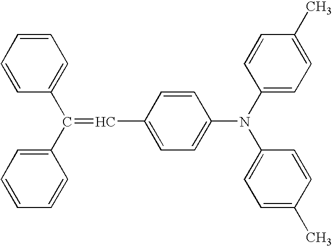

| | |
|---|---|
| Silicone oil | 0.002 parts |
| (1 cm²/s (100 cSt), from Shin-Etsu Chemical Co., Ltd.) | |
| Tetrahydrofuran | 100 parts |
| Antioxidant having the following formula | 0.03 parts |

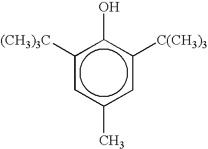

Thus, an image bearing member (22) was prepared.

### Manufacturing Example 23 of Image Bearing Member

The procedure for preparing the image bearing member (22) in Manufacturing Example 22 was repeated except that the charge transport material (i.e., α-phenylstilbene derivative) was replaced with the compound No. 17 (having an ionization potential of 5.39 eV) and 0.07 parts of an antioxidant having the following formula was added.

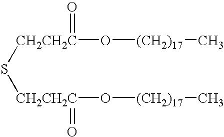

Thus, an image bearing member (23) was prepared.

### Manufacturing Example 24 of Image Bearing Member

The procedure for preparing the image bearing member (1) in Manufacturing Example 1 was repeated except that the compound having an alkylamino group was replaced with a compound having the following formula:

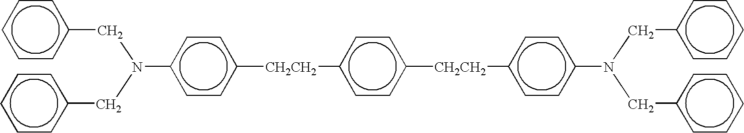

Thus, an image bearing member (24) was prepared.

### Manufacturing Example 25 of Image Bearing Member

The procedure for preparing the image bearing member (1) in Manufacturing Example 1 was repeated except that 0.3 parts of an antioxidant having the following formula was added:

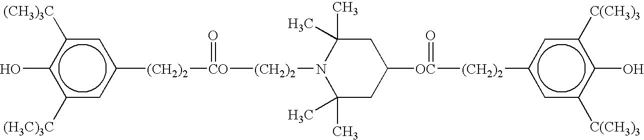

Thus, an image bearing member (25) was prepared.

### Manufacturing Example 26 of Image Bearing Member

The procedure for preparing the image bearing member (1) in Manufacturing Example 1 was repeated except that 0.3 parts of an antioxidant having the following formula was added:

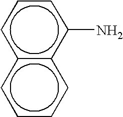

Thus, an image bearing member (26) was prepared.

### Manufacturing Example 27 of Image Bearing Member

The procedure for preparing the image bearing member (1) in Manufacturing Example 1 was repeated except that 0.3 parts of an antioxidant having the following formula was added:

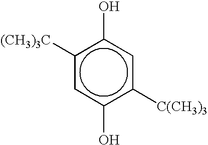

Thus, an image bearing member (27) was prepared.

### Manufacturing Example 28 of Image Bearing Member

The procedure for preparing the image bearing member (1) in Manufacturing Example 1 was repeated except that the compound having an alkylamino group was not added. Thus, an image bearing member (28) was prepared.

### Manufacturing Example 29 of Image Bearing Member

The procedure for preparing the image bearing member (28) in Manufacturing Example 28 was repeated except that 1 part of a compound having an alkylamino group, having the following formula was added:

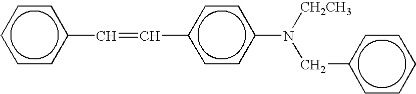

Thus, an image bearing member (29) was prepared.

### Manufacturing Example 30 of Image Bearing Member

The procedure for preparing the image bearing member (1) in Manufacturing Example 1 was repeated except that the resin layer was not formed. Thus, an image bearing member (30) was prepared.

### Manufacturing Example 31 of Image Bearing Member

The procedure for preparing the image bearing member (1) in Manufacturing Example 1 was repeated except that the undercoat layer was not formed. Thus, an image bearing member (31) was prepared.

### Measurement of Real Transit Time

Each of the image bearing members prepared above was set to the apparatus illustrated in FIG. 4 so as to measure the real transit time.

The linear velocity of the image bearing member 1 was set to 262 msec. The angle between the irradiator 3 and the second surface electrometer 6 was set to 155° so that a time between irradiating the image bearing member 1 with a predetermined amount of irradiating light and measuring the surface potential of the irradiated portion (i.e., development time) was 155 msec. The charger 2 charges the image bearing member 1 so that the first surface electrometer 5 indicates a potential of a non-irradiated portion of −800 V. Subsequently, the irradiator 3 irradiates the image bearing member 1 with a predetermined amount of irradiating light, and the second surface electrometer 6 measures the potential of the irradiated portion. Finally, the diselectrification device 4 diselectrifies the image bearing member 1. The irradiating pixel was 400 dpi, and the irradiating light had a wavelength of 655 nm. It was confirmed with an irradiating light having a wavelength of 780 nm that the real transit time did not depend on the wavelength of the irradiating light.

The above-described procedure of charging, irradiating, and diselectrifying the image bearing member was repeated while varying the intensity of the irradiating light, so that an optical attenuation curve as illustrated in FIG. 5 was obtained. The surface potential of the irradiated portion was determined from the flection point observed in FIG. 5.

Next, the angle between the irradiator 3 and the second surface electrometer 6 was changed to 120°, 100°, 90°, 80°, 70°, 60°, 55°, 50°, 45°, 40°, 35°, 30°, 25°, and 20°, so that a time between irradiating the image bearing member 1 with a predetermined amount of irradiating light and measuring the surface potential of the irradiated portion (i.e., development time) was 120 msec, 100 msec, 90 msec, 80 msec, 70 msec, 60 msec, 55 msec, 50 msec, 45 msec, 40 msec, 35 msec, 30 msec, 25 msec, and 20 msec, respectively. The above-described procedure of charging, irradiating, and diselectrifying the image bearing member was repeated while varying the intensity of the irradiating light, so that an optical attenuation curve as illustrated in FIG. 5 was obtained, at each angle. Values of the surface potential of the irradiated portion were obtained within a range of from 20 to 155 msec of the development time.

The values were plotted on a graph showing a relationship between the development time and the surface potential of the irradiated portion, as illustrated in FIG. 6. The real transit time was determined by finding the first flection point, at which the surface potential rises up for the first time as the development time is shortened.

The thus measured real transit times of the image bearing members 1 to 31 are shown in Table 1.

### Examples 1 to 21 and Comparative Examples 1 to 10

Each of the above-prepared image bearing members was set in a process cartridge. The process cartridge was attached to a modified digital copier (from Ricoh Co., Ltd.) including a charger employing a scorotron having a grid width of 10 mm, an irradiator employing a laser diode having a wavelength of 780 nm, a developing unit employing a probe connected to a surface electrometer, and an LED having a wavelength of 660 nm serving as a diselectrification device, from which a transfer unit and a cleaning unit were removed. The image bearing member had a linear velocity of 127 mm/sec (i.e., the rotational velocity was 80.9 rpm and the charging time was 78.7 msec). The applied voltage was controlled so that non-irradiated portion of the image bearing member had a surface potential of =800 V.

At first, 5 sheets of white solid image were produced. The difference (ΔVD) in surface potential (VD) of the non-irradiated portion between the first and third sheets was measured. The ΔVD was defined as the amount of charge decline in the first rotation. Subsequently, 5 sheets of black solid image were produced. The surface potential (VL) of the irradiated portion of the fifth sheet was measured.

Next, a developing unit containing a developer, a cleaning unit, and a transfer unit were installed in the modified digital copier so as to produce an image. The produced image (i.e., the initial image) had good quality.

Next, a running test in which 30,000 sheets of an image were continuously produced was performed. After the rnning test, the image bearing member was left in a dark space for 10 minutes, while the developing unit employing a probe connected to a surface electrometer was reinstalled in the modified digital copier and the transfer unit and the cleaning unit were removed from the modified digital copier again. Subsequently, 5 sheets of white solid image were produced, and the difference (ΔVD) in surface potential (VD) of the non-irradiated portion between the first and third sheets was measured. Furthermore, 5 sheets of black solid image were produced, and the surface potential (VL) of the irradiated portion of the fifth sheet was measured.

Again, the image bearing member was left in a dark space for 10 minutes, while the developing unit containing a developer, the cleaning unit, and the transfer unit were reinstalled in the modified digital copier. White solid image was produced at a time of the first rotation of the image bearing member, and subsequently black solid images and halftone image were produced.

The white solid image was evaluated in terms of the occurrence of background fouling and graded as follows:

Level A: Background fouling is not observed.

Level B: Background fouling is slightly observed, but no problem in practical use.

Level C: Background fouling is observed, and having a problem in practical use.

Level D: Background fouling is seriously observed, and having a serious problem in practical use.

The halftone image was evaluated in terms of image density, image resolution, and the occurrence of moiré, and graded as follows:

### (Image Density)

Level A: Very good.

Level B: The image density slightly decreases, but no problem in practical use.

Level C: The image density decreases, and having a problem in practical use.

Level D: The image density seriously decreases, and having a serious problem in practical use.

### (Image Resolution)

Level A: Very good.

Level B: The image resolution slightly decreases, but no problem in practical use.

Level C: The image resolution decreases, and having a problem in practical use.

Level D: The image resolution seriously decreases, and having a serious problem in practical use.

(Occurrence of Moiré)

Level A: Moiré is not observed.

Level B: Moiré is slightly observed, but no problem in practical use.

Level C: Moiré is observed, and having a problem in practical use.

Level D: Moiré is seriously observed, and having a serious problem in practical use.

The evaluation results are shown in Table 1.

TABLE 1

| | | Real | Initial | | After 30,000 | | | |
|---|---|---|---|---|---|---|---|---|
| | Image | Transit | Stage | | sheets printing | | | |
| | Bearing | Time | ΔVD | VL | ΔVD | VL | White Solid | Half-tone |
| | Member No. | (msec) | (V) | (V) | (−V) | (−V) | Image | Image |
| Ex. 1 | 1 | 51 | 1 | 59 | 6 | 57 | A | A |
| Ex. 2 | 2 | 54 | 0 | 64 | 9 | 61 | A | A |
| Ex. 3 | 3 | 69 | 1 | 50 | 13 | 44 | A | A |
| Ex. 4 | 4 | 62 | 1 | 69 | 10 | 65 | A | A |
| Ex. 5 | 5 | 53 | 1 | 60 | 8 | 57 | A | A |
| Ex. 6 | 6 | 61 | 1 | 79 | 3 | 76 | A | A |
| Ex. 7 | 7 | 59 | 0 | 62 | 7 | 58 | A | A |
| Ex. 8 | 8 | 65 | 1 | 75 | 11 | 71 | A | A |
| Comp. | 9 | 82 | 1 | 118 | 65 | 155 | C | C(ID)* |
| Ex. 1 | | | | | | | | |
| Comp. | 10 | 81 | 2 | 65 | 87 | 62 | D | A |
| Ex. 2 | | | | | | | | |
| Comp. | 11 | 80 | 3 | 136 | 53 | 208 | C | D(ID) |
| Ex. 3 | | | | | | | | |
| Comp. | 12 | 92 | 3 | 121 | 76 | 160 | C | C(ID) |
| Ex. 4 | | | | | | | | |
| Comp. | 13 | 90 | 2 | 110 | 72 | 148 | C | C(ID) |
| Ex. 5 | | | | | | | | |
| Comp. | 14 | 88 | 2 | 85 | 63 | 97 | C | A |
| Ex. 6 | | | | | | | | |
| Ex. 9 | 15 | 52 | 1 | 60 | 5 | 58 | A | A |
| Comp. | 16 | 88 | 5 | 123 | 73 | 167 | C | C(ID) |
| Ex. 7 | | | | | | | | |
| Ex. 10 | 17 | 71 | 2 | 101 | 28 | 117 | B | D(ID) |
| Comp. | 18 | 92 | 3 | 134 | 60 | 171 | C | C(ID) |
| Ex. 8 | | | | | | | | |
| Ex. 11 | 19 | 55 | 1 | 73 | 4 | 70 | A | A |
| Ex. 12 | 20 | 70 | 1 | 82 | 17 | 89 | A | A |
| Comp. | 21 | 91 | 0 | 113 | 47 | 142 | C | C(ID) |
| Ex. 9 | | | | | | | | |
| Comp. | 22 | 80 | 8 | 54 | 68 | 65 | C | A |
| Ex. 10 | | | | | | | | |
| Ex. 13 | 23 | 73 | 2 | 52 | 11 | 62 | A | A |
| Ex. 14 | 24 | 52 | 2 | 57 | 8 | 56 | A | A |
| Ex. 15 | 25 | 52 | 1 | 60 | 5 | 60 | A | A |
| Ex. 16 | 26 | 51 | 0 | 63 | 2 | 63 | A | A |
| Ex. 17 | 27 | 55 | 1 | 76 | 7 | 94 | A | A |
| Ex. 18 | 28 | 51 | 1 | 56 | 6 | 45 | A | B(IR)** |
| Ex. 19 | 29 | 51 | 1 | 70 | 10 | 58 | A | B(IR) |
| Ex. 20 | 30 | 50 | 3 | 57 | 8 | 51 | B | A |
| Ex. 21 | 31 | 51 | 3 | 62 | 5 | 60 | A | B(M)*** |

*Image Density
**Image Resolution
***Moiré

### Comparative Example 11 to 13

Each of the above-prepared image bearing members 3, 17, and 20 was set in another modified digital copier (from Ricoh Co., Ltd.) in which the image bearing member had a linear velocity of 150 mm/sec and the charging time was 66.7 msec. The above-described evaluations were performed. The evaluation results are shown in Table 2.

TABLE 2

| | | Real | Initial | | After 30,000 sheets | | | |
|---|---|---|---|---|---|---|---|---|
| | Image | Transit | Stage | | printing | | | |
| | Bearing | Time | ΔVD | VL | ΔVD | VL | White Solid | Half-tone |
| | Member No. | (msec) | (V) | (V) | (−V) | (−V) | Image | Image |
| Comp. | 3 | 69 | 2 | 53 | 40 | 46 | C | B(ID) |
| Ex. 11 | | | | | | | | |
| Comp. | 17 | 71 | 2 | 105 | 62 | 121 | C | B(ID) |
| Ex. 12 | | | | | | | | |
| Comp. | 20 | 70 | 1 | 86 | 51 | 92 | C | A |
| Ex. 13 | | | | | | | | |

It is clear from the above results that when the real transit time exceeds the charging time, the first rotation charge decline notably occurs after the running test is performed. In contrast, when the real transit time is shorter than the charging time, the occurrence of the first rotation charge decline is notably prevented. In particular, when the charge transport layer includes the charge transport material having the formulae (3) to (5), the real transit time is drastically shortened, resulting in prevention of the first rotation charge decline.

It is also clear from the above results that when the ionized potentials of the charge transport material and the charge generation material satisfy the above-described relationship (6), the surface potential of the irradiated portion after the running test is notably decreased. As a result, high quality images are stably produced.

It is also clear from the above results that when the charge transport polymer and the charge transport material are used in combination, the real transit time is much more shortened. As a result, the first rotation charge decline is much effectively prevented. The charge transport material having the formula (3) can exert its high effect also in this case. However, when the difference in ionized potential between the charge transport polymer and the charge transport material is greater than 0.1 eV, the surface potential of the irradiated portion notably increases.

It is also clear from the above results that when the charge transport layer does not include the compound having an amino group having the formula (7) or (8), the image resolution slightly deteriorates after the running test. Although a charge transport material having a small ionized potential tends to deteriorate the image resolution, a combinational use with the compound having an amino group having the formula (7) or (8) can prevent the deterioration of the image resolution. On the other hand, a compound having an amino group which does not have the formula (7) nor (8) cannot prevent deterioration of the image resolution.

It is also clear from the above results that when the charge transport layer includes a suitable preferred antioxidant for the present invention, high quality images are produced. In contrast, when the charge transport layer includes other antioxidant, the surface potential of the irradiated portion notably increases.

It is also clear from the above results that both a titanyl phthalocyanine and an asymmetric azo pigment are preferably used as the charge generation material. Thereby, the resultant image bearing member has high sensitivity, residual potential is decreased, and the first rotation charge decline can be prevented.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Applications No. 2007-069136, filed on Mar. 16, 2007, the entire contents of which are herein incorporated by reference.

What is claimed is:

1. An image forming apparatus, comprising:
an image bearing member comprising:
a conductive substrate; and
a photosensitive layer comprising a charge generation material and a charge transport material, located overlying the conductive substrate;
a charger configured to charge the image bearing member;
an irradiator configured to irradiate the image bearing member so as to form an electrostatic latent image thereon; and
a developing device configured to develop the electrostatic latent image formed on the image bearing member,
wherein the following relationships (1) and (2) are satisfied:
T1≦T2 (1)
T2=W/V (2)
wherein T1 (msec) represents a real transit time, defined as a value on X-axis of a first flection point, at which a surface potential (Y) of the image bearing member firstly rises up when a time (X) between irradiating the image bearing member and measuring the surface potential of the irradiated portion thereof is shortened, in a graph showing a relationship between X and Y; T2 (msec) represents a charging time; W (mm) represents a charging width of the charger; and V (mm/msec) represents a linear velocity of the image bearing member.

2. The image forming apparatus according to claim 1, wherein the photosensitive layer comprises:
a charge generation layer comprising the charge generation material; and
a charge transport layer comprising the charge transport material, located overlying the charge generation layer.

3. The image forming apparatus according to claim 1, wherein the charge transport material comprises a compound having the following formula (3): 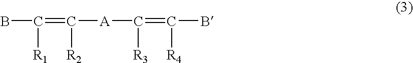
wherein each of R₁ to R₄ independently represents a hydrogen atom, an alkyl group having 1 to 4 carbon atoms, an alkoxy group having 1 to 4 carbon atoms, or a phenyl group which may have a substituent group; A represents a substituted or unsubstituted arylene group or a functional group having the following formula (3a): 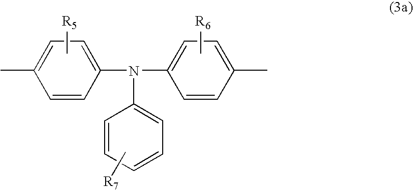
wherein each of R₅ to R₇ independently represents a hydrogen atom, an alkyl group having 1 to 4 carbon atoms, an alkoxy group having 1 to 4 carbon atoms, or a phenyl group which may have a substituent group; and each of B and B′ independently represents a substituted or unsubstituted aryl group or a functional group having the following formula (3b): 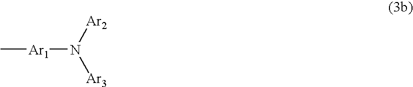
wherein Ar₁ represents an arylene group which may have a substituent group; and each of Ar₂ and Ar₃ independently represents an aryl group which may have a substituent group.

4. The image forming apparatus according to claim 3, wherein the charge transport material comprises a compound having the following formula (4): 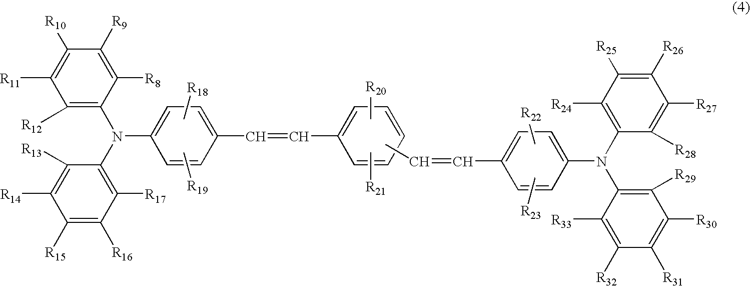
wherein each of R₈ to R₃₃ independently represents a hydrogen atom, an alkyl group having 1 to 4 carbon atoms, an alkoxy group having 1 to 4 carbon atoms, or a substituted or unsubstituted phenyl group.

5. The image forming apparatus according to claim 3, wherein the charge transport material comprises a compound having the following formula (5): 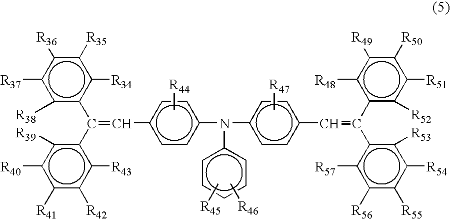
wherein each of R₃₄ to R₅₇ independently represents a hydrogen atom, an alkyl group having 1 to 4 carbon atoms, an alkoxy group having 1 to 4 carbon atoms, or a substituted or unsubstituted phenyl group.

6. The image forming apparatus according to claim 3, wherein the following relationship (6) is satisfied:
Ip_{CGM}−Ip_{CM}≧−0.1 (6)
wherein Ip_{CGM} (eV) represents an ionization potential of the charge generation material and Ip_{CTM} (eV) represents an ionization potential of the charge transport material.

7. The image forming apparatus according to claim 3, wherein the photosensitive layer comprises a binder resin comprising at least one of a polycarbonate andapolyarylate.

8. The image forming apparatus according to claim 3, wherein the photosensitive layer comprises a binder resin comprising a charge transport polymer.

9. The image forming apparatus according to claim 8, wherein a difference in ionization potential between the charge transport material and the charge transport polymer is not greater than 0.1 eV.

10. The image forming apparatus according to claim 3, wherein the photosensitive layer comprises a compound having an alkylamino group, having the following formulae (7) or (8): 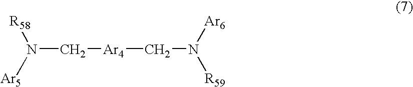
wherein Ar₄ represents a substituted or unsubstituted arylene group; each of Ar₅ and Ar₆ independently represents a substituted or unsubstituted aryl group, a substituted or unsubstituted alkyl group, or a substituted or unsubstituted aralkyl group; each of R₅₈ and R₅₉ independently represents a substituted or unsubstituted alkyl group or a substituted or unsubstituted aralkyl group; Ar₅ and R₅₈ optionally share bond connectivity to form a substituted or unsubstituted heterocyclic ring containing a nitrogen atom; and Ar₆ and R₅₉ optionally share bond connectivity to form a substituted or unsubstituted heterocyclic ring containing a nitrogen atom; 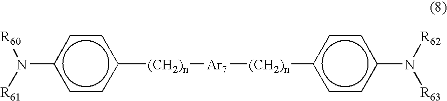
wherein Ar₇ represents a substituted or unsubstituted arylene group; each of R₆₀ to R₆₃ independently represents a substituted or unsubstituted alkyl group or a substituted or unsubstituted aralkyl group; and n represents an integer of 1 or 2.

11. The image forming apparatus according to claim 3, wherein the photosensitive layer comprises at least two antioxidants selected from the group consisting of the following compounds having the formulae (9) to (12): 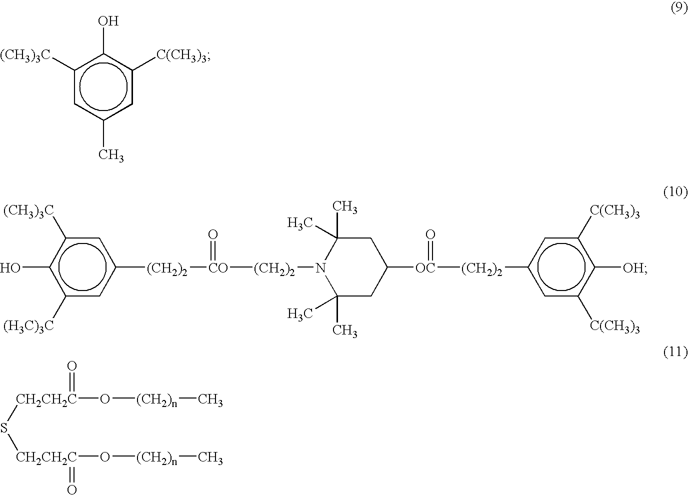
wherein n represents an integer of from 12 to 18; and 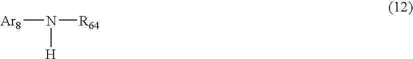
wherein Ar₈ represents a substituted or unsubstituted aryl group; and R₆₄ represents a hydrogen atom, a substituted or unsubstituted alkyl group, a substituted or unsubstituted aralkyl group, or a substituted or unsubstituted aryl group.

12. The image forming apparatus according to claim 1, wherein the charge generation material comprises a titanyl phthalocyanine pigment.

13. The image forming apparatus according to claim 12, wherein the titanyl phthalocyanine pigment has an X-ray diffraction spectrum in which a maximum diffraction peak is observed at 27.2°, main diffraction peaks are observed at 9.4°, 9.6°, and 24.0°, a diffraction peak with the smallest angle is observed at 7.3°, and no diffraction peak is observed either in a range of greater than 7.3° and less than 9.4° or at 26.3°, among each of Bragg angles (2θ±0.2°), obtained using a characteristic X-ray specific to CuKα having a wavelength of 1.542 Å.

14. The image forming apparatus according to claim 1, wherein the charge generation material comprises an asymmetric bisazo pigment having the following formula (13): 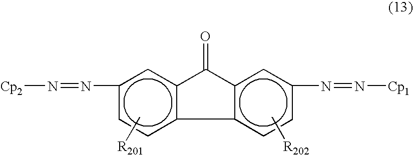
wherein each of R₂₀₁ and R₂₀₂ independently represents a hydrogen atom, a halogen atom, an alkyl group, an alkoxy group, or a cyano group; and each of Cp₁ and Cp₂, being different from each other, independently represents a residue group of a coupler, having the following formula (14): 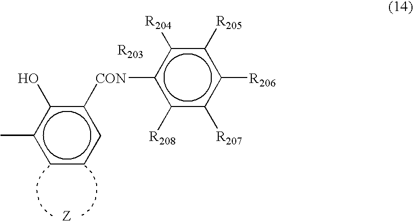
wherein R₂₀₃ represents a hydrogen atom, an alkyl group, or an aryl group; each of R₂₀₄ to R₂₀₈ independently represents a hydrogen atom, a nitro group, a cyano group, a halogen atom, a trifluoromethyl group, an alkyl group, an alkoxy group, a dialkylamino group, or a hydroxyl group; and Z represents an atomic group needed for constituting a substituted or unsubstituted aromatic carbocyclic ring or a substituted or unsubstituted aromatic heterocyclic ring.

15. The image forming apparatus according to claim 1, wherein the image bearing member further comprises an undercoat layer comprising two titanium oxide pigments, each having a different number average primary particle diameter, located between the conductive substrate and the photosensitive layer.

16. The image forming apparatus according to claim 15, wherein the image bearing member further comprises a resin layer comprising a polyamide resin and having a thickness of not greater than 2 μm, located between the conductive substrate and the photosensitive layer.

17. The image forming apparatus according to claim 1, wherein the charger is a scorotron charger.

18. The image forming apparatus according to claim 17, wherein the scorotron charger comprises a plurality of wires.

19. The image forming apparatus according to claim 1, further comprising a plurality of image forming units, which are provided in tandem, each comprising the image bearing member and at least one member selected from the charger, the irradiator, the developing device, a transfer device, a cleaning device, and a diselectrification device.

20. A process cartridge, comprising:
an image bearing member comprising:
a conductive substrate; and
a photosensitive layer comprising a charge generation material and a charge transport material, located overlying the conductive substrate; and
a charger configured to charge the image bearing member;
wherein the following relationships (1) and (2) are satisfied:
T1≦T2 (1)
T2=W/V (2)
wherein T1 (msec) represents a real transit time, defined as a value on X-axis of a first flection point, at which a surface potential (Y) of the image bearing member firstly rises up when a time (X) between irradiating the image bearing member and measuring the surface potential of the irradiated portion thereof is shortened, in a graph showing a relationship between X and Y; T2 (msec) represents a charging time; W (mm) represents a charging width of the charger; and V (mm/msec) represents a linear velocity of the image bearing member.
